(19) United States
(12) Patent Application Publication
(10) Pub. No.: US 2003/0154403 A1
(43) Pub. Date: Aug. 14, 2003

(54) Web-based security with controlled access to data and resources

(76) Inventors: Brian E. Keinsley, Corydon, IN (US); Brett T. Edwards, Louisville, KY (US); Siddy Rosenberg, Louisville, KY (US); Eric P. Light, Louisville, KY (US); David L. Townsend, Louisville, KY (US); Mark A. Smithson, Louisville, KY (US); Sharon A. Harris, Villanova, PA (US); Aaron L. Lawhead, New Albany, IN (US); Craig Stanley, Jeffersonville, IN (US); Leigh S. Weber, Maple Glen, PA (US); Eleanor W. Latimer, Dallas, TX (US); William Burchard, Louisville, KY (US)

Correspondence Address: JACOBSON HOLMAN PLLC, 400 SEVENTH STREET N.W., SUITE 600, WASHINGTON, DC, 20004, US

(21) Appl. No.: 10/216,664

(22) Filed: Aug. 12, 2002

Related U.S. Application Data
(60) Provisional application No. 60/311,821, filed on Aug. 14, 2001.

(51) Int. Cl. G06F 11/30; G06F 15/173

(52) U.S. Cl. 713/201; 709/223

(57) ABSTRACT

A stand-alone security system controlling access to secured information and self-service functionality for a sponsor organization, usable for Web-based and IVR-based self-service functions, having five primary facets: (1) control of access to secured information and self-service functionality for a sponsor organization, (2) enabling access to users having indirect relationships to the sponsor organization and to users having a direct relationship with the sponsor organization, (3) distribution of security administration from a central information technology resource to various users of the security system, (4) support for integration into different kinds of environments, and (5) support for system integrators. Key components of access control include (1) association of a userId with one specific person, (2) identification of keys to data in back-end systems and association of those keys with the system users, (3) definition of pieces (segments) of an organization so that permissions are granted based on the pieces instead of the entire organization, (4) definition of roles that a user has based on the functionality to which he has been given permission, (5) a single sign-on for a user who has multiple reasons to use the system, and (6) support for direct and indirect assignment of business functions. A consequence of facet (2) is that the user's employer must identify a person who legally binds that employer and a person who handles day-to-day security administration for the employer. Facet (3) enables multiple levels of distribution, including enabling one organization to delegate its rights to another organization.

### CROSS-REFERENCE TO RELATED APPLICATIONS

This application claims priority to provisional U.S. Application Ser. No. 60/311,821, filed Aug. 14, 2001, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to web-based security applications that provide controlled access to a sponsor organization's data and other resources.

### BACKGROUND OF THE INVENTION

Sponsor organizations, such as healthcare companies, have clients that access their data and other resources over a distributed information retrieval system such as the World Wide Web. Such sponsor organizations have need of a stand-alone security system controlling access to secured information and self-service functionality for the sponsor organization. The basic requirements for such a security system are as follows:

1. A User ID is to be associated with a specific person and only that person.

2. The system needs to handle registrations of people who are unknown to the sponsor organization prior to registration and have indirect relationships to the sponsor organization through their employers. This requirement makes a registration process necessary.

3. In order to use the system, each user needs to have the context in which he uses the system be defined. In general, the context is the organization for which he or she works. Typically these organizations are different from the sponsor organization. Having the context will drive what kinds of business functions and data are available to the user. Within the secured logon application, the contexts are referred to as entities. Each of these entities needs to be registered also.

4. A user can work within multiple contexts and still use the same User ID.

5. Different users need to play different roles within the entities for which they work. This requirements means that there needs to be a way to assign roles to users.

6. When logging onto the system, each user needs to be presented with a menu that contains only those business functions that his or her role allows.

7. The day-to-day administration of security activity within the entities needs to be distributed to those entities.

8. Access Identifiers need to be associated with the entities in order to provide keys to the data in back-end systems.

9. The security system must integrate into multiple environments, even within one sponsor organization.

10. It should be possible for one organization to delegate its access rights to another organization so that the second organization may do work on behalf of the first organization.

11. For those large entities that have multiple access identifiers, it should be possible to define pieces (segments) of the organization based on groupings of the access identifiers and assign permissions based on the pieces instead of based on the entire organization.

While various prior art security systems are known to exist that meet some of these requirements, no security system is known to exist that meets most of the requirements, much less the totality of the requirements.

### BRIEF SUMMARY OF THE INVENTION

The present invention, hereinafter referred to as the secured logon application, is a stand-alone. security system controlling access to secured information and self-service functionality for a sponsor organization. It can be used for Web-based and IVR-based self-service functions. A sponsor organization can be an organization hosting the user-interface (Web site or IVR) and the back-end systems or can be an organization hosting just the user interface and passing transactions to other organization(s) for back-end processing. Although it has been developed at a healthcare company, it is not healthcare specific, but can be used by any sponsor organization having clients needing access to its secured information and self-service functionality.

Definitions and abbreviations used herein are as follows:

Access Administrator (AA)—A user at an entity who has some security administration rights for the entity, but is not the Primary Access Administrator.

Access Control—Maintaining records of access rights and communication of this information where needed. In general, access control consists of controlling which business functions a user can perform using what data, and of insuring that the user is an active user while performing those business functions.

Access Identifiers—For those entities that have data about them in the back-end systems of a sponsor organization, Access Identifiers are the keys to that data. Identifiers can be primary, i.e., they are provided during the registration process or by system application owners, or they can be derived, i.e., they are derived from data in the back-end system based on the primary identifiers. An example of an access identifier for a provider group is the group's TIN (Tax ID Number). The entities that access the secured logon application can vary in size. Most entities will have just one Access Identifier. There are other entities, such as large hospitals that may have dozens, hundreds, or even thousands of access identifiers.

Access Identifier Type—An Access Identifier Type is a categorization of the access identifiers that are set up to identify entities.

Access Management (also known as Assigning Roles)—the process of granting, modifying, or removing an administrator's (or user's) access to an organization's data.

Admin Entity—The Entity for which a user works.

AKA Name—A public user ID or alias for a user. AKA Names, like user ID's, are unique to a user. It is an alternate way to refer to the user without divulging any information that can be used to log on.

Alternate Controlling Authority—An Alternate Controlling Authority (ACA) is a person who can legally bind an entity and who acts as a back-up to the Primary Controlling Authority in instances in which the Primary Controlling Authority is unavailable.

Assigning Roles—see Access Management.

Authentication—ongoing verification that this individual is still allowed to have access

Authorization—approving someone, who has a right and a need to use the secure web self-service functions, for access to specific business functions and data based on the individual's credentials and the context for which access is requested.

BehalfOF Entity—The entity on whose behalf a user is doing work. In situations involving delegation, this will be a different entity than the one for which the user works.

Business Functions—A business function is some function or activity that a user can perform and that is made available to a user through the secured logon application by a system application that has been properly registered within the secured logon application. An example is “View Claims.”

Business Function Gen Key/Business Function ID—A Business Function Gen Key, also known as a Business Function ID, is a unique value that is assigned to a Business Function. It is assigned when the Business Function is registered with the secured logon application.

Business Function Set—A Business Function Set is a logical grouping of Business Functions.

Delegation—Delegation is the process by which one entity enables another entity to do work of the first entity on behalf of the first entity.

Derivative Identifiers—Derivative identifiers are those identifiers derived from data in the back-end systems based on the value(s) of primary identifier(s).

Dynamic Menus—the list of functions a user can perform based on the rights granted to him or her within the secured logon application. If a user does not have access to a particular function that function will not be presented as a menu item to the user.

Entity—organization such as a provider group, a broker agency, an employer, etc. An entity is an organization or person with whom a sponsor organization has a business relationship. Entities are also third party organizations doing business with the entities having a relationship with a sponsor organization. Each entity has to have specific people identified for a couple of responsibilities—a person who can legally bind the organization (Primary Controlling Authority—PCA) and a person who is responsible for security administration (Primary Access Administrator—PAA).

Entity Type—Multiple types of entities can be supported. Each entity type can have specific business functions associated with it and certain identifier types associated with it. For a healthcare company, entity types might include provider organization, physician, employer, member, agent, or broker.

Entity User—An entity user represents the fact that a specific user may do work on behalf of a specific entity. See also User Context.

Identifiers—See Access Identifier

Menu—When a user logs on, a menu of business functions is presented to him or her consisting of a list of at least the business functions that his or her role allows and sometimes more.

Port of Origin (“PO”)—a starting point or entry point for getting access to a sponsor organization's secured business functions and resources via the secured logon application. In the case of a sponsor organization for a healthcare company, there may be ports of origin for health care providers and employers.

Port of origin key—a key assigned to the PO by the secured logon application administrator when the PO is initially registered.

Primary Access Administrator (PAA)—A Primary Access Administrator is a person who is responsible for security administration at an entity.

Primary Controlling Authority (PCA)—A Primary Controlling Authority (PCA) is a person who can legally bind an entity.

Primary Identifiers—Primary identifiers are those identifiers provided during the registration process or maintained by system application owners.

Provider organization—An organization that provides healthcare to people insured by the Sponsor Organization and that may be itself insured by the Sponsor Organization.

Real Entity User—In a real entity user situation, the user works for the entity on whose behalf he or she is doing the work.

Registration Process—The process whereby data about an entity, the Primary Controlling Authority, and the Primary Access Administrator are captured via an online process and approved. The approval can be by the IT security personnel or it can be an automated approval process.

Segmentation—Segmentation is the definition of pieces of an organization (segments) based on groupings of the access identifiers and assigning permissions based on the pieces instead of the whole organization.

Single Sign-On—The single sign-on concept means that a user uses a single User ID in order to log on for multiple contexts.

Sponsor Organization—A sponsor organization is an organization that installs the secured logon application to control access to its secured information and self-service functionality for a Web site capabilities. A sponsor organization can be an organization hosting the user-interface (Web site) and the back-end systems or can be an organization hosting just the user interface and passing transactions to other organization(s) for back-end processing.

System application—the code implementing a business function or set of business functions

System Application ID—A System Application ID is a unique value that is assigned to a System Application. It is assigned when the System Application is registered with the secured logon application.

System Application Owner—The “owners” of the System Applications are considered to be the business people or organizations that sponsor or control the System Applications.

System Configuration—The secured logon application supports multiple installation-wide configuration options. Each option provides for some differences in the way the secured logon application works at a given installation. A configuration consists of the whole package of differences, i.e., the individual differences cannot be individually chosen and specified.

User—an individual who is associated with an entity and who has access to secured business functions protected by the secured logon application

User Context—In order to use the system, each user needs to have the context in which he or she uses the system be defined. In general, the context is the organization for which he or she works. Typically these organizations are different from the sponsor organization. Having the context will drive what kinds of business functions and data are available to the user. The contexts are referred to as entities.

User ID—A User ID is the ID that a user uses to log onto a Port of Origin to get access to secured information and self-service functionality. It is associated with a specific person and only that person.

User Role—A user's role is defined by the business functions to which he or she has been granted access. Roles can be changed dynamically. The number of roles that can be created is limited only by the number of combinations of business functions that are available.

Virtual Entity User—In a virtual entity user situation, the user does not work for the entity on whose behalf he or she is doing the work.

There are five primary facets of the secured logon application:

1. Access Control: Control of access to secured information and self-service functionality for a sponsor organization.

2. Support for Unknown Users: Enable access to users who have indirect relationships to the sponsor organization as well as to users who have a direct relationship with the sponsor organization.

3. Distribution of Security Administration: Distribution of security administration from a central information technology resource to various users of the secured logon application.

4. Support for Multiple Environments: Support for integration into different kinds of environments.

5. Support for System Integrators: Support for system integrators who need to interface with and use the information in the secured logon application in order to execute their business functions.

The secured logon application in accordance with the present invention has the following characteristics, each of which fits into one or another of the above five primary facets:

1. Sponsor Organization: The secured logon application may be installed at different Sponsor Organizations.

2. System Configuration: The secured logon application can have some differences in configuration depending on the sponsor organization.

3. Integration with a Port of Origin into a Web Site: The secured logon application can be integrated and blended into the Port of Origin between an unsecured section of the Port of Origin and a secured section of the Port of Origin. The integration includes adapting to the look and feel of the Port of Origin, the adjustment of some content, and through its menu structure, defining the navigation paths to the functions that it offers.

4. System Application and System Application Owners: The secured logon application distributes some of the security administration rights to System Application Owners based on the business functions implemented by the System Application.

5. Business Function: The secured logon application supports access to business functions that may not be in control of the Sponsor Organization, but may be at another organization.

6. Entities: The secured logon application has access defined based on entities. Access is approved for an entity and granted to people within those entities.

7. Entity Types: The secured logon application categorizes entities into Entity Types for various purposes of controlling access as well as determining which business functions are appropriate for the entity.

8. Users: The secured logon application supports users who are people associated with the entities.

9. Known and Unknown People: The secured logon application allows users to be people who are not previously known to any sponsor organization, but have an indirect relationship to the sponsor organization through their employers.

10. Single Sign-On: The secured logon application supports the use of a single User ID for a given user in multiple contexts, including IVR.

11. Identification of a User through a Public Name. The secured logon application supports an AKA Name for a user.

12. User Roles: The secured logon application supports the creation of different roles for different users, limited only by the number of combinations of business functions that are available.

13. Multiple Ways to Determine Roles: The secured logon application supports multiple ways to determine the user roles, from direct assignment of business functions making up the role to implicit determination based on facts about the user.

14. Menus: When a user logs on, the secured logon application supports the presentation of a menu of business functions to the user that contains only those business functions that his or her role allows.

15. Distribution of Security Administration: The secured logon application supports distribution of Security Administration to the entities using the Web site in order to perform day-to-day account administration and to the System Application Owners controlling the business functions available on the Web site to grant those business functions and access identifiers the business functions need.

16. Delegation to Third Parties: The secured logon application supports delegation by entities to third parties with which they have a relationship.

17. Connections to Back-End Data (Access Identifiers): For those entities that have data about them in the back-end systems of a sponsor organization, the secured logon application captures access identifiers that provide the connection or key to that data. It also supports the capture and storage of other identifiers, which are derivatives of the original access identifiers.

18. Access Control: The secured logon application supports access control to information and functionality on the site based on the access identifiers of the entity that are assigned to the user and the business functions (role) that are assigned to the user.

19. Access Identifier Management (Segmentation): The secured logon application enables large organizations with multiple access identifiers to define subsets of themselves for purposes of controlling access to the subsets versus the entire organization.

20. Conditional Use of Site: The secured logon application controls and keeps records of the fact that users of the site have agreed to or acknowledged the conditions for using the site prior to their use of the site.

21. Session Management: The secured logon application provides for session management at a Web site once a user has logged onto the site.

22. Multiple Registration Alternatives: The secured logon application supports multiple registration alternatives. These include online registration for users connected indirectly to the sponsor organization through an entity, auto-creation of users and entities based on feeds from trusted sources, one-step registration for person entities who are “known” based on data in the back-end systems, and temporary registration through a temporary UserID and password.

23. Notification from Back-End Systems: The secured logon application supports the receipt of information from back-end systems to change the security profiles of entities and users.

24. Notification to Back-End Systems: The secured logon application supports the notification to back-end systems of additions and changes to security profiles for entities and users.

25. Status Control: The secured logon application enables administrators to manage the status of users so that only users who are “active” may perform functions.

26. Integration with Other Security Software: Microsoft's Personalization and Membership (“P&M”) product can be utilized in conjunction with the secured logon application to provide an additional level of security for directory access protection.

The facet of Access Control includes the characteristics of Business Function, Entities, Entity types, Users, Single Sign-On, Identification of a User through a Public Name, User Roles, Multiple Ways to Determine Roles, Menus, Delegation to Third Parties, Connection to Back-End Data, Access Control, Access Identifier Management, Conditional Use of Site, Session Management, and Status Control The facet of Support for Unknown Users includes the characteristics of Known and Unknown People and Multiple Registration Alternatives. The facet of Distribution of Security Administration includes the characteristics of System Application and System Application Owners and Distribution of Security Administration. The facet of Support for Multiple Environments includes the characteristics of Sponsor Organization, System Configuration, Integration with a Port of Origin into a Web Site, and Integration with Other Security Software. The facet of Support for Systems Integrators includes the characteristics of Notification from Back-End Systems and Notification to Back-End Systems.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a diagram illustrating the relationship between an entity, a user, what the user can do (business functions), and what data the user can perform those functions on (access identifiers).

FIG. 2 is a flow chart illustrating the flow a user of the secured logon application will follow when accessing business functions setup within the secured logon application from a registered port of origin.

FIG. 3 is an exemplary help text screen.

FIG. 4 is a flowchart illustrating the User ID and AKA name conflict management process of the secured logon application.

FIG. 5 shows the arrangement of FIGS. 5A-5D, which show an example of a form post used to give a port of origin the ability to “auto-create” an entity and a user in the secured logon application

FIG. 6 is an exemplary Assign Roles screen.

FIG. 7 is an exemplary XML transaction for updating a user's access programmatically.

FIGS. 8A and 8B show exemplary screens for assigning business functions and the data to go along with them.

FIG. 9 is a diagrammatic view illustrating the organization of an exemplary Provider.

FIGS. 10-12 are exemplary screens employed in a web-based registration application for obtaining information about a person's organization and primary contact of the organization.

FIG. 13 shows a confidentiality agreement presented via a web page.

FIG. 14 is a flow chart the showing the process by which derivative identifiers are assigned.

FIGS. 15A and 15B show exemplary screens for temporarily suspending a user.

FIG. 16 is a diagram illustrating the extension of multiple delegation chains to the next level when there are multiple delegation chains from the same source entity to a target entity via different routes, and the target entity wants to delegate.

FIG. 17 is a diagram illustrating the tracking of a delegation chain by a 3-tuple of data.

FIG. 18 is a chart showing an example of possible choices displayed to a Primary Access Administrator for creating segments for his or her organization.

FIG. 19 is a chart showing an example of possible choices displayed to an Access Administrator for creating segments within his or her segment of an organization.

FIGS. 20-22 are exemplary screens used in managing the creation and contents of segments.

FIGS. 23-29 illustrate the functionality for managing delegations and the typical “Delegate Work” and “Assign Delegated Work” workflows.

FIG. 30 illustrates the conceptual relationship between key components of the secured logon application.

### DETAILED DESCRIPTION OF THE PREFERRED EMBODIMENT

The secured logon application is a stand-alone security system controlling access to secured information and self-service functionality for a sponsor organization via a secure, externally managed, dynamic menuing program that provides for controlled access to resources, such as secured information and self-service functionally, of the sponsor organization.. It can be implemented using conventional, commercially-available computer equipment and programming languages, and used for Web-based and IVR-based self-service functions. A sponsor organization can be an organization hosting the user-interface (Web site or IVR) and the back-end systems or can be an organization hosting just the user interface and passing transactions to other organization(s) for back-end processing. Although a primary application of the secured logon application is in connection with the healthcare industry, it is not healthcare specific.

Among the features of the secured logon application are that it can have differences in configuration depending on the sponsor organization; it can be integrated and blended into a Web site between an unsecured section of the site and a secured section of the site; it has access defined based on entities; it supports security for known people as well as people who are unknown to the sponsor organization prior to registration but have an indirect relationship to it through their employers; it supports the creation of different roles for different users, limited only by the number of combinations of business functions that are available (role-based assignment); it supports multiple types of entities, and permits each entity type to have specific business functions and certain access identifier types associated with it; it works for all expected users of web self-service functions, including (in the case of health benefit providers), provider organizations, physicians, employers, agencies, brokers, members, and associates; it supports the Health Insurance Portability and Accountability Act of 1996 (“HIPAA”); it supports the use of a single user ID for a given user in multiple contexts, including IVR; and it provides “hooks” to authorized underlying data.

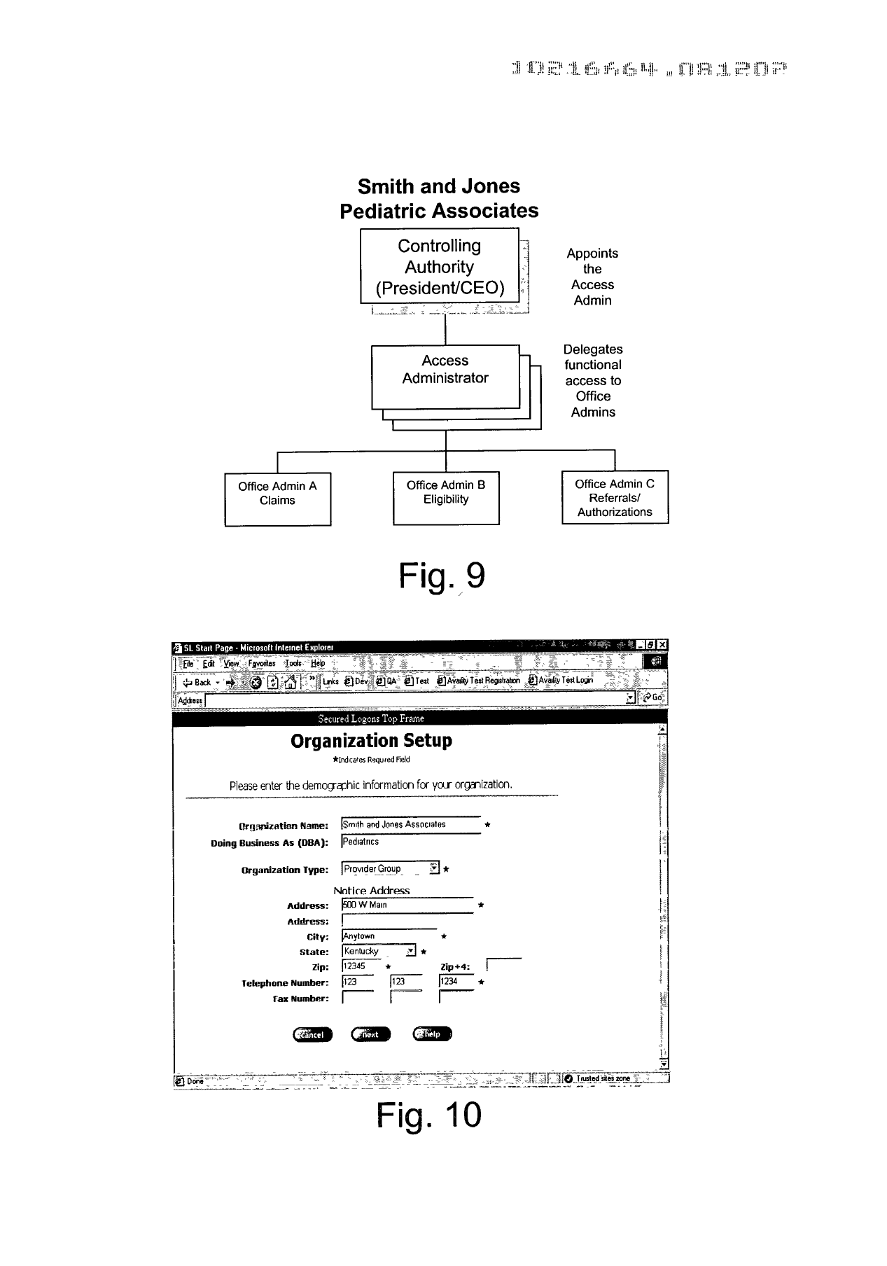

Security administration is distributed to Authorized Organizations. Each Authorized Organization must designate at least one “Controlling Authority” and one “Access Administrator.” One Authorized Organization can delegate to another Authorized Organization. However, delegation is not allowed for certain critical security activities. The organization of an exemplary doctor's office is shown diagrammatically in FIG. 9.

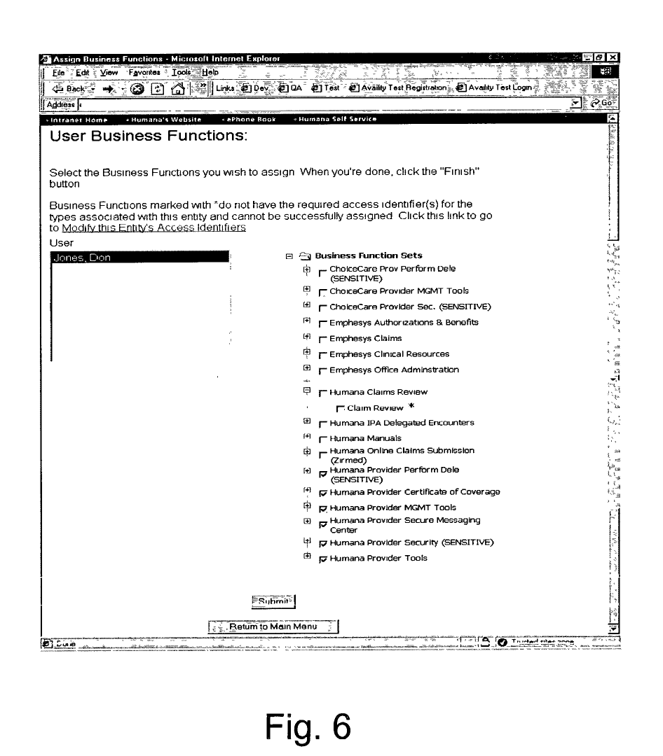

To support various organization structures, the secured logon application enables the assignment of functions based on the role the person plays in the Authorized Organization. As discussed hereinafter in greater detail, the Assign Roles function is initiated from an Assign Roles screen such as the one shown in FIG. 6.

In order to support the HIPAA, each user account, as signified by a User ID, is associated with a specific person and only that person. Further, because a single User ID is used for multiple contexts, a person can function from multiple contexts; for example, a broker can be granted a role as part of an employer's “staff” as well as that of a broker, and a physician can be not only a physician but also a member of a healthcare plan. The AKA Name provides an alternate way to refer to a user without divulging any information that can be used to log on. It is used to communicate with others about a given user account, thus enabling customer service support. It also permits a user to reuse his User ID in contexts different from where the User ID was established.

The secured logon application provides a hook to the underlying data by collecting high level identifying information. For provider organizations, in the health care industry, the high level identifying information can be the Tax ID; and for physicians, it can be the state license number(s) or similar identifying information. The secured logon application also supports interfaces to enable “segmentation” of an organization into pieces based on groupings of access identifiers and to assign permissions based on the pieces instead of based on the entire organization.

The access control concept means that the secured logon application provides a single authoritative system for maintaining user information and access rights and communicating access rights information where needed within the sponsor organization. In general access control consists of controlling which business functions a user can perform using what data and of insuring that the user is an active user while performing those business functions.

The secured logon application supports a registration process whereby a person at an organization with a relationship to the sponsor organization may register the organization as a valid entity within the secured logon application and establish a Primary Access Administrator (security administrator) for the organization's continuing use of the secured logon application.

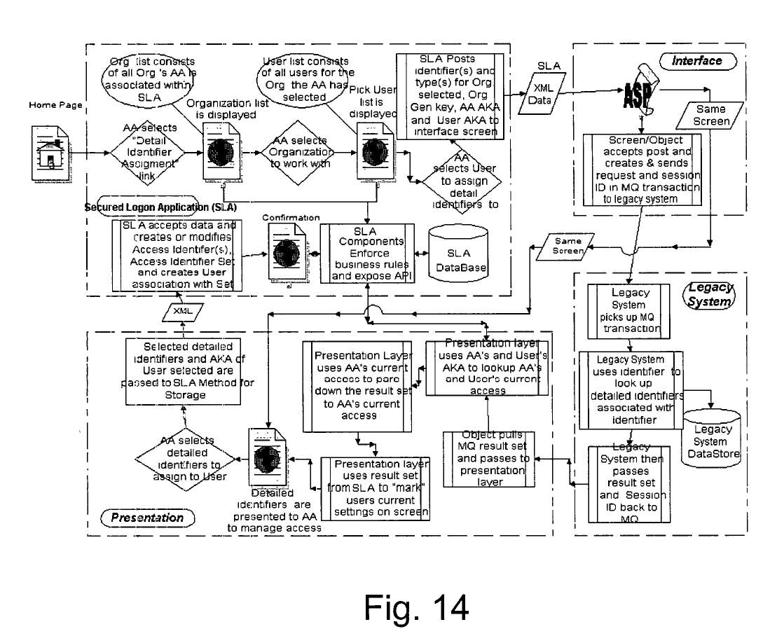

The secured logon application also enables security administration by Authorized Organizations using the web, and supports interfaces to capture access identifiers from back-end systems at a lower level than the high level access identifiers. A flow chart showing the process by which derivative identifiers are assigned is shown in FIG. 14. Access rights are granted and revoked by business function and by access identifiers. Access rights can also be delegated to other Authorized Organizations.

In order to support multiple environments, the secured logon application is customizable by portal. Screen features that can be customized include the header/logo displayed at the top of the page; a left and bottom navigation bar; the look and feel of the menu items displayed by the secured logon application via a style sheet; the location to which users are returned when they complete a business function served up by the secured logon application (this is done by setting the Port of Origin return URL in the secured logon application); the graphics used for navigation; the graphics used to designate required fields and missing data; the help text presented on each external screen provided by the secured logon application; the menu items presented to the user when access is granted; and the text of most of the error messages presented to a user while utilizing the secured logon application.

The secured logon application can include risk abatement features such as obtaining legal agreements with all Authorized Organizations, obtaining legal agreements with all users, incorporating audit processes and capabilities, and logging of all security transactions.

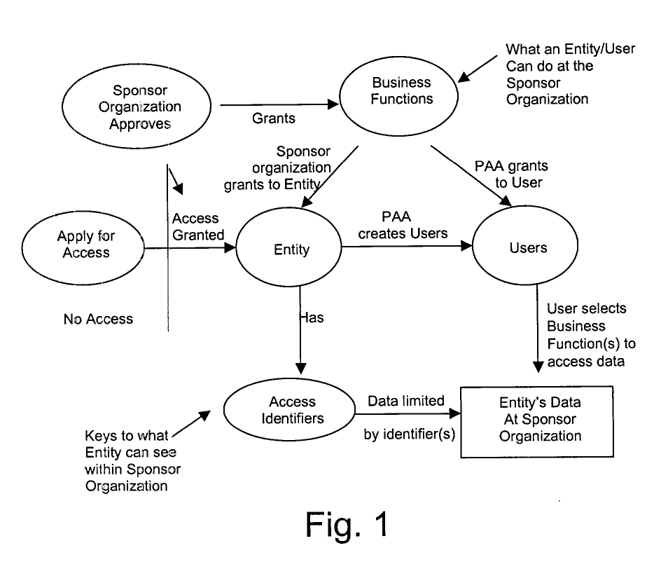

FIG. 1 illustrates the relationship between an entity, a user, what the user can do (business functions), and what data the user can perform those functions on (access identifiers).

In a preferred embodiment of the invention, the programming languages used to implement the secured logon application are: Visual Basic (VB6) (for COM objects), SQL (for stored procedures), ASP (for web presentation), HTML (for web presentation), JAVA (for COM objects), and Javascript. The database preferably is an SQL Server database.

I. Primary Facets of the Secured Logon Application

There are five primary facets of the secured logon application:

1. Access Control: Control of access to secured information and self-service functionality for a sponsor organization.

2. Support for Unknown Users: Enable access to users who have indirect relationships to the sponsor organization as well as to users who have a direct relationship with the sponsor organization.

3. Distribution of Security Administration: Distribution of security administration from a central information technology resource to various users of the secured logon application.

4. Support for Multiple Environments: Support for integration into different kinds of environments.

5. Support for System Integrators: Support for system integrators who need to interface with and use the information in the secured logon application in order to execute their business functions.

Each of these is discussed in more detail below.

II. Access Control

On a very high level, access control consists of controlling which business functions a user can perform using what data and of insuring that the user is an active user while performing those business functions. The items that are included in a dynamic menu can also be considered part of Access Control.

A. Control of Which Business Functions a User Can Perform Using What Data

The control of which business functions a user can perform using what data has many inter-relating facets to it. This is more complex than what might generally be expected because of the support within the secured logon application of delegation and segmentation. Delegation is the granting of permissions from one organization to another organization. Segmentation is support for defining pieces of an organization (segments) and assigning permissions for the pieces instead of the entire organization. The explanation of the facets and how they work together starts with a discussion of the building blocks used in this control, continues with concepts and structures that relate the building blocks, and ends with the rules governing how things can be built.

B. Building Blocks Used in Control of Which Business Functions a User Can Perform Using What Data

The basic building blocks used in control of which business functions a user can perform using what data are listed below

Entity—An entity is an organization or person with whom a sponsor organization has a business relationship. Entities are also third party organizations doing business with the entities having a relationship with a sponsor organization. Examples applicable at a healthcare company as the sponsor organization are:

Organization entities—provider group, an insurance agency, an employer;

Person entities—member (person insured by a healthcare company), broker, physician; and

Third party entities—billing organizations, collection organizations.

Business Function—A business function is some function or activity that a user can perform

Access Identifier—For those entities that have data about them in the back-end systems of a sponsor organization, Access Identifiers are the keys to that data. An example of an access identifier for a provider group is the group's TIN (Tax ID Number).

Access Identifier Type—This is a categorization of the access identifiers that are set up to identify entities.

User—An individual who has been authorized by an entity to gain access to business functions and information that are secured by the secured logon application.

Key Positions at Entities—Each entity has to have specific people identified for a couple of positions—a person who can legally bind the organization (Primary Controlling Authority—PCA) and a person who is responsible for security administration (Primary Access Administrator—PAA). For the person entities, the PCA and PAA generally are the person himself or herself. For non-person entities, the PCA and PAA are people and they can be the same person. There are two other positions at entities which are optional. An Access Administrator (AA) can be another person who has security administration responsibilities. An Office Administrator (OA) can be another person who does not have security administration responsibilities.

Security Account Administration Functions: Several business functions are available to PAAs and AAs to perform account administration activities. There is a set of these functions for non-owner entities and a set for owner entities. Chief among them for non-owner entities for access control purposes are Assign Web Access Rights, Manage User Status, Segment Your Organization, Delegate Work to Another Organization, Change Work Delegated to Another Organization, Stop Delegation to Another Organization, and Assign Delegated Work to Staff. The ones for owner entities are Grant Access to Organization and Establish New Function.

C. Concepts and Structures (Database Tables) That Relate the Building Blocks Used in Control of Which Business Functions a User Can Perform Using What Data

There are several key concepts and tables that relate the basic building blocks together. They are explained below.

1. Concept: Entity-Users—Users Operate Only in the Context of an Entity

In order to use the system, each user needs to have the context(s) in which he or she uses the system defined. In general, the context is the entity that authorized the user access to business functions and information. Having the context will drive what kinds of business functions and data are available to the user.

2. Structure: ENTITY_USER Table

The Entity_User table associates a user with an entity, and therefore provides the context in which the user can operate.

3. Concept: Primary Access Identifiers and Derivative Access Identifiers

The secured logon application divides Access Identifiers into two broad categories: Primary and Derivative. Although this distinction is key to the secured logon application's processes, it is, or can be obscure, to Administrators (Primary Access Administrators—PAA, and Access Administrators—AA). Primary Access Identifiers are explicitly defined. The initial set-up is done by the IT security personnel of the sponsor organization, and the information is gleaned from the entity's registration information. Additional Primary access identifiers can be added later. Most often the Primary access identifiers are at the highest, most general level, often a Tax Identification number, or Social Security Number, or physician state license number, or an insurance company issued employer group number. The Derivative access identifiers derive from the primary access identifiers. A “first level” Derivative access identifier would have a primary access identifier as its “parent;” a “second level” Derivative access identifier would have a Derivative access as its “parent;” etc. Derivative access identifiers are either equivalent to a primary access identifier or they represent “subdivisions” of what the primary access identifier represents. A sub-division could be a division, department, site, location, or employer sub-group. For example, a hospital whose primary access identifier is a Tax Identification number may have Derivative identifiers that represent departments within the hospital, such as Billing, Admissions, or Scheduling. Derivative access identifiers at the lowest level can represent an individual or a location, unit, or department, depending upon the level of detail stored in a particular back-end system.

Reporting and control requirements require that we be able to create a hierarchy amongst the primary and derivative access identifiers for an entity. To accomplish this, the secured logon application tags each Derivative access identifier with the identity of its parent, thus providing a back-link field to represent a tree structure. All derivative access identifiers are back-linked to either another derivative access identifier or to a primary access identifier. The table design permits a tree to be any number of levels deep. They all are rooted in a Primary access identifier. There can be multiple nodes below any given node (multiple branches).

4. Structure: ACCESS_IDENTIFIER Table

The secured logon application will store the primary and derivative access identifiers in the Access Identifier table. This table contains the access identifier value and access identifier type; the entity to which it relates; an indication about whether it is a primary or Derivative access identifier; the identity of the parent for a Derivative access identifier; and short and long descriptions.

5. Concept: Segmentation of an Entity Based on Groupings of Access Identifiers

The entities that access the secured logon application can vary in size. Most entities will have just one Access Identifier. Other entities, generally large entities, such as large hospitals may have dozens, hundreds, or even thousands of identifiers. For those entities that have multiple access identifiers, segmentation is the definition of pieces of an organization (Segments) based on groupings of the access identifiers and assigning permissions for the pieces instead of the entire organization. In this way, different groups of people within the organization can work with information specific to the part of the organization in which they work.

6. Structure: ACCESS_GROUP and ACCESS_GROUP_ID_ASSOC Tables

The definition of a segment is stored in the ACCESS_GROUP table, and the association of which access identifiers make up a segment is stored in the ACCESS_GROUP_ID_ASSOC table.

7. Concept: Many Business Functions Use Data

Most of the business functions work with certain types of access identifiers in order to get to data keyed by that access identifier type. For example, “view member claims” needs a member ID type of access identifier in order to display the appropriate claims; “review employer bill” needs an employer group number type of access identifier in order to display the appropriate bill. Some business functions do not require an association with a specific set of data, for example, a business function for reference information and the security functions. A record is kept of which business functions work with which access identifier types and which business functions do not require any access identifier in order to work.

8. Structure—BUS_FUNC_ID_TYPE_ASSOC (BFITA) Table

This table defines the Access Identifier types that must be associated with a business function. A given business function can be associated with more than one Access Identifier Type. If this table has no entry for a business function then the business function does not require any data.

9. Concepts: Delegation

There are many organizations that want a specialist to do the work for them. It is often done to save money, or provide superior service, or to handle extended hours of operation, or because it is too difficult for the organization to hire, train, and maintain people to do the particular job.

The secured logon application enables one entity (the “BehalfOf entity”) to allow another entity (the “Admin entity”) to do work on its behalf. This is referred to as delegation. Delegation typically is done by smaller organizations.

An example is a small physician's office that contracts with a third party administrator (TPA) to process insurance claims with government agencies; it can also contract with another company, acting as another TPA to deal with other insurance companies.

10. Concept: Delegation Chain

The secured logon application allows a delegated-to entity (Admin entity) to allow yet another entity to do work on the original entity's (BehalfOF entity) behalf. This can continue until there is a string of entities who can do work on behalf of the original BehalfOF entity, where each entity in the string received the delegated permissions from the entity directly ahead of it in the string. This is referred to as a delegation chain.

11. Structure: DELEGATION Table

The Delegation Table contains information about the business functions and data that have been delegated by one entity to another and the definition of the delegation chains.

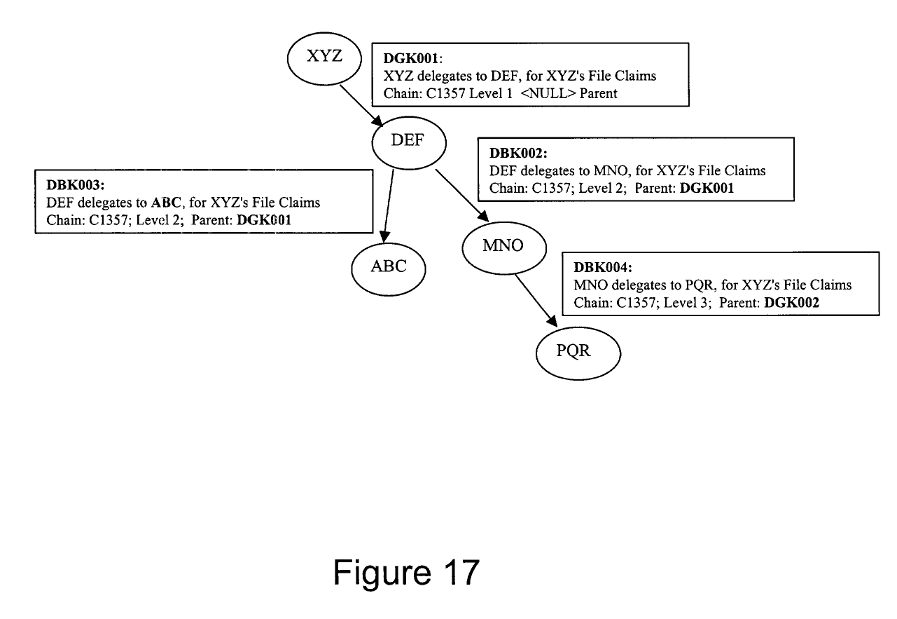

Referring to FIG. 17, a delegation chain is tracked by a 3-tuple of data, the chain identifier, the level, and the parent. The chain groups the delegations for a particular entity/business function/data set. For example, when XYZ delegates “File Claims” to DEF, a chain ID of “C1357” is assigned. When DEF furthers the delegation by delegating to ABC, the delegation has the same chain ID of “C1357”. The first delegation from XYZ to DEF is level 1, and the second delegation from DEF to ABC is level 2. The parent value points to the row that gave the delegation. The delegation from XYZ to DEF has no parent, so is NULL. The delegation from DEF to ABC has a parent of XYZ to DEF's row.

It is possible for DEF also to delegate the same work to MNO. This delegation by DEF to MNO will have the same chain ID, the same level, and the same parent value as the delegation by DEF to ABC.

DELEGATION Table snippet (not all columns shown): See FIG. 17

| Delegation | | | | | | | | | |
|---|---|---|---|---|---|---|---|---|---|
| _Gen | BehalfOf | Admin | GrantedBy | | | | | | |
| _Key | Entity | Entity | Entity | Data | Bus_Func | Chain | Level | Parent | Explanation |
| DGK001 | XYZ | DEF | XYZ | DI200 | File | C1357 | 1 | <NULL> | XYZ |
| | | | | | Claims | | | | delegates to |
| | | | | | | | | | DEF |
| DGK002 | XYZ | ABC | DEF | DI200 | File | C1357 | 2 | DGK001 | DEF |
| | | | | | Claims | | | | delegates to |
| | | | | | | | | | ABC for |
| | | | | | | | | | XYZ |
| DCK003 | XYZ | MNO | DEF | DI200 | File | C1357 | 2 | DGK001 | DEF |
| | | | | | Claims | | | | delegates to |
| | | | | | | | | | MNO for |
| | | | | | | | | | XYZ |
| DGK004 | XYZ | PQR | MNO | DI200 | File | C1357 | 3 | DGK003 | MNO |
| | | | | | Claims | | | | delegates to |
| | | | | | | | | | PQR for |
| | | | | | | | | | XYZ |

This design will handle the following kinds of delegations and actions, where “=>” represents delegation: two paths from one node to another node: A=>B=>D and A=>C=>D (the D node is connected to A via two paths and each path is tracked separately); many-to-one mapping: A, B, C, D, E, . . . =>Z; any level of sub-trees; a simple tree of just F=>G; walking back-up a path; and reconstruction of the entire tree.

12. Concept: Real Entity Users and Virtual Entity Users—An Extension to the Entity-User Concept

In order for the secured logon application to provide Delegation, the secured logon application must have two kinds of Entity-User—a real one and a virtual one. A real entity-user is one in which the user works for the entity on whose behalf he is doing work. A virtual entity-user is a user who is employed by one company (Admin entity) and is doing work on behalf of a different company (BehalfOF entity) that has delegated work to the Admin entity.

13. Structure: ENTITY_USER Table

This is the same Entity_User table referenced earlier. In the earlier reference, only one entity field was described. In reality, there are three entity fields that are necessary in order to support delegation; namely, GrantedBy_Entity_Gen_Key, Admin_Entity_Gen_Key, and the BehalfOf_Entity_Gen_Key. The GrantedBy_Entity_Gen_Key contains an identification of the entity whose user caused the entity-user row to be created. The Admin_Entity_Gen_Key contains an identification of the entity the user really works for. The BehalfOf_Entity_Gen_Key contains an identification of the entity on whose behalf he is doing work. The real and virtual entity-users are differentiated by the GrantedBy_Entity_Gen_Key and by the relationship between the Admin_Entity_Gen_Key and the BehalfOf_Entity_Gen_Key. In the case of the real entity-user, this field will be populated. In the case of the virtual entity-user, the GrantedBy_Entity_Gen_Key will be NULL. Also, in the case of the virtual entity-user, the Admin_Entity_Gen_Key (entity the user works for) and the BehalfOf_Entity_Gen_Key (entity on whose behalf he is doing work) will be different.

14. Concept: One Table Controls the Business Function—Data Combinations a User Can Use and a User's Role is Determined by the Business Functions and Data Assigned

The secured logon application limits the data to which a PAA, AA, or OA has access. For business functions that require data, the secured logon application associates specific data with a specific business function for the user. Since business functions are individually assigned and since they are recorded along with the data they may operate against in the EUA table, each user may have business function/data assigned specific to that user's role in his or her organization.

15. Structure: ENTITY_USER_ACCESS (EUA) Table

The ENTITY_USER_ACCESS (EUA) Table defines the access rights a User has for a External Entity in terms of the Business Function:Data pairs with which the User can work.

16. Concept: A Given EUA Entry Can Result from Multiple Delegations,

It is possible to have multiple paths from one entity to another entity in delegation. For example, in the case of A=>B=D and A=>C=>D where “=>” represents delegation, there are two paths from A to D. Extending this idea further, if D=>E, both of A's delegation chains to D will be extended to entity E. There would be EUA entries for the users in D doing work for A and for users in E doing work for A.

17. Structure: EUA_DELEGATION_ASSOC Table

The EUA_DELEGATION_ASSOC table documents why a virtual user has access to a “business function:data pair”. In conjunction with the EUA entries in the Entity_User_Access table, there will be an entry made in the EUA_DELEGATION_ASSOC table to justify each EUA entry resulting from delegation.

18. Concept: Business Function Can Operate on Segments or Not

For some business functions, it makes sense for that business function to operate on discrete segments or parts of an organization. An example would be “View Claims” in a large hospital, where it would be useful to be able to “View Claims” for each department individually. For other business functions, it does not make sense for that business function to operate on discrete segments or parts of an organization. An example would be “Reference Material”.

19. Concept: A Business Function Can Be Delegatable or Not

For some business functions, it makes sense for that business function to be delegated from one organization to another organization. An example for a provider organization delegating to a third party billing service would be “Submit Claims”. For other business functions, it does not make sense for that business function to be delegated from one organization to another organization. An example would be any of the security account administration functions.

20. Structure: BUSINESS_FUNCTION Table

The Business_Function table defines each Business Function that is controlled by the secured logon application and records whether or not each business function can operate on segments and whether or not each business function can be delegated.

21. Concept: Hierarchy of Permission Granting

The secured logon application uses a hierarchy to allow people to access business functions and information (data). The primary control for all business function and data access is the IT Security group of the sponsor organization. They create the entities that represent providers, insurers, payers, third party administrators, members, agencies, brokers, etc. A part of the set-up is the creation of the Primary Access Administrator (PAA) for an entity. A PAA is a person who is given the complete set of business functions and information access that the entity is permitted to have. This is the first layer of the assignment hierarchy.

When the PAA wants to assign business functions and information access to people who work for the same entity as the PAA, the process is called “Assignment” and the PAA follows the “Assign Access” workflows. The PAA can give other people in his or her organization authority to use the “Assign Access” workflow, thus creating Access Administrators (AAs). This is the second level of the hierarchy. The AAs do not have to have the same set of business functions and information access as the PAA, although the secured logon application permits the AA to be a peer. It is noted that even if an AA has the same set of business functions and information access, he or she is still not a PAA. The PAA has special meaning within many of the secured logon application work flows and can only be created and changed to another individual via intervention from the IT Security group of the sponsor organization.

When the PAA or an AA at an organization wants to delegate business functions and information access to people who work for a different entity, the process is called “Delegation” and the PAA/AA follows the “Delegate Work” workflows. When Delegation happens, the PAA at the receiving organization receives the rights to the delegated business functions and information access and may assign them to his or her staff. This is another level of the hierarchy.

When the PAA at an organization that has received delegated rights wants to assign those rights to people who work for his or her organization, the process is called “Assign Delegated Work” and the PAA follows the “Assign Delegated Work” workflow. The PAA can give other people in his or her organization authority to use the “Assign Delegated Work” workflow. This is another level of the hierarchy.

Another path of the hierarchy goes from the IT Security group of the sponsor organization to the System Application Owners. These System Application Owners have control over the assignment to PAAs of the functions they control. Thereafter, the flow is as outlined above from the PAAs outward.

The key points of distributed security administration are that all authority flows first from the IT security personnel of the sponsor organization outward:

From IT security personnel
To an entity PAA
To an AA at the entity
To an Employee at the entity
To an Employee at the entity
To the PAA of another entity
To an AA of the other entity
To an Employee of the other entity
To an Employee of the other entity
To a System Application Owner
To an entity PAA
To an AA at the entity
To an Employee at the entity
To an Employee at the entity
To the PAA of another entity
To an AA of the other entity
To an Employee of the other entity

D. Rules Used in Control of Which Business Functions a User Can Perform Using What Data

There are eight rules relating to permissions granted to key positions, which are as follows:

1. The secured logon application permits only one active PAA for an entity.

2. The secured logon application protects the PAA's permissions. Only the sponsor organization IT Security personnel or System Application owners can change the PAA's base access. Delegated access to a PAA is changed by the delegators. An AA in the same entity cannot change the PAA's access.

3. The PAA's permissions can be changed in one of three ways—replacing the PAA, adding functions to the PAA, and removing functions from the PAA.

a. If a PAA is replaced, a new PAA is named. The new PAA receives all the permissions that the prior PAA had. The prior PAA does not have any permissions automatically removed, other than the fact that he or she is no longer the PAA.

b. A PAA may have business functions added or removed only by the sponsor organization IT security personnel or System Application Owners.

4. If business functions are added to a PAA, the PAA must assign or delegate them out to others in order for others to perform those business functions.

5. If business functions are removed from a PAA for an entity, they are automatically removed from anyone within the entity to whom they have been previously assigned and they are automatically removed from any user within any other entity to which they have been delegated.

6. An AA can change the rights of any other AA or OA, but only to the extent of that AA's rights. In this example, “D” stands for the data assignment and “BF” stands for the corresponding business function assignment. Assume, for example, that Harry's PAA gave OA Harry rights D1-BF1, D1-BF2, D2-BF144, and D2-BF145, and that there are two AAs: Joan and Bella. Joan has Harry's rights and in addition she has rights: D3-BF1, D3-BF2. Joan can remove rights from Harry, or give him one or more of the D3 access pairs. AA Bella only has access to D1-xx, so she can only add or remove D1-xx functions from or to Harry; she cannot change Harry's D2-xx rights in any way. Joan can also give or remove access from Bella. Bella can only remove access from Joan for the D1-xx data pair business functions.

7. If an AA is terminated, or his or her permissions are revoked, the termination or revocation will have no effect upon any person he or she has assigned access to, delegated to; or “assigned delegated access” to.

8. Rights, once granted, can only be removed either explicitly or through cascading delete due to a revocation of delegation.

There are three rules relating to explicit business function assignment, which are as follows:

1. The determination of which business functions a user can perform using what data starts with the assignment of business functions to a user. There are multiple ways in which this can happen:

a. IT security personnel to PAA when an application is approved or during a “Manage PAA Roles” process or during a “Mass Assignment” process. This will be done in an entity type context.

b. IT security personnel to an AA or OA during an “Add an Administrator” process or “Manage AA Roles” process. This will be done in an entity context.

c. PAA or AA to an AA or OA during a “Register New User” process or “Assign Access Rights” process. This will be done from within a Port of Origin and in an entity context.

d. System Application Owner to a PAA during a “Grant Access to Organization” process or during an “Establish New Function” process. This will be done from within a Port of Origin and in an entity type context.

e. PAA or AA of one organization to PAA of another organization during a “Begin Delegation” process, “Change Delegation” process, or “Stop Delegation” process. This will be done from within a Port of Origin and in an entity context.

f. For delegated rights, PAA or AA of a delegated to organization to an AA or OA of that same organization during a “Assign Delegated Rights” process. This will be done from within a Port of Origin and for a chosen Behalf~f entity.

g. Transaction Acceptor through the PAA Function Data Access transaction (adds access identifiers and then corresponding rights to those access identifiers through previously assigned business functions) and the User Access Transaction (adds business functions/data pairs to a user for an entity). These will be done in an entity context.

2. In all cases except for the transaction acceptor, a screen is displayed that shows the business functions available for assignment. An exemplary screen is shown in FIG. 6. The screen initially comes up showing only business function sets. By clicking on the box with a plus sign to the left of a business function set, the set is expanded to show the business functions within it. In cases where business functions have already been assigned and the process is not a “mass assignment” process, the screen also indicates the business functions or business function sets currently assigned by showing check marks in the boxes.

3. The determination of which business functions are available for assignment in each of the above circumstances differs:

a. IT security personnel to PAA:

i. Determine the entity type of the PAA's entity or the entity type being used for “mass assignment.”

ii. Determine the business function sets that can be granted to that entity type.

iii. Look up the business functions that are part of the business function sets.

b. IT security personnel to an AA or OA

i. Look up the business functions that the PAA for the selected entity has.

c. PAA or AA to an AA or OA:

i. Look up the business functions that the administrator has for the selected entity that are valid for the Port of Origin in which the process is being done.

d. System Application Owner to PAA

i. Look up the business functions which are registered with the system application owner that are valid for the selected entity type and the Port of Origin in which the process is being done.

e. PAA or AA of one organization to PAA of another organization

i. Look up the business functions that the administrator has for the selected entity, that are valid for the Port of Origin in which the process is being done, and that are “delegatable”.

f. For delegated rights, PAA or AA of a delegated to organization to an AA or OA of that same organization

i. Look up the business functions that the administrator has for the delegated from organization (BehalfOF entity) and that are valid for the Port of Origin in which the process is being done.

g. Transaction Acceptor to non-PAA User

i. Validate that the function being assigned has already been assigned to the PAA of the selected entity.

There is one rule relating to implicit business function assignment, which is as follows:

1. The secured logon application supports the implicit assignment of business functions under some circumstances. Two features must be present in order to support implicit business function assignment. The first is a set of rules, codified in database tables, of what business functions are to be assigned under what conditions. The second is a means of determining the conditions under which a user logs in, so that those conditions can be matched to the rules relating to those conditions in order to determine the appropriate set of business functions.

There are fourteen rules relating to assignment of data with the business function, which are as follows:

1. The second step in the determination of which business functions a user can perform using what data is the association of specific data to an assigned business function.

2. Whenever the assignment is to a PAA and the business function requires data, all existing access identifiers for the entity that are appropriate for the business function are associated automatically with the business function.

3. When the assignment is not to a PAA and the business function requires data and the business function is not “segmentable”, then all existing access identifiers for the entity that are appropriate for the business function are associated automatically with the business function.

4. When the assignment is not to a PAA and the business function requires data and the business function is “segmentable” and there is only one existing access identifier for the entity that is appropriate for the business function and no segment contains it, then that one access identifier is associated automatically with the business function.

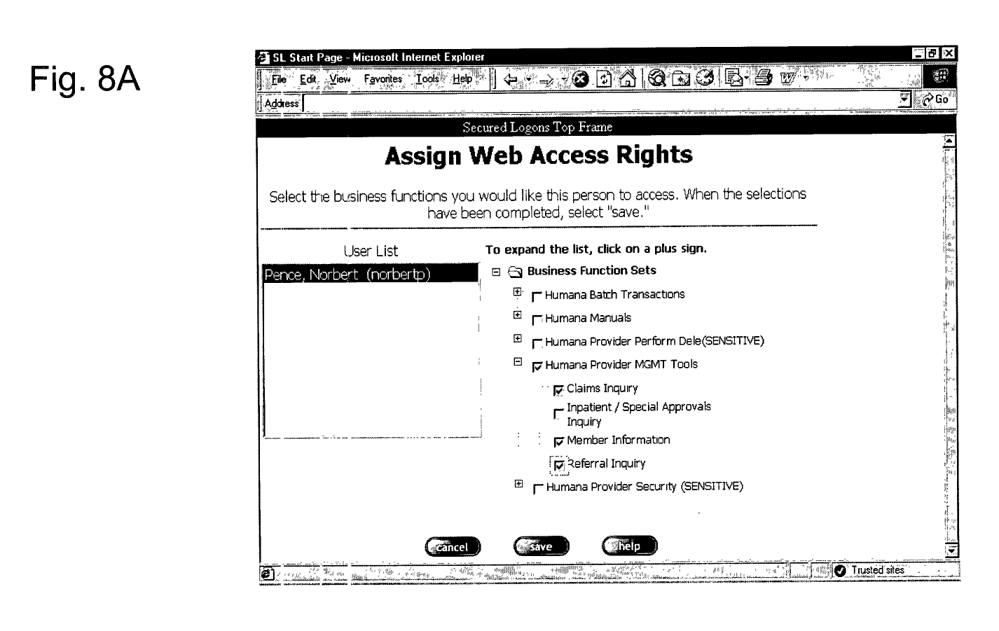

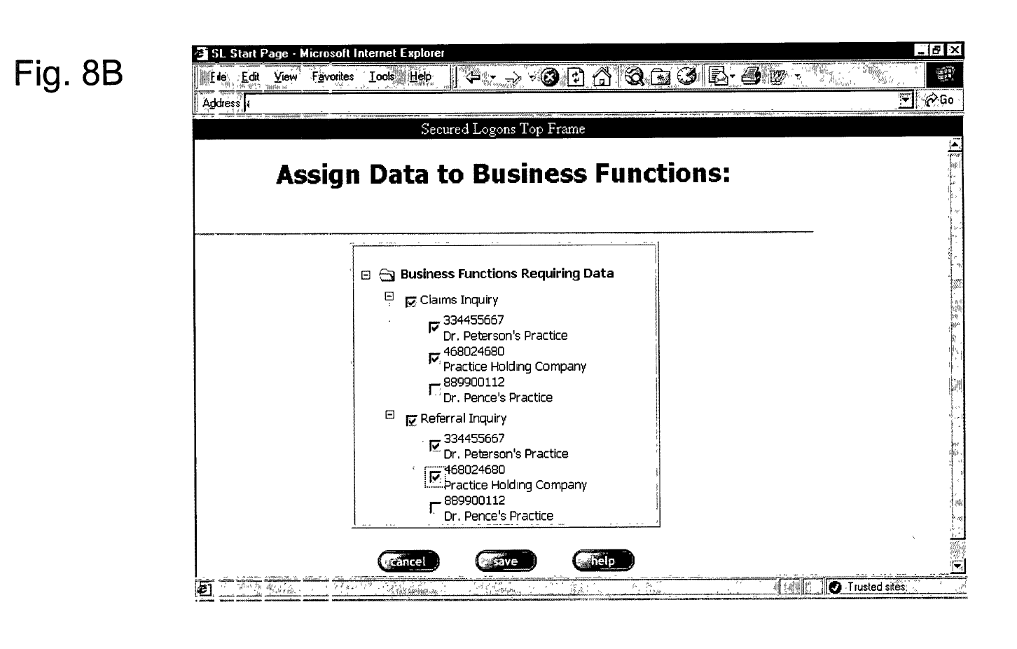

5. When the assignment is not to a PAA and the business function requires data and the business function is “segmentable” and there are multiple access identifiers and/or segments for the entity that are appropriate for the business function, then an “assign data” screen appears to assign data to that business function. FIGS. 8A and 8B illustrate the sequence of assigning business functions and data associated with them.

6. If a business function does not require data, then it is assigned with no data designation in the EUA table and possibly also the Delegation table.

7. If a business function requires data, at least one access identifier of an appropriate type must exist in order to complete the assignment. If one does not exist, the business function is not assigned.

8. If a business function is “segmentable,” it must be associated with at least one access identifier type in the BFITA table. Otherwise, it is not possible to assign segments or pieces of the organization to it.

9. A segmentable business function can be associated with primary access identifiers and or segments. The Administrators can assign a person a business function associated with one or more primary access identifiers; one or more Segments; or any combination of Segments and primary access identifiers.

10. The assignments of a primary access identifier and a segment containing that access identifier for the same business function are independent of one another. If this occurs and later, the primary access identifier is removed from the segment, the direct assignment of the primary access identifier and the business function remains. For example, if a person is assigned a Primary access identifier of Tax ID of 222334444, and that same access identifier is included in a Segment, then when the Primary access identifier is removed from the Segment and nothing else is changed, the person will still have access to the Tax ID.

11. When assigning the data on which a business function is to be performed during the “Assign Access” workflow or the “Delegate Work” workflow, an AA can only assign access to another AA or OA to the extent that the AA has access himself or herself. The data that can be chosen is represented (a) by the Segments that have been assigned to the administrator for the function and proper subsets of those segments as long as they contain at least one individual access identifier of a type that the business function uses and (b) by the Primary access identifiers to which the administrator has rights for the business function (by design these primary access identifiers must be of a type appropriate for the business function).

12. In the assignment of access identifiers during the “Assign Access” workflow or the “Delegate Work” workflow, it is assumed that the PAA will have access to all Segments. This is true even when an AA assigns Derivative access identifiers to a Segment and the PAA has not worked with the new Derivative access identifiers directly, because the PAA has access to all the Primary access identifiers. Since all Derivative access identifiers are derived from one of the Primary access identifiers, the PAA has access to all the “parents” of Derivative access identifiers. The secured logon application ensures that if someone has access to the Parent access identifier, then he or she also has access to every Derivative access identifier.

13. A business function can be delegated without any data associated with it if and only if the business function does not require access IDs in its normal use.

14. At the time of business function invocation, the secured logon application will expand a Segment into the individual access identifiers that make it up according to the following steps:

a. Each Segment will be looked up to find its individual access identifiers

b. The union of the individual access identifiers of the Segments and assigned individual access identifiers will be found giving the full set of individual access identifiers; and

c. The full set of individual access identifiers will be filtered based upon the types of access identifiers that the business function is allowed to process.

The resulting filtered group is the set of access identifiers that the person can use with the business function. It is possible that the resulting set is NULL

There are fifteen rules relating to segments, which are as follows:

1. A Segment is a collection of one or more access identifiers that “belong to” one entity. The Segment can contain any combination of Primary and Derivative access identifiers.

2. When an access identifier is added to a segment, it becomes available immediately everywhere that segment is referenced. Similarly, when an access identifier is removed from a segment, it is immediately removed everywhere that segment is referenced.

3. An access identifier can be an element of zero, one, or more Segments, the only restriction being that the Segment must be on behalf of the same entity with which the access identifier is associated.

4. Within a Segment an access identifier can exist only once.

5. A Segment may not contain another segment.

6. A Segment can exist without any members in it.

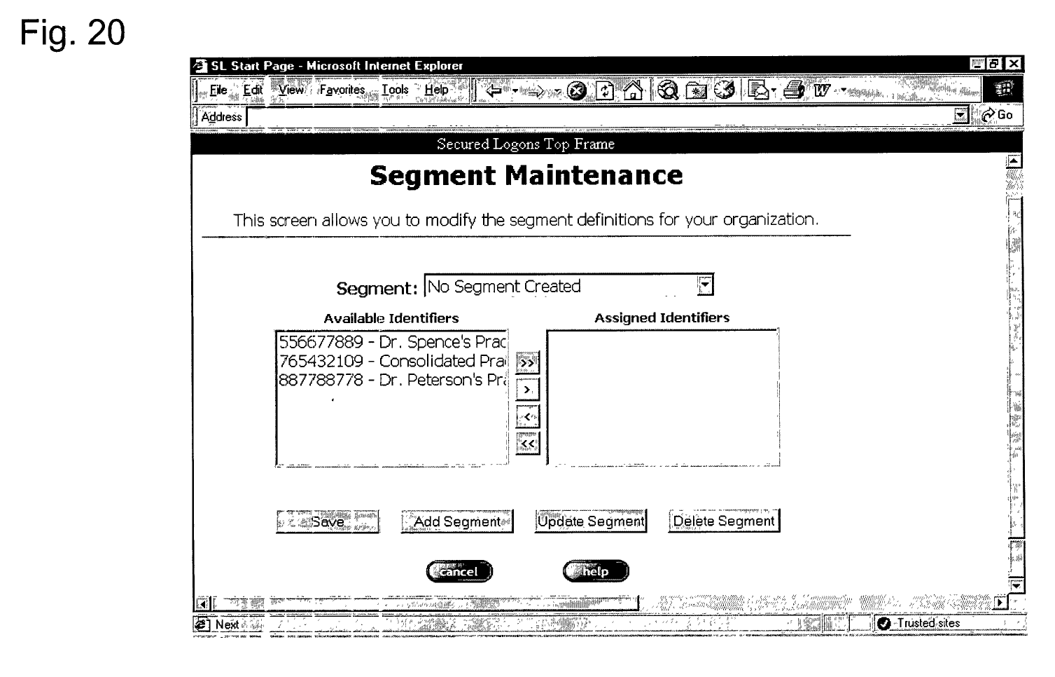

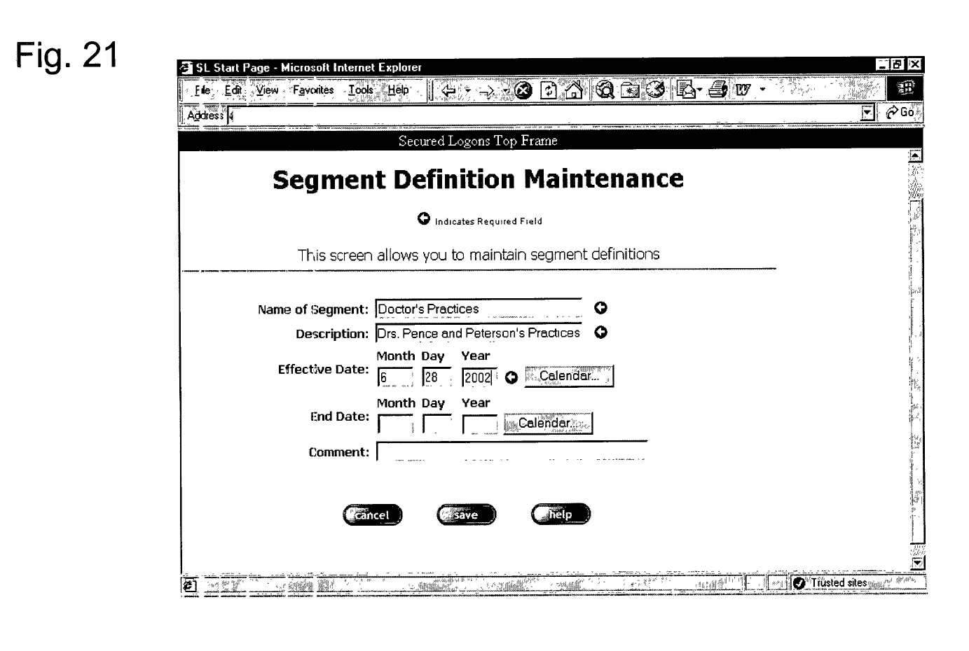

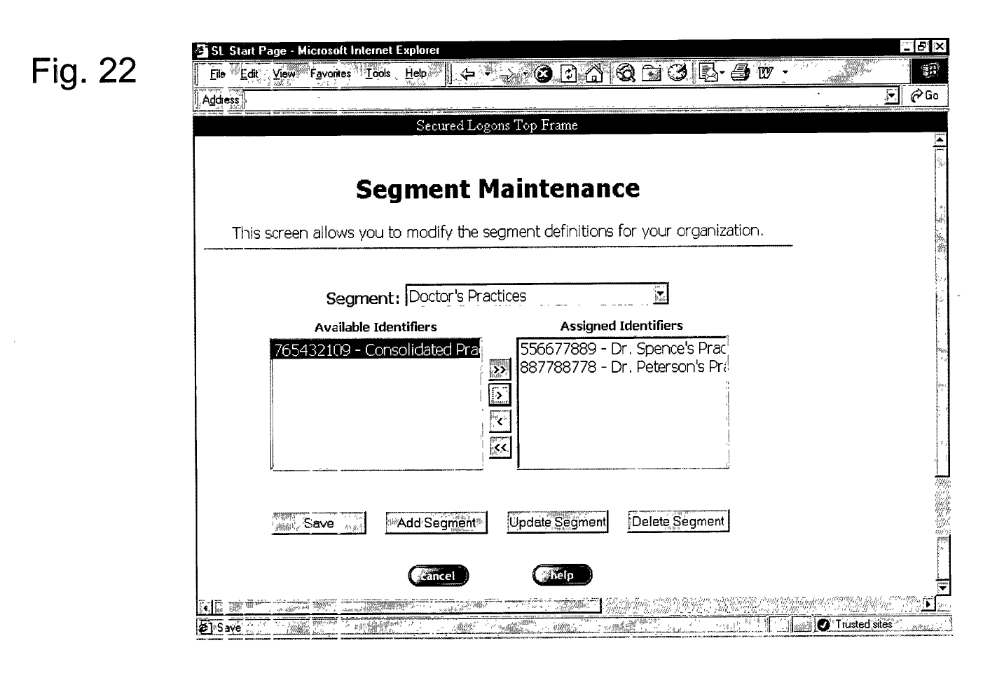

7. The Manage Segments function enables an administrator to manage the creation and contents of Segments. FIGS. 20-22 illustrate the process of creating a segment definition and then determining its contents.

a. If Derivative access identifiers are possible, a link is provided in the Manage Segments function to enable the user to pick up any Derivative Identifier that has not previously been chosen for use in Segment content definitions.

8. The PAA assigns, or withholds permission to an administrator to work with segments via assignment of the Manage Segments function. If an AA does not have the Manage Segments business function, then he or she would not be aware of Segments except to the extent he or she has been assigned a Segment in the context of performing a business function using the data defined by the Segment.

9. The Manage Segments function is associated with access ID types in BFITA.

a. It is necessary to associate the Manage Segments function with access ID types in BFITA so that when a derivative link is activated and it wants to know what data it has to work with for a “parent” access identifier, the derivative link gets the appropriate data. As an example, for agencies and brokers, the function would be based on an access ID type of tax ID as a parent and an access ID type of an Agency Location ID as a parent. These access ID types are the only ones that can actually result in derivatives.

b. Associating the Manage Segments function with access ID types in BFITA is also done so that administrators can be assigned to Manage Segments for specific segments of the organization.

i. A consequence of assigning segments of the organization for an administrator to manage via the Manage Segments process is that the administrator may have access to more data for a different function if a broader or different segment is assigned for the other function.

10. A PAA can work with all Access identifiers when defining the contents of a Segment.

11. The identifiers that an AA can work with when defining the contents of a Segment are determined as follows:

a. When the AA was assigned the Manage Segments business function, the person who assigned it indicated what data the AA could work with for Maintain Segments. The data assigned is in the form of Segments or Primary access identifiers.

b. Determine all the Primary access identifiers in the Segments, all the derivative access identifiers in the Segments, all the Primary access identifiers directly assigned, and all the access identifiers that have been derived from the Primary access identifiers. This constitutes all the access identifiers that the AA can work with.

12. A PAA can work with all Segments for his or her entity when using the Manage Segments function.

13. The Segments that an AA can work with when using the Manage Segments function are determined as follows (results in a list of segments, each of which consists of access identifiers that are directly or indirectly assigned to the AA to use in Manage Segments)

a. Determine the identifiers the AA can work with when defining the contents of a Segment as above.

b. Determine the Segments which consist entirely of access identifiers in the above list.

14. If a segment is delegated from one organization to another, the PAA and AAs at the receiving organization will not be able to see the individual items within the segment and cannot define segments of their own of the items within the original segment or of primary access IDs that were individually delegated.

15. Segments may be created and maintained by both user interface-based processes (Manage Segments) and Transaction Acceptor transactions.

Two examples of the use of segmentation are as follows:

### EXAMPLE ONE

Jefferson Hospital System started as Jefferson General Hospital, a large big city hospital. It has grown by acquisition such that it now owns facilities that were once thirteen separate organizations. Each of these facilities has retained its original tax ID.

Megan is the VP of Business Operations for Jefferson and runs all the administration for the Jefferson Hospital System. She has three directors of Business Operations—Charles who oversees the facilities on the East Side of town, Linda who oversees the facilities in the downtown area, and Peter who oversees the facilities in the suburbs.

Two business activities are conducted online—claims processing and referral processing. Megan has asked Charles to handle the Referral Processing for the entire organization. Claims Processing is handled by the individual operations.

With these parameters, the organization is structured as follows:

Charles handles:

East Side Family Clinic—Tax ID=TINA

East Side MRI Center—Tax ID=TINB

East Side Outpatient Surgi-Center—Tax ID=TINC

East Side Rehab—Tax ID=TIND

East Side Hospital—Tax ID=TINE

Linda handles:

Sisters of Mercy Hospital—Tax ID=TINL

Jefferson General Hospital—Tax ID=TINM

Peter handles:

Middletown Hospital—Tax ID=TINF

Chester Hospital—Tax ID=TING

Johnson City Hospital—Tax ID=TINH

Kingston Hospital—Tax ID=TINI

Cold Springs Hospital—Tax ID=TINJ

Bristol Hospital—Tax ID=TINK

Charles has four administrators working for him. Cathy handles the East Side Family Clinic; Charlotte handles the specialty facilities (East Side MRI and East Side Rehab); Connor handles the East Side Outpatient Surgi-Center and the East Side Hospital; and Chris handles the Referral Processing for the entire operation.

When Megan registers Jefferson Hospital System with the secured logon application, she lists all 13 Tax IDs as Access Identifiers on the registration.

Behind the scenes in the secured logon application, the following information is in the BFITA table:

| Business Function | Access Identifier Type |
|---|---|
| Segment Your Organization | Tax ID |
| Claims Processing | Tax ID |
| Referral Processing | Tax ID |

The following information is in the Business Function table:

| Business Function | Segmentable |
|---|---|
| Segment Your Organization | Yes |
| Claims Processing | Yes |
| Referral Processing | Yes |

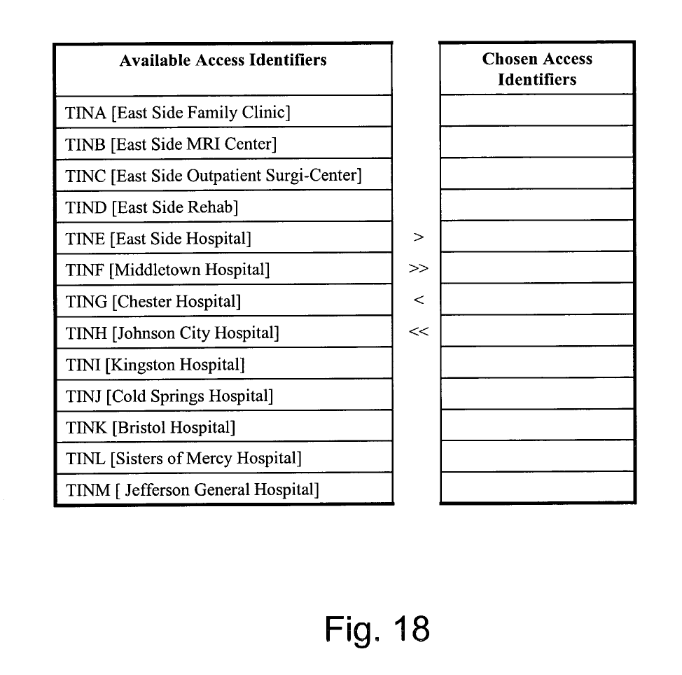

When Megan first gets on, she sets up segments. Since she has access to all data and since Segment Your Organization uses data with Access ID Type of Tax ID, her choice for creating segments is shown in FIG. 18.

Megan sets up the following segments:

| Segment Name | Contents |
|---|---|
| East Side | TINA, TINB, TINC, TIND, TINE |
| Mid Town | TINL, TINM |
| Suburbs | TINF, TING, TINH, TINI, TINJ, TINK |
| All | TINA, TINB, TINC, TIND, TINE, TINF, |
| | TING, TINH, TINI, TINJ, TINK, TINL, |
| | TINM |

She registers Charles, Peter, and Linda and assigns them rights as follows:

| Person | Business Function | Data It Uses for Operating |
|---|---|---|
| Charles | Segment Your Organization | East Side segment |
| Charles | Claims Processing | East Side segment |
| Charles | Referral Processing | All segment |
| Peter | Segment Your Organization | Suburbs segment |
| Peter | Claims Processing | Suburbs segment |
| Linda | Segment Your Organization | Mid Town segment |
| Linda | Claims Processing | Mid Town segment |

When she assigns them rights, she will first see a screen that displays the business functions that she may grant out. This screen would show Segment Your Organization, Claims Processing, and Referral Processing. After she has chosen the business functions, she will see all the data that can be assigned with each of the chosen functions.

The screen she would see for Charles when she assigns data for his business functions would contain the following display of choices:

+Segment Your Organization

TINA [East Side Family Clinic]

TINB [East Side MRI Center]

TINC [East Side Outpatient Surgi-Center]

TIND [East Side Rehab]

TINE [East Side Hospital]

TINF [Middletown Hospital]

TING [Chester Hospital]

TINH [Johnson City Hospital]

TINI [Kingston Hospital]

TINJ [Cold Springs Hospital]

TINK [Bristol Hospital]

TINL [Sisters of Mercy Hospital]

TINM [Jefferson General Hospital]

East Side

Midtown

Suburbs

All

+Claims Processing

TINA [East Side Family Clinic]

TINB [East Side MRI Center]

TINC [East Side Outpatient Surgi-Center]

TIND [East Side Rehab]

TINE [East Side Hospital]

TINF [Middletown Hospital]

TING [Chester Hospital]

TINH [Johnson City Hospital]

TINI [Kingston Hospital]

TINJ [Cold Springs Hospital]

TINK [Bristol Hospital]

TINL [Sisters of Mercy Hospital]

TINM [Jefferson General Hospital]

East Side

Midtown

Suburbs

All

+Referral Processing

TINA [East Side Family Clinic]

TINB [East Side MRI Center]

TINC [East Side Outpatient Surgi-Center]

TIND [East Side Rehab]

TINE [East Side Hospital]

TINF [Middletown Hospital]

TING [Chester Hospital]

TINH [Johnson City Hospital]

TINI [Kingston Hospital]

TINJ [Cold Springs Hospital]

TINK [Bristol Hospital]

TINL [Sisters of Mercy Hospital]

TINM [Jefferson General Hospital]

East Side

Midtown

Suburbs

All

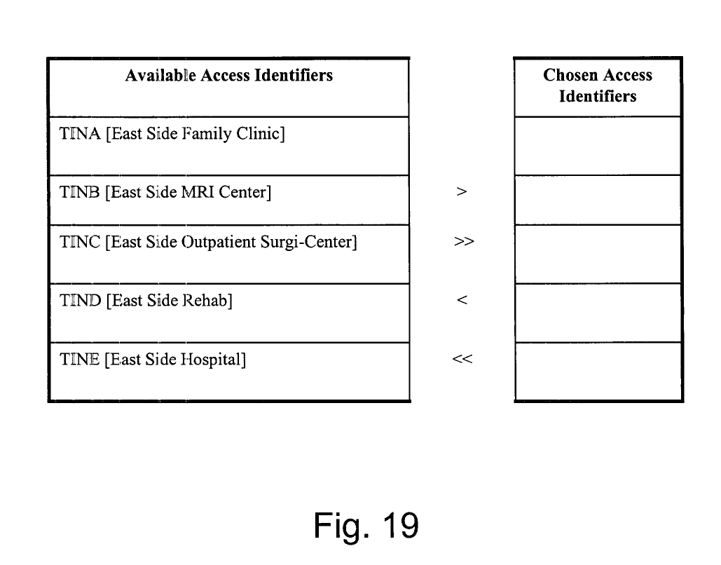

Once Charles has his functions, he goes about setting up segments that suit him. Since he has been assigned the East Side segment for the Segment Your Organization function, his choice for creating segments will be as shown in FIG. 19.

Charles sets up the following segments:

| Segment Name | Contents |
|---|---|
| Specialty Facilities | TINB, TIND |
| Hospital Care | TINC, TINE |

He does not set up a separate segment for the East Side Family Clinic.

Charles registers Cathy, Charlotte, and Connor and sets them up for Claims Processing for their respective operations. He sets up Chris and sets him up for Referral Processing for the entire organization.

When he assigns data for the claims processing for Cathy, Charlotte, and Connor, he will have the following options for assigning data and assigns it as follows:

| Business Function and Data for Assignment | Cathy | Charlotte | Connor |
|---|---|---|---|
| +Claims Processing | | | |
| TINA [East Side Family Clinic] | X | | |
| TINB [East Side MRI Center] | | | |
| TINC [East Side Outpatient Surgi-Center] | | | |
| TIND [East Side Rehab] | | | |
| TINE [East Side Hospital] | | | |
| Specialty Facilities | | X | |
| Hospital Care | | | X |
| East Side | | | |

When he assigns data for the Referral Processing for Chris, he will have the following options for assigning data and can assign it in a number of different ways as he sees fit:

| Business Function and Data for | | | |
|---|---|---|---|
| Assignment | Option 1 | Option 2 | Option 3 |
| +Referral Processing | | | |
| TINA [East Side Family | X | | |
| Clinic] | | | |
| TINB [East Side MRI Center] | X | | |
| TINC [East Side Outpatient | X | | |
| Surgi-Center] | | | |
| TIND [East Side Rehab] | X | | |
| TINE [East Side Hospital] | X | | |
| TINF [Middletown Hospital] | X | | |
| TING [Chester Hospital] | X | | |
| TINH [Johnson City Hospital] | X | | |
| TINI [Kingston Hospital] | X | | |
| TINJ [Cold Springs Hospital] | X | | |
| TINK [Bristol Hospital] | X | | |
| TINL [Sisters of Mercy | X | | |
| Hospital] | | | |
| TINM [Jefferson General | X | | |
| Hospital] | | | |
| East Side | | X | |
| Midtown | | X | |
| Suburbs | | X | |
| All | | | X |
| Specialty Facilities | | | |
| Hospital Care | | | |

It is noted that the data choices Charles sees for assigning for Claims Processing and Referral Processing are different from one another. The differences are based on the rights originally assigned to Charles. For Claims Processing, he was assigned the East Side segment. Thus, when he assigns data for Claims Processing, he sees the Access Identifiers associated with the East Side segment and he sees the other segments which are proper subsets of the East Side segment.

For Referral Processing, he was assigned the All segment. So when he assigns data for Referral Processing, he sees the Access Identifiers associated with the All segment and he sees the other segments which are proper subsets of the All segment.

### EXAMPLE TWO

Payor Front End (PFE) is a sponsor organization that captures transactions from providers and sends them for processing to payor organizations that have signed up with them. PFE has three payors, ABC, DEF, and GHI.

At PFE, there are Payor specific functions for each kind of transaction. This means that for the Claims Inquiry transaction, there is an ABC Claims Inquiry and a DEF Claims Inquiry and a GHI Claims Inquiry. For the Referral Inquiry transaction, there is an ABC Referral Inquiry and a DEF Referral Inquiry and a GHI Referral Inquiry.

In general the ABC functions and GHI functions use a Tax ID (access identifier type=TI) as the identifier when processing the functions and the DEF functions use a proprietary identifier called a Site Definition id (access identifier type=SD) as the identifier when processing the functions.

The Segment Your Organization business function is associated with both Tax IDs and DEF Site Definition ids, since segments can be created from either or both kinds of identifiers.

As a consequence the BFITA entries for these functions would be:

BFITA Entries

| | |
|---|---|
| ABC Claims Inquiry | TI |
| ABC Referral Inquiry | TI |
| DEF Claims Inquiry | SD |
| DEF Referral Inquiry | SD |
| GHI Claims Inquiry | TI |
| GHI Referral Inquiry | TI |
| Segment Your Organization | TI |
| Segment Your Organization | SD |

For the large Provider Organizations, there are often multiple SDs defined, typically one for each of the locations for that Provider Organization. Sometimes there are also multiple Tax IDs.

We take the case of Big Florida Hospital. It has three locations—Miami East, Miami Central, and Tampa. Big Florida Hospital started in Tampa and acquired the Miami Regional Hospital system. Therefore, it has two Tax IDs—one for the original Tampa hospital and one for the Miami Regional Hospital. The identifiers for the three locations are:

Big Florida Hospital Identifiers

| | |
|---|---|
| Miami East | TI = 222333444, SD = H678 |
| Miami Central | TI = 222333444, SD = H789 |
| Tampa | TI = 666777666, SD = I345 |

When Big Florida Hospital is set up, it has only the Tax IDs in the application. The SD access ids will be added later. Therefore, when Security assigns access to the PAA (Megan), Megan will have the following EUA entries:

PAA (Megan) Initial EUA Entries

| | |
|---|---|
| Segment Your Organization | TI = 222333444 |
| Segment Your Organization | TI = 666777666 |
| ABC Claims Inquiry | TI = 222333444 |
| ABC Claims Inquiry | TI = 666777666 |
| ABC Referral Inquiry | TI = 222333444 |
| ABC Referral Inquiry | TI = 666777666 |
| GHI Claims Inquiry | TI = 222333444 |
| GHI Claims Inquiry | TI = 666777666 |
| GHI Referral Inquiry | TI = 222333444 |
| GHI Referral Inquiry | TI = 666777666 |

DEF uses the System Application Owner functions process to assign the Site Definition ids within a few days of the registration completion. They are not captured during the registration process, since they are not known by the Provider Organizations in order to add during the registration process. DEF also assigns the DEF functions to the Provider Organization after adding the Site Definition ids. In fact, if Security attempted to assign the DEF functions prior to the existence of the Site Definition ids, there is a check to prevent this and to raise a warning that an ID of the appropriate type is missing.

Once DEF completes the assignment of the Site Definition ids and DEF business functions, there will be additional EUA entries as follows:

PAA (Megan) Additional EUA Entries

| | |
|---|---|
| DEF Claims Inquiry | SD = H678 |
| DEF Claims Inquiry | SD = H789 |
| DEF Claims Inquiry | SD = I345 |
| DEF Referral Inquiry | SD = H678 |
| DEF Referral Inquiry | SD = H789 |
| DEF Referral Inquiry | SD = I345 |

Some additional Segment Your Organization EUA entries also come into existence when the Site Definition ids are added. This is due to the fact that when an access identifier is added to an entity, there will be an automatic assignment to the PAA of that access identifier along with any currently assigned business function that can use an access identifier of its type.

PAA (Megan) Additional EUA Entries

Segment Your Organization SD=H678

Segment Your Organization SD=H789

Segment Your Organization SD=1345

Megan now goes in and creates segments as follows:

| Segment Name | Contents |
|---|---|
| Miami East | TI = 222333444, SD = H678 |
| Miami Central | TI = 222333444, SD = H789 |
| Miami | TI = 222333444, SD = H687, SD = H789 |
| Tampa | TI = 666777666, SD = I345 |
| Entire | TI = 222333444, TI = 666777666, SD = H678, |
| Organization | SD = H789, SD = I345 |

It is noted that Megan could have created the segments right away before DEF added the Site Definition ids and business functions. If she did that, the segments would include only the Tax IDs, since the Site Definition ids would not be available. Then when the Site Definition ids became available, she could have added them to the appropriate segments. If she sets up things early, she will be unable to assign all business functions, since she will not have access to them or to the Site Definition ids.

Megan has AAs established for each of the locations—Charles for Miami East, Susan for Miami Central, and George for Tampa.

When assigning business functions, Megan has the following information displayed, with the choices she makes for Charles, Susan, and George being indicated by an “X.”.

| Business Functions and Data | Charles | Susan | George |
|---|---|---|---|
| Account Administration | | | |
| Segment Your Organization | | | |
| Entire Organization | | | |
| Miami East | X | | |
| Miami Central | | X | |
| Miami | | | |
| Tampa | | | X |
| SD = H678 | | | |
| SD = H789 | | | |
| SD = I345 | | | |
| TI = 222333444 | | | |
| TI = 666777666 | | | |
| Claims Inquiry | | | |
| ABC Claims Inquiry | | | |
| Entire Organization | | | |
| Miami East | X | | |
| Miami Central | | X | |
| Miami | | | |
| Tampa | | | X |
| TI = 222333444 | | | |
| TI = 666777666 | | | |
| DEF Claims Inquiry | | | |
| Entire Organization | | | |
| Miami East | X | | |

| | | | |
|---|---|---|---|
| Miami Central | | X | |
| Miami | | | |
| Tampa | | | X |
| SD = H678 | | | |
| SD = H789 | | | |
| SD = I345 | | | |
| GHI Claims Inquiry | | | |
| Entire Organization | | | |
| Miami East | X | | |
| Miami Central | | X | |
| Miami | | | |
| Tampa | | | X |
| TI = 222333444 | | | |
| TI = 666777666 | | | |
| Referral Inquiry | | | |
| ABC Referral Inquiry | | | |
| Entire Organization | | | |
| Miami East | | | |
| Miami Central | | | |
| Miami | X | | |
| Tampa | | | X |
| TI = 222333444 | | | |
| TI = 666777666 | | | |
| DEF Referral Inquiry | | | |
| Entire Organization | | | |
| Miami East | | | |
| Miami Central | | | |
| Miami | X | | |
| Tampa | | | X |
| SD = H678 | | | |
| SD = H789 | | | |
| SD = I345 | | | |
| GHI Referral Inquiry | | | |
| Entire Organization | | | |
| Miami East | | | |
| Miami Central | | | |
| Miami | X | | |
| Tampa | | | X |
| TI = 222333444 | | | |
| TI = 666777666 | | | |

It is noted that based on the above assignments, Charles handles all referrals for Miami and Susan handles none.

Charles has several staff members. When he assigns access to them, he sees the following list displayed:

Business Functions and Data

Account Administration
Segment Your Organization
Miami East
SD = H678
TI = 222333444
Claims Inquiry
ABC Claims Inquiry
Miami East
TI = 222333444
DEF Claims Inquiry
Miami East
SD = H678
GHI Claims Inquiry
Miami East
TI = 222333444
Referral Inquiry
ABC Referral Inquiry
Miami East
Miami Central
Miami
TI = 222333444
DEF Referral Inquiry
Miami East
Miami Central
Miami
SD = H678
SD = H789
GHI Referral Inquiry
Miami East
Miami Central
Miami
TI = 222333444

There are multiple ways in which Charles could have been assigned Referral Processing for Miami. Three options are as follows:

| Option | Assignment |
|---|---|
| 1 | ABC Referral Inquiry - Miami |
| | DEF Referral Inquiry - Miami |
| | GHI Referral Inquiry - Miami |
| 2 | ABC Referral Inquiry - TI = 222333444 |
| | DEF Referral Inquiry - SD = H678 |
| | DEF Referral Inquiry - SD = H789 |
| | GHI Referral Inquiry - TI = 222333444 |
| 3 | ABC Referral Inquiry - Miami East |
| | ABC Referral Inquiry - Miami Central |
| | DEF Referral Inquiry - Miami East |
| | DEF Referral Inquiry - Miami Central |
| | GHI Referral Inquiry - Miami East |
| | GHI Referral Inquiry - Miami Central |

Option 1 is the way in which he was assigned Referral Processing.

Given the rules associated with which Access Identifiers and segments are available to Charles for assignment, it would not matter how the assignment to him was done. All options result in the choices for his assignment of data for Referral Processing as indicated above.

There are four rules relating to Derivative access identifiers, which are as follows:

1. The secured logon application finds out about derivative access identifiers through processes that peruse back-end systems. The process uses a “parent” access identifier to retrieve and present the back-end systems' identifiers that relate to the “parent” access identifier to an administrator (PAA or AA). The administrator then chooses the desired derivative access identifier(s). A typical flow for this process is represented in FIG. 14. The Port-of-Origin (PO) developers are expected to implement the routines to retrieve the back-end access identifiers, present them to the Administrator via the User Interface, and then send the selected list of derivative access identifiers to the secured logon application via the secured logon application supplied API routines. Furthermore, the secured logon application will allow registered applications (programs) to add derivative access identifiers via the secured logon transaction acceptor.

2. The Manage Segments function contains a link(s) to the process(es) that enable the user to pick Derivative Identifiers. Only a person with access to this business function and data can use the PO's functions to find derivative access identifiers to add to the secured logon application.

3. The added access identifiers cannot be used individually and must be placed into Segments.

4. Since Derivative access identifiers can only be used in segments, a consequence of indicating that a business function is not segmentable is that Derivative identifiers are not allowed for it.

There is one rule relating to access identifiers that are no longer active, which is as follows:

The secured logon application does not have a synchronization method in place to ensure that any access identifier (primary or derivative) is still active in a back-end system. It is the responsibility of every business function to ensure that it uses access identifiers appropriately according to business rules, i.e., an otherwise inactive access identifier may still be needed for reporting purposes, but should not be used for new work. Example: a broker is no longer working for an agency, but that broker access identifier is still needed to issue the commission reports for the current fiscal year. A business function must be able to bypass gracefully an invalid or inactive access identifier or tell the user what to do in other circumstances. The business function must deal with the access ID in an appropriate manner. It can, for example, reject the access identifier, or use it for reporting, but not for new work.

There are three rules relating to deleting access identifiers and segments, which are as follows:

1. Whenever an access identifier is deleted, references to it and its children must be deleted:

a. The entire sub-tree below that access identifier in the Access_Identifier table must be deleted, i.e., all its children must be deleted.

b. Furthermore, all rows in the EUA table referencing the deleted access identifier and its children must be deleted.

c. All references to the deleted access identifier and its children in segments must be deleted by removing the association between them in the Access_Group_ID_Assoc table.

d. All references to the deleted access identifier and its children in the Delegation table must be marked inactive and all EUA_Delegation_Assoc rows associated with those Delegation rows should be marked inactive.

2. No deletion of EUA rows or EUA_Delegation_Assoc rows is done for rows pointing to a segment that becomes empty when an access identifier is deleted.

3. Whenever a segment is deleted, references to it must be deleted:

a. All rows in the EUA table referencing the deleted segment must be deleted.

b. All references to the deleted segment in the Delegation table must be marked inactive and all EUA_Delegation_Assoc rows associated with those Delegation rows should be marked inactive.

There are two rules relating to adding access identifiers:

1. When an access identifier is added to an entity, there will be an automatic assignment to the PAA of that access identifier along with any currently assigned business function that can use an access identifier of its type.

2. No such automatic assignment should be done for any business functions that are not currently assigned to the PAA.

There are two rules relating to logging and audit trails, which are as follows:

1. Log records are kept of all adds, changes, and deletions of access identifiers and segments.

2. The secured logon application has an audit trail of how any individual or entity received his or her or its authority to perform a function on another's behalf.

There are twenty-three rules relating to delegation, which are as follows:

1. Whenever an entity wants another entity to do some or all of the work for it, the PAA will follow the “Delegate Access” workflow. The PAA can delegate any part or all of the “delegatable” business functions and information access to the other entity.

2. Delegation is not an alternate way to “Assign Access” to other people within a particular person's entity. Assignment is the process of giving other people in a person's entity the ability to do the work, whereas delegation is granting access to another entity.

3. The secured logon application will pre-determine which entity types can be delegated to by another entity type, e.g. a provider can delegate to a third party administrator, but not to a member entity.

4. A PAA becomes a virtual entity-user of the BehalfOF entity when the BehalfOf entity delegates work to the entity for which the PAA works (Admin entity). A PAA, and later an AA of the Admin entity if given the permissions, creates other virtual entity-users when the PAA/AA assigns delegated work to the users. The IT security personnel of the sponsoring organization also can create virtual entity-users when they assign delegated work to the users. Each of these virtual entity-users will have a row in the entity-user table.

5. When a person is given access via delegation to another entity, in the context of that other entity he or she is only an OA and cannot be an AA or PAA for that entity.

6. If in the context of his or her own entity he or she is the PAA or an AA, he or she can assign people “employed” by his or her entity access to the other entity.

7. Referring to FIG. 17, a delegation chain is tracked by a 3-tuple of data: The chain identifier, level, and parent. The chain groups the delegations for a particular entity/business function/data set. For example, when XYZ delegates “File Claims” to DEF, a chain ID of “C1357” is assigned. When DEF furthers the delegation by delegating to ABC, the delegation has the same chain ID of “C1357”. The first delegation from XYZ to DEF is level 1, and the second delegation from DEF to ABC is level 2. The parent value points to the row that gave the delegation. The delegation from XYZ to DEF has no parent, so is NULL. The delegation from DEF to ABC has a parent of XYZ to DEF's row. It is possible for DEF also to delegate the same work to MNO. This delegation by DEF to MNO will have the same chain ID, the same level, and the same parent value as the delegation by DEF to ABC.

DELEGATION Table snippet (not all columns shown): See FIG. 17

| Delegation | | | | | | | | | |
|---|---|---|---|---|---|---|---|---|---|
| _Gen | BehalfOf | Admin | GrantedBy | | | | | | |
| _Key | Entity | Entity | Entity | Data | Bus_Func | Chain | Level | Parent | Explanation |
| DGK001 | XYZ | DEF | XYZ | DI200 | File | C1357 | 1 | <NULL> | XYZ |
| | | | | | Claims | | | | delegates to |
| | | | | | | | | | DEF |
| DGK002 | XYZ | ABC | DEF | DI200 | File | C1357 | 2 | DGK001 | DEF |
| | | | | | Claims | | | | delegates to |
| | | | | | | | | | ABC for |
| | | | | | | | | | XYZ |
| DCK003 | XYZ | MNO | DEF | DI200 | File | C1357 | 2 | DGK001 | DEF |
| | | | | | Claims | | | | delegates to |
| | | | | | | | | | MNO for |
| | | | | | | | | | XYZ |
| DGK004 | XYZ | PQR | MNO | DI200 | File | C1357 | 3 | DGK003 | MNO |
| | | | | | Claims | | | | delegates to |
| | | | | | | | | | PQR for |
| | | | | | | | | | XYZ |

8. Each “Delegation chain” is considered separately for each “business function: data access pair”. There can be many different “delegation chains.” In fact, there can be hundreds of different “delegation chains” between two entities because each “business function: data access pair” or “business function alone” is delegated separately.

9. For a first delegation there is a one-to-one correspondence between a delegated row in the EUA and the EUA_DELEGATION_ASSOC table.

10. When delegated work is assigned to staff members within an Admin entity, the Delegation definition used for the delegation to the PAA is used for the staff member as well. This means that when a PAA or AA in an Admin entity “assigns delegated access” to another staff member in the Admin entity, an EUA entry is created for the other staff member and the EUA_Delegation_Assoc table contains an entry associating the new EUA row with the original Delegation for the PAA.

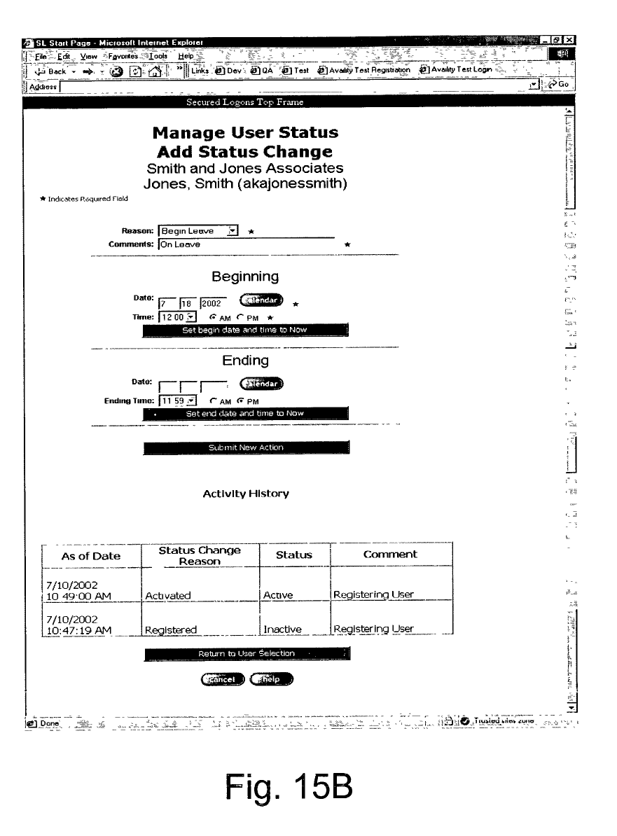

11. When there are multiple delegation chains from the same Behalf~f entity to an Admin entity via different routes, and the Admin entity wants to delegate, all of the chains will be extended to the next level. This means that there will be multiple entries in the EUA_Delegation_Assoc table for a given EUA entry created as a result of this delegation to the next level. Referring to FIG. 16, as an example, assume that entity A's work is being delegated: A=>B=>D and A=>C=>D. In this case, entity D can do work on A's behalf via two different paths. When D=>E on behalf of A, then both of A's delegation chains to D will be extended to entity E. This means that any EUA entry created for users at E to do work on behalf of A will have two entries in the EUA_Delegation_Assoc table, one representing the delegation path of A=>B=>D=>E and one representing the delegation path of A=>C=>D=>E.

12. In the case as above of multiple delegation chains being extended to the same Admin entity via two different paths, a delegation will continue even if one of the paths is revoked. In the example above, if A revokes the delegation to C, the path of A=>B=>D=>E remains and E may still do work on behalf of A. In this case, the Delegation representing A=>C=>D=>E would be deactivated and the EUA_Delegation_Assoc row referencing that Delegation would be deactivated as well.

13. The secured logon application does not permit having a “loop” in the delegation chain. That is, a PAA or AA cannot delegate back to any organization that has already been delegated to on the original entity's behalf on this same delegation chain. For example, if A delegates to B, who delegates A's work to C, then C cannot delegate A's work back to A or to B, and B cannot delegate A's work back to A.

14. The Delegation_Authorization table ensures that a delegation between two entities reaches the correct entity the first time. The receiving entity sets up a Delegation Acceptance Code entry in this table, and communicates this public information to the PAA who will perform the delegation. An entry in this table “opens the door” for other entities to delegate to this entity. The PAA of the receiving entity can choose to have one entry that he or she uses to receive all delegations, or he or she can create a separate row for each delegation. It is at the receiving PAA's discretion. Rows in this table are deactivated by the receiving PAA or by the sponsoring organization's IT security personnel.

15. The result of delegation is that the PAA of the Admin entity receives the business functions and data. An entity cannot delegate to anyone other than the PAA of the other entity because the secured logon application must have some control as to who receives the delegation. The PAA would then “Assign Delegated Access” of the delegated rights to others within his or her own organization resulting in people in the delegated to company who can do work on behalf of the original delegating entity. The delegation process requires the delegating entity's PAA or AA to know the delegation acceptance code value from the PAA of the “delegating-to” entity.

16. The PAA or AA can revoke only the direct delegation from his or her entity to the next entity in the chain.

17. When a delegation is terminated, either because of removal of rights to a specific business function: data pair, or because all rights are removed through Stop Delegating to Another Organization, then all corresponding delegations within the terminated entity and all subsequent (lower levels of authorization) are automatically terminated (revoked). This is referred to as a cascading delete. The determination of which items to revoke is made by traversing the delegation chain and deactivating corresponding Delegations from the Delegation table and associations from the EUA_Delegation_Assoc table. EUA rows are removed if there are no remaining entries for them in the EUA_Delegation_Assoc table.

18. If A has already delegated to B for a “business function: data pair”, and some time later A wants to delegate to B an additional access ID for the same business function, then there are two ways in the secured logon application to accomplish this: (1) If the delegation was originally done using a Segment, then A's administrator need only add the new access ID to the appropriate Segment; or (2) A runs the “Change Delegation” process to delegate the “business function: new access ID pair” to B. In both cases A's PAA should tell B's PAA that a new access ID has been delegated.

19. If a segment is delegated from one organization to another, the PAA and AAs at the receiving organization will not be able to see the individual items within the segment and cannot define segments of their own of the items within the original segment or of primary access IDs that were individually delegated.

20. In the assignment of access identifiers during the “Assign Delegated Work” workflow, a PAA or AA may assign segments or primary access ids that have been directly assigned to him or her.

21. Because a receiving PAA is not allowed to define/redefine segments that have been delegated to him, assignment of delegated functions and any further delegation will be done with what was originally delegated.

22. There is no explicit way for the PAA to control further delegation. A future objective of the secured logons application is to control access along four lines: no further delegation allowed, delegation allowed with permission, delegation allowed with notification, and delegation allowed with no restrictions. The control at the moment consists of not assigning the “perform delegation” functions to organizations that have the “receive delegation” functions.

23. Quick summary of delegation information and the tables in which it is stored:

a. Delegated Business Function and Access Identifier pairs are stored in the Delegation_Table with the definition of the delegation chain. The delegation chain provides the “reason” for the business function/access identifier pair existence. Three pieces of data define the delegation chain—the chain identifier, level, and parent. The Delegation_Table has information on an entity basis.

b. The virtual Entity User is stored in the Entity_User table; the BehalfOf_Entity_Gen_Key [symbol] Admin_Entity_Gen_Key; GrantedBy_Entity_Gen_Key is null (the granted by entity can be determined by looking at the Delegation_Table and reviewing the delegation chain information)

c. There is an Entity_User_Access (EUA) entry for each Business Function—Access Identifier pair assigned to the user on behalf of the BehalfOf entity.

d. EUA_Delegation_Assoc table associates the EUA entry with the reason(s) for its existence, i.e., the entry or entries in the Delegation_Table that documents the delegation chain(s) by which the user has received permission to do the work in the EUA entry.

e. When someone is “assigned delegated work”, an EUA record is created for him and the EUA_Delegation_Assoc table contains an entry associating the new EUA row and the same Delegation that documents the reason that the PAA received the same permissions.

f. When a further delegation is done from an existing chain, the 3-tuple of data for the new entry in the Delegation table is related to the 3-tuple of data defining the delegation that it came from as follows: contains the same chain id, has its level incremented by 1 from the delegation from which it is coming, and has its parent point to the delegation from which it is coming.

g. When a user has the same functionality delegated from multiple paths, the same EUA row is used and another row (reason) is added to the EUA_Delegation_Assoc table, associating that one EUA row with a different Delegation entry.

h. When a function is removed from a user who has received the functionality from multiple paths, deactivate the EUA_Delegation_Assoc row associated with the path that has been removed; remove the EUA row only if there are no other EUA_Delegation_Assoc rows for that EUA row.

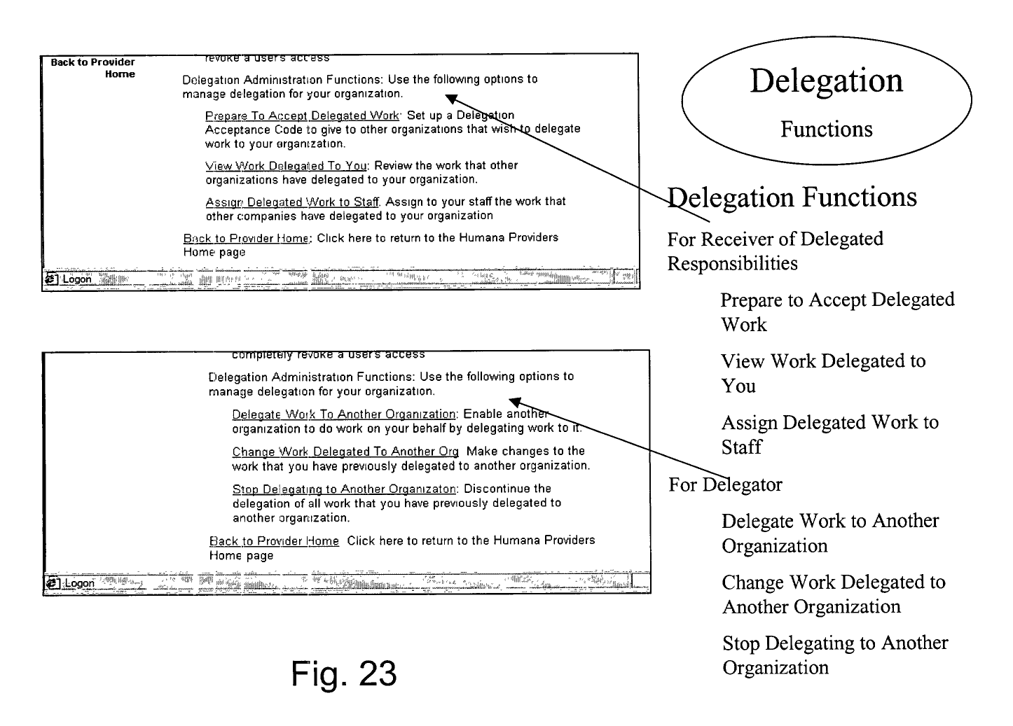

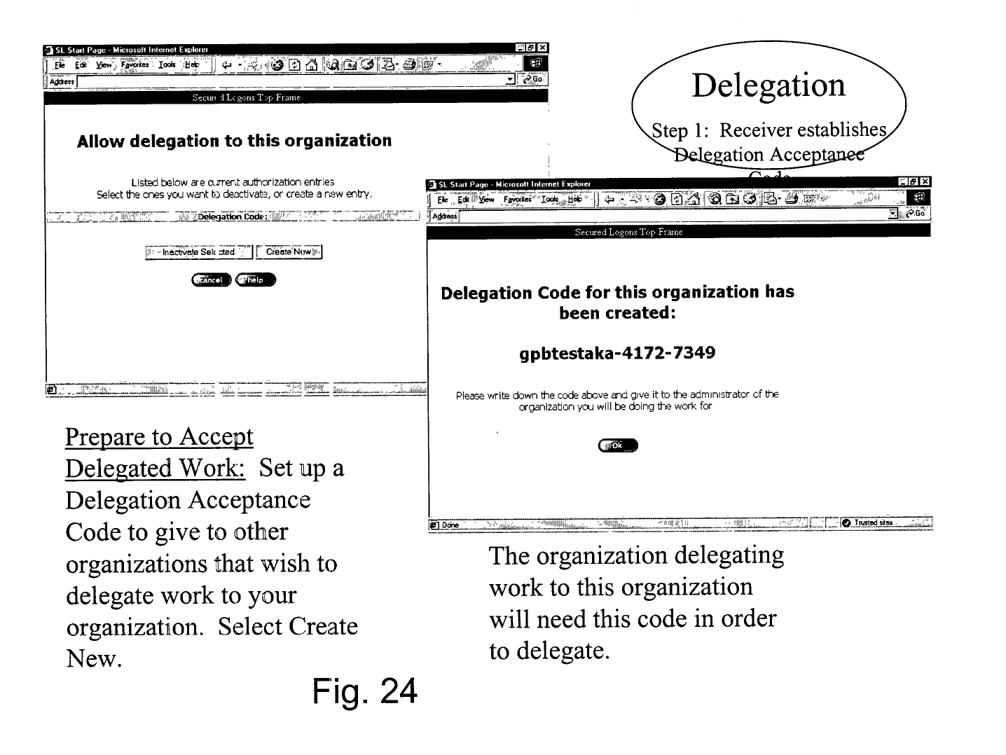

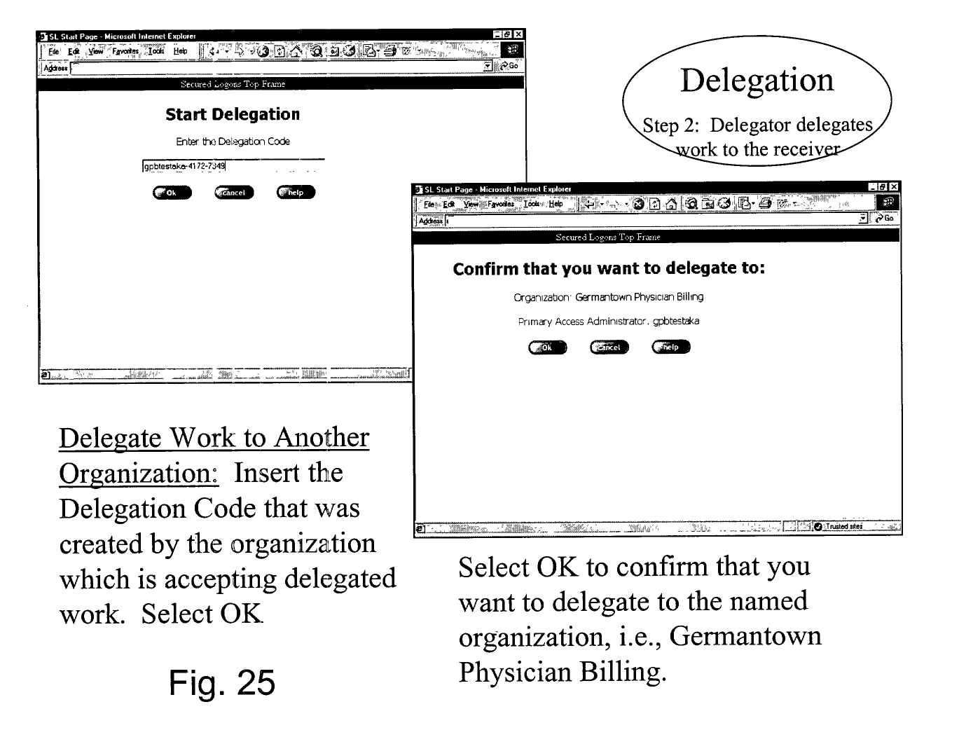

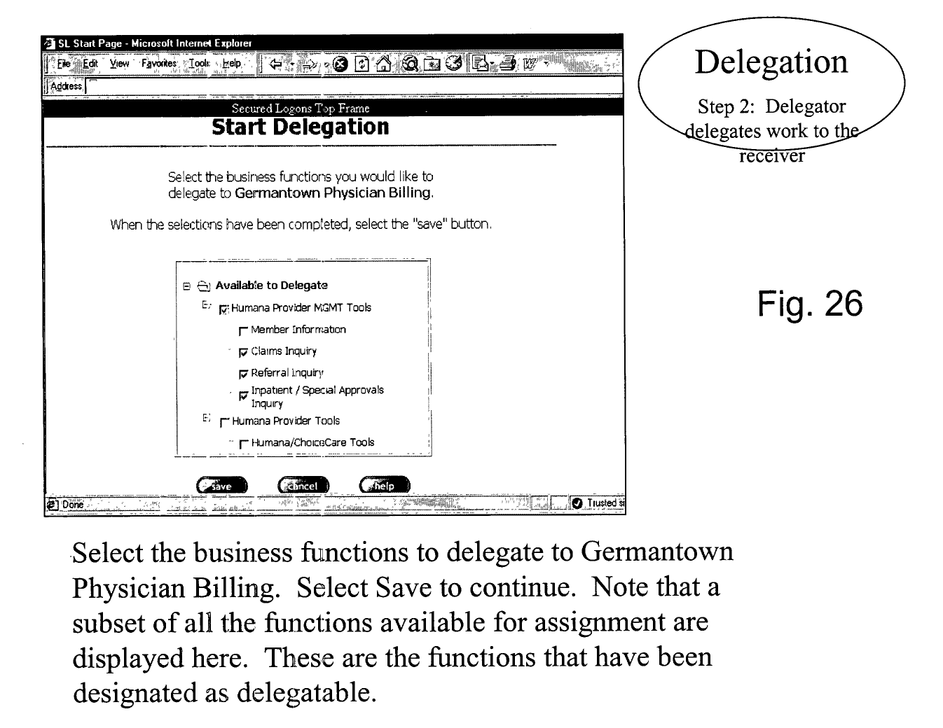

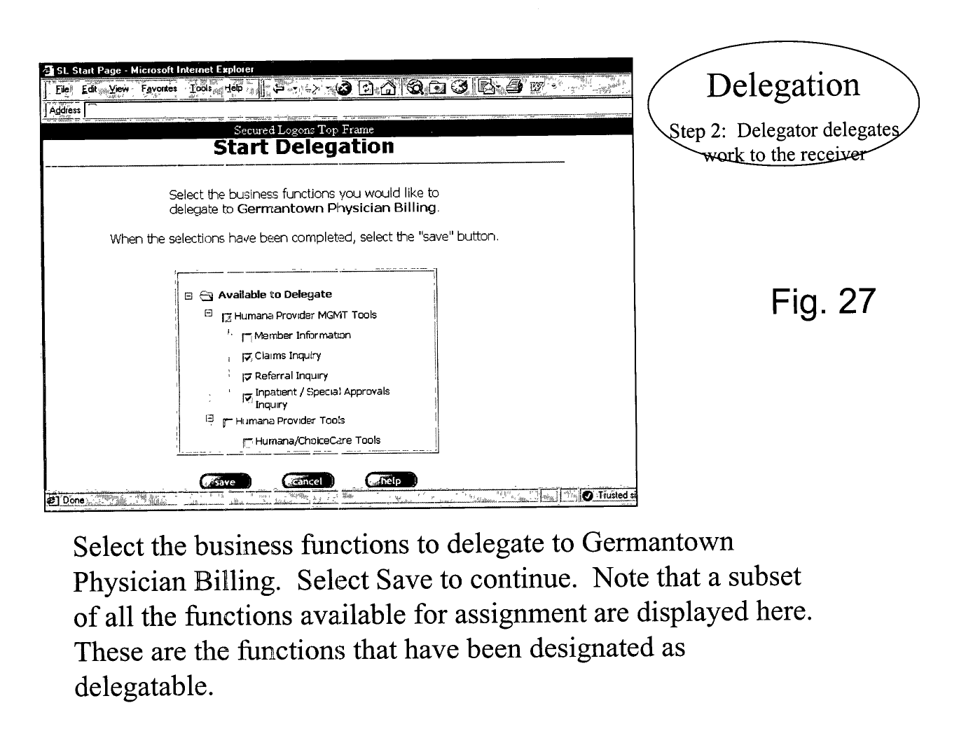

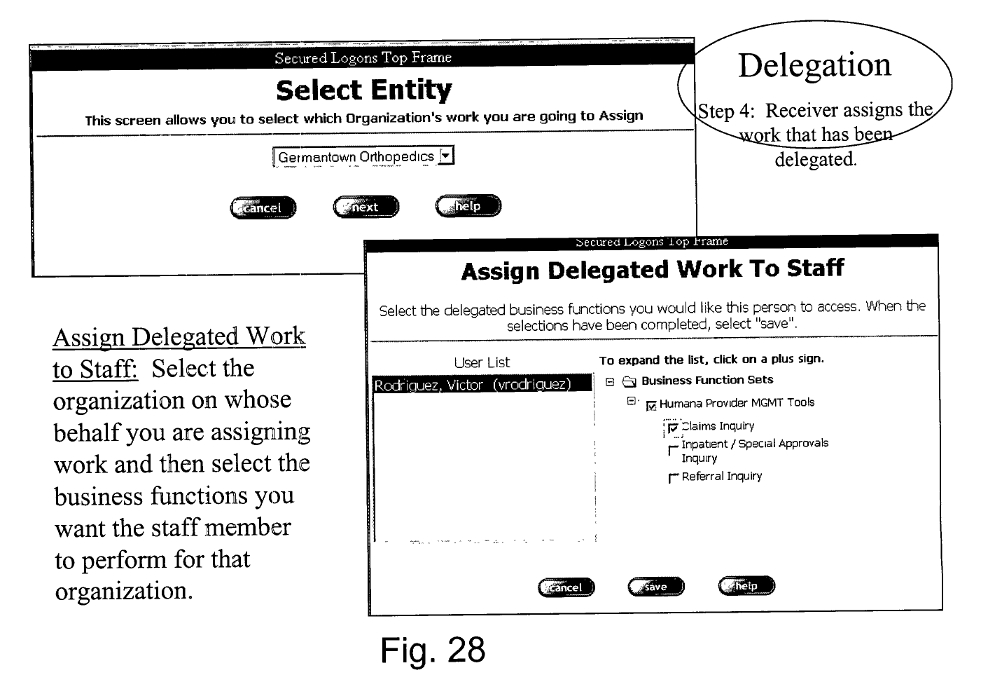

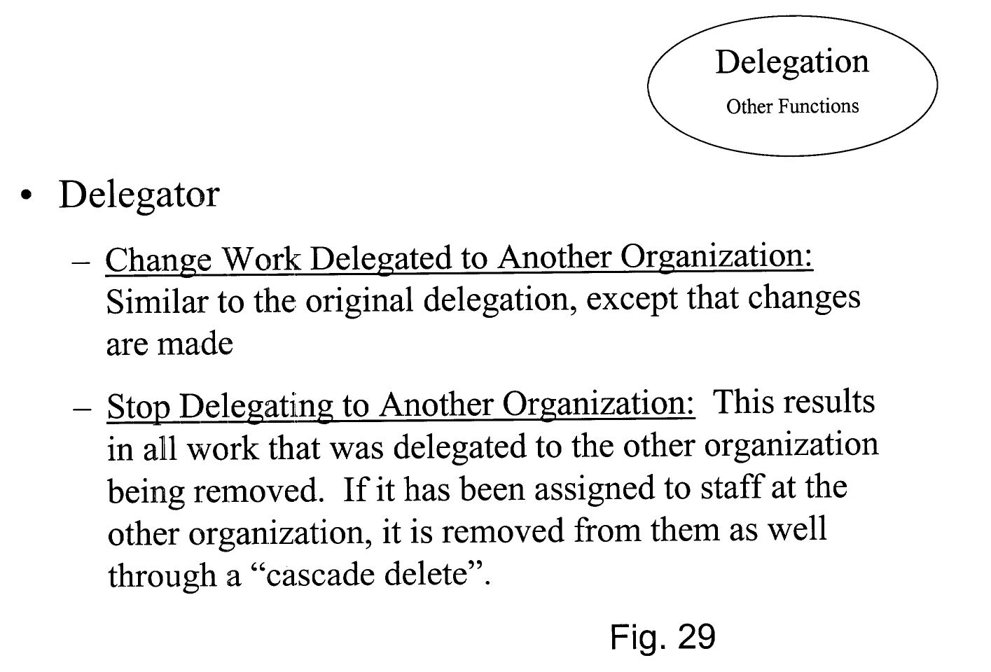

FIGS. 23-29 illustrate the functionality for managing delegation and the typical “Delegate Work” workflow and “Assign Delegated Work” workflow.

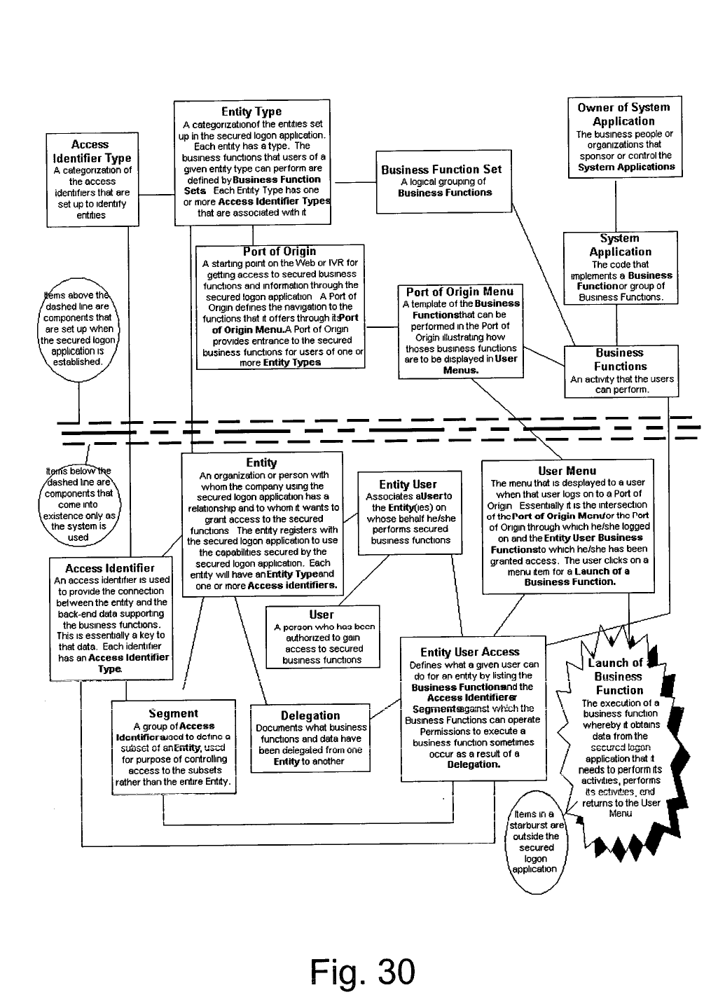

FIG. 30 illustrates the conceptual relationship between key components describes. The three examples below illustrate the basic concepts covered in FIG. 30.

### EXAMPLE ONE

### Illustration of the Concepts in FIG. 30

The following is an illustration of the basic concepts shown in FIG. 30, in which a health insurance company is the sponsor organization.

When the secured logon application is established, the following items are set up: two ports of origin, two access identifier types, three system applications, three Owners, five business function sets,

The two Ports of Origin that are set up are a Port of Origin for an Entity Type of Employer and a Port of Origin for an Entity Type of Provider.

The Access Identifier Types are Customer Group Number for use by an Employer Entity Type and Tax Identification Number for use by a Provider Entity Type.

Three System Applications are supported, each with one or two Business Functions. The Employer Support Application implements Online Billing and Member ID Card Replacement. The Provider Support Application implements Claims Inquiry and Eligibility Inquiry. The Account Administration Application implements Register a New User.

The Owner of the Employer Support Application is the Billing and Enrollment Division of the company. The Owner of the Provider Support Application is the Provider Relations Division of the company. The Owner of the Account Administration Application is the Internal Security Division of the company.

There are five Business Function Sets: the Employer Member Functions set, which includes Member ID Card Replacement; Employer Billing Functions set, which includes Online Billing; the Employer Account Administration set, which includes Register a New User; the Provider Functions set, which includes Claims Inquiry and Referral Inquiry; and the Provider Account Administration set, which includes Register a New User.

Different Business Function Sets are associated with each Entity Type. The Employer Entity Type uses the Business Function Sets of Employer Member Functions, Employer Billing Functions, and Employer Account Administration. The Provider Entity Type uses the Business Function Sets of Provider Functions and Provider Account Administration.

The Port of Origin Menu for the Employer Port of Origin lists the individual Business Functions: Member ID Card Replacement, Online Billing, and Employer Account Administration.

The Port of Origin Menu for the Provider Port of Origin lists the individual Provider Account Administration function first and then the Provider Functions set as a unit.

The items that come into existence as the secured logon application are dependent on what happens. In this example, two organizations register—Popkins Internal Medicine and Acme Broadcasting. Popkins Internal Medicine registers two users and Acme Broadcasting registers one user. As a consequence of these actions, the items that come into existence are two Entities, two Access Identifiers, three Users, and three Entity Users.

There are two Entities: Popkins Internal Medicine, which provides medical services to individuals insured by the sponsor organization and registers as a Provider Entity Type; and Acme Broadcasting, which carries insurance for its employees through the sponsor organization and registers as an Employer Entity Type.

The Access Identifier value for Popkins Internal Medicine is 123456789 with an Access Identifier Type of Tax Identification Number. The Access Identifier value for Acme Broadcasting is AB 12345 with an Access Identifier Type of Customer Group Number.

The three Users are Irene Popkins, who is registered as a User by Popkins Internal Medicine; Martin Carver, who is registered as a User by Popkins Internal Medicine; and Mary Smith, who is registered as a User for Acme Broadcasting.

Since no User is associated with more than one entity, there are also three Entity Users, Irene Popkins to Popkins Internal Medicine, Martin Carver to Popkins Internal Medicine, and Mary Smith to Acme Broadcasting.

The Entity User Business Functions are granted from the Business Functions within the Business Function Sets associated with the Entity Type. Irene Popkins at Popkins Internal Medicine can be granted functions from the Provider Functions and the Provider Account Administration sets and is actually granted Register a New User, Claims Inquiry, and Referral Inquiry. Martin Carver at Popkins Internal Medicine can be granted functions from the Provider Functions and the Provider Account Administration sets and is actually granted Claims Inquiry and Referral Inquiry.

Mary Smith at Acme Broadcasting can be granted functions from the Employer Member Functions, Employer Billing Functions, and Employer Account Administration sets and is actually granted Member ID Card Replacement, Online Billing, and Register a New User.

The User Menu for Irene Popkins in the Provider Port of Origin shows Register a New User and Provider Functions. The User Menu for Martin Carver in the Provider Port of Origin shows Provider Functions. The User Menu for Mary Smith in the Employer Port of Origins shows Member ID Card Replacement, Online Billing, and Register a New User.

### EXAMPLE TWO

### Person as an Entity

Entities can be people as well as organizations. Typically the sponsor organization has direct relationships with people as well as organizations. These people or organizations have different kinds of relationships with the sponsor organization. When these people or organizations are set up as entities, each entity is set up with an entity type that represents the relationship the entity has to the sponsor organization. This is done to enable different business functions to be established for the different entity types and to establish relationships easily between entities over time. Examples of these situations at a health insurance sponsor organization are:

Member of a health insurance plan: Typically, a person becomes a member of a health insurance plan by being employed by an employer who purchases the health insurance plan. At first glance, there might be an expectation that the member would be set up as a user associated with the employer. However, different business functions are available for members than for employers and a member may change employers over time. Having a separate member entity type facilitates each of these situations.

Physician Typically, a physician does business with a health insurance company by being associated with a provider organization. At first glance, there might be an expectation that the physician would be set up as a user associated with the provider organization. However, different business functions are available for physicians, some dealing with delivery of medical services, and a physician may change provider organizations over time. Having a separate physician entity type facilitates each of these situations.

The following is an example that builds on Example One above by showing a member as an entity.

When the secured logon application is established, the following items are set up: three Ports of Origin, three Access Identifier Types, four Systems Applications, four Owners, seven Business Function Sets

The three Ports of Origin that are set up are a Port of Origin for an Entity Type of Employer, a Port of Origin for an Entity Type of Provider, and a Port of Origin for an Entity Type of Member.

The Access Identifier Types are Customer Group Number for use by an Employer Entity Type, Tax Identification Number for use by a Provider Entity Type, and Member ID for use by a Member Entity Type

Four System Applications are supported, each with one or two Business Functions. The Employer Support Application implements Online Billing and Member ID Card Replacement. The Provider Support Application implements Claims Inquiry and Eligibility Inquiry. The Member Support Application implements Referral Inquiry and Change Primary Care Provider (PCP). The Account Administration Application implements Register a New User and Open My Account to Another User.

The Owner of the Employer Support Application is the Billing and Enrollment Division of the company. The Owner of the Provider Support Application is the Provider Relations Division of the company. The Owner of the Member Support Application is the Member Relations Division. The Owner of the Account Administration Application is the Internal Security Division of the company.

The seven Business Function Sets are the Employer Member Functions set, which includes Member ID Card Replacement; the Employer Billing Functions set, which includes Online Billing; the Employer Account Administration set, which includes Register a New User; the Provider Functions set, which includes Claims Inquiry and Referral Inquiry; the Provider Account Administration set, which includes Register a New User; the Member Function set, which includes Referral Inquiry and Change PCP; the Member Account Administration set, which includes Open My Account to Another User.

Different Business Function Sets are associated with each Entity Type. The Employer Entity Type uses the Business Function Sets of Employer Member Functions, Employer Billing Functions, and Employer Account Administration. The Provider Entity Type uses the Business Function Sets of Provider Functions and Provider Account Administration. The Member Entity Type uses the Business Function Sets of Member Functions and Member Account Administration.

The Port of Origin Menu for the Employer Port of Origin lists the individual Business Functions: Member ID Card Replacement, Online Billing, and Employer Account Administration.

The Port of Origin Menu for the Provider Port of Origin lists the individual Provider Account Administration function first and then the Provider Functions set as a unit.

The Port of Origin Menu for the Member Port of Origin lists the Member Functions set as a unit and then the Member Account Administration set as a unit.

The items that come into existence as the secured logon application is used are dependent on what happens. In this example, two organizations and one person register as entities—Popkins Internal Medicine, Acme Broadcasting, and Steven Towers. Popkins Internal Medicine registers two users; Acme Broadcasting registers one user; and Steven Towers is the only user in his entity. As a consequence of these actions the items that come into existence are three Entities, three Access Identifiers, four Users, and four Entity Users.

The three entities are Popkins Internal Medicine, which provides medical services to individuals insured by the sponsor organization and registers as a Provider Entity Type; Acme Broadcasting, which carries insurance for its employees through the sponsor organization and registers as an Employer Entity Type; and Steven Towers, who works for Acme Broadcasting and as a consequence is insured by the sponsor organization, and registers as a Member Entity Type.

Popkins Internal Medicine uses an Access Identifier of 123456789 with an Access Identifier Type of Tax Identification Number. Acme Broadcasting uses an Access Identifier of AB12345 with an Access Identifier Type of Customer Group Number. Steven Towers uses and Access Identifier of STAB12345 with an Access Identifier Type of Member ID.

The four Users are Irene Popkins, who is registered as a User by Popkins Internal Medicine, Martin Carver, who is registered as a User by Popkins Internal Medicine, Mary Smith, who is registered as a User for Acme Broadcasting, and Steven Towers, who is registered as a User for his own entity, i.e., the Steven Towers entity.

Since no User is associated with more than one entity, there are also four Entity Users, Irene Popkins to Popkins Internal Medicine, Martin Carver to Popkins Internal Medicine, Mary Smith to Acme Broadcasting, and Steven Towers to Steven Towers (entity).

The Entity User Business Functions are granted from the Business Functions within the Business Function Sets associated with the Entity Type. Irene Popkins at Popkins Internal Medicine can be granted functions from the Provider Functions and the Provider Account Administration sets and is actually granted Register a New User, Claims Inquiry, and Referral Inquiry.

Martin Carver at Popkins Internal Medicine can be granted functions from the Provider Functions and the Provider Account Administration sets and is actually granted Claims Inquiry and Referral Inquiry.

Mary Smith at Acme Broadcasting can be granted functions from the Employer Member Functions, Employer Billing Functions, and Employer Account Administration sets and is actually granted Member ID Card Replacement, Online Billing, and Register a New User.

Steven Towers at Steven Towers (entity) can be granted functions from the Member Function and Member Account Administration sets and is actually granted Referral Inquiry, Change PCP, and Open My Account to Another User.

The User Menu for Irene Popkins in the Provider Port of Origin shows Register a New User and Provider Functions. The User Menu for Martin Carver in the Provider Port of Origin shows Provider Functions. The User Menu for Mary Smith in the Employer Port of Origin shows Member ID Card Replacement, Online Billing, and Register a New User. The User Menu for Steven Towers in the Member Port of Origin shows Member Functions and Member Account Administration.

### EXAMPLE THREE

### User Associated with More than One Entity

A user can be associated with more than one entity. As an example, a user can be a member and associated with himself or herself and can be an administrator within an employer organization. The following illustrates this concept by building on examples one and two above. All new items are shown italicized.

The items set up when the secured logon application is established are the same as in Example Two; there is no change.

The items that come into existence as the secured logon application is used are dependent on what happens. In this example, two organizations and two people register as entities—Popkins Internal Medicine, Acme Broadcasting, Steven Towers, and Mary Smith. Popkins Internal Medicine registers two users; Acme Broadcasting registers one user; Steven Towers is the only user in his entity, and Mary Smith is the only user in her entity. As a consequence of these actions the items that come into existence are four Entities, four Access Identifiers, four Users, and five Entity Users.

The four entities are Popkins Internal Medicine, which provides medical services to individuals insured by the sponsor organization and registers as a Provider Entity Type; Acme Broadcasting, which carries insurance for its employees through the sponsor organization and registers as an Employer Entity Type; Steven Towers, who works for Acme Broadcasting and as a consequence is insured by the sponsor organization, and registers as a Member Entity Type; and Mary Smith, who is registered as an administrator for Acme Broadcasting in the above examples and works for Acme Broadcasting and as a consequence is insured by the sponsor organization and registers as a Member Entity Type

Popkins Internal Medicine uses an Access Identifier of 123456789 with an Access Identifier Type of Tax Identification Number. Acme Broadcasting uses an Access Identifier of AB12345 with an Access Identifier Type of Customer Group Number. Steven Towers uses an Access Identifier of STAB12345 with an Access Identifier Type of Member ID. Mary Smith uses an Access Identifier of MSAB12345 with an Access Identifier Type of Member ID.

The four Users are Irene Popkins, who is registered as a User by Popkins Internal Medicine; Martin Carver, who is registered as a User by Popkins Internal Medicine; Mary Smith, who is registered as a User for Acme Broadcasting; and a User for her own entity, i.e., the Mary Smith entity; and Steven Towers is registered as a User for his own entity, i.e., the Steven Towers entity.

Since one User is registered with two entities, there are five Entity Users, Irene Popkins to Popkins Internal Medicine, Martin Carver to Popkins Internal Medicine, Mary Smith to Acme Broadcasting, Mary Smith to Mary Smith (entity), and Steven Towers to Steven Towers (entity).

The Entity User Business Functions are granted from the Business Functions within the Business Function Sets associated with the Entity Type. Irene Popkins at Popkins Internal Medicine can be granted functions from the Provider Functions and the Provider Account Administration sets and is actually granted Register a New User, Claims Inquiry, and Referral Inquiry.

Martin Carver at Popkins Internal Medicine can be granted functions from the Provider Functions and the Provider Account Administration sets and is actually granted Claims Inquiry and Referral Inquiry.

Mary Smith at Acme Broadcasting can be granted functions from the Employer Member Functions, Employer Billing Functions, and Employer Account Administration sets and is actually granted Member ID Card Replacement, Online Billing, and Register a New User. Mary Smith at Mary Smith (entity) can be granted functions from the Member Function and Member Account Administration sets and is actually granted Referral Inquiry, Change PCP, and Open My Account to Another User.

Steven Towers at Steven Towers (entity) can be granted functions from the Member Function and Member Account Administration sets and is actually granted Referral Inquiry, Change PCP, and Open My Account to Another User.

The User Menu for Irene Popkins in the Provider Port of Origin shows Register a New User and Provider Functions. The User Menu for Martin Carver in the Provider Port of Origin shows Provider Functions. The User Menu for Mary Smith in the Employer Port of Origin shows Member ID Card Replacement, Online Billing, and Register a New User. The User Menu for Mary Smith in the Member Port of Origin shows Member Functions and Member Account Administration. The User Menu for Steven Towers in the Member Port of Origin shows Member Functions and Member Account Administration.

E. User Status

1. Overview

Determination of user status for purposes of executing a business function is governed by the status of four different items: (1) Entity; (2) User; (3) Entity-user (real and virtual); and (4) Entity-user access (business functions and data combinations)

The combination of the statuses controls whether a given user can perform something for a given entity against certain data. To do this, the user has to be active, the entity has to be active, the user has to be actively associated with the entity (entity-user), and the business function and data combination has to be active for the user for the entity (entity-user access). Any one of these items can have a status other than “active,” which would cause the operation to fail.

The statuses are managed in various ways. The IT security personnel of the sponsor organization can manage the statuses of all four items. An external Access Administrator can manage the statuses of two of the items—entity-user and entity-user access. All can be non-active for a period of time and then become active again. One item—entity-user access—can be turned on and off easily at any time through the assignment of access rights processes discussed above. Because there are complexities involved with turning the other three—entity, user, and entity-user—on and off, there are explicit ways in which they can be made temporarily non-active without turning them off. Making the entity, user, and entity-user inactive includes being able to set up planned Suspense Periods in advance.

Also, in order for the secured logon application to provide Delegation, the logic for determining Processing Status (see the description of Status Types, below) for a virtual entity-user must include reviewing the status of multiple entities, namely the user's administering organization and the entity on whose behalf he is working.

Under all circumstances, dates define periods of time in which the various statuses are in effect.

Records must be kept of all actions that establish a planned future status change, change a status, or change a planned future status change.

2. Status Types

There are four ways to represent a status, depending on the circumstances and location:

Date Status:—This refers to the status of an item as determined by the status dates associated with it.

Display Status:—This is the status of an item that is displayed on screens and is always relative to the current date and time. For entity-users, this status applies to real entity-users only.

Processing Status:—This applies to entity users, both real and virtual. It refers to whether an entity user is allowed to perform any functions.

Selection Status:—This applies to real entity users only. It is used to determine which entity users to display for selection lists used by access administrators and/or Internal Security.

3. Entity User Access Status

A given Entity_User_Access row (combination of entity, user, function, and data) is active, as long as the user, the Admin entity, the BehalfOf entity (if different from the Admin entity), and the real entity user (real entity user whether the Entity User Access is for a real or virtual entity user) are all active; and as long as delegation does not extend beyond one level (i.e., as long as a “delegated to” organization does not in turn delegate the delegated work to another organization). A given Entity_User_Access row (combination of entity, user, function, and data) is active, as long as the user, the Admin entity, the BehalfOf entity (if different from the Admin entity), and the real entity user (real entity user whether the Entity User Access is for a real or virtual entity user) are all active; and as long as delegation does not extend beyond one level (i.e., as long as a “delegated to” organization does not in turn delegate the delegated work to another organization). When delegation can be extended beyond one level (i.e., when a “delegated to” organization can delegate the delegated work to another organization), a given Entity_User_Access row will be active as long as all entities in the delegation chain between the BehalfOF entity and the Admin entity are active in addition to all the criteria mentioned above.

4. Business Rules

a) Real Entity User Statuses

Statuses for the Real Entity User—Entity User Display Status, Processing Status, and Selection Status—are dependent not only on the Entity User Date Status, but also on the Entity Date Status and the User Date Status. This dependency is reflected in the Entity User Status Derivations matrix, which is set forth in Appendix A.

In general the rules affecting the status interactions are as follows:

1. For Entity User Display Status, the End Date and Time of a revoke (if it exists) takes precedence over all other things that may be happening to either the entity or the user. This is so that the explicit instructions from the Access Administrator or Internal Security, as reflected by the End Date and Time of a revoke will prevail in the event that any of the other events is backed out.

2. The Entity User Processing Status will be Active as long as the Entity Date Status is Active, the User Date Status is Active, and the Entity User Date Status is Active. Otherwise, it is Inactive.

3. The Entity User Selection Status for the Access Administrator (“AA”) will be Active as long the user has not been suspended or revoked, and the entity is still active. From a status perspective, the user shows up on the current selection lists for an entity when the Entity User Display Status is “Registered”, “Active”, or “Temporarily Inactive”. The user shows up on the Revoked selection list when the Entity User Display Status is “Revoked”.

b) Virtual Entity User Processing Status

As long as delegation does not extend beyond one level (i.e., as long as a “delegated to” organization does not in turn delegate the delegated work to another organization) the virtual Entity User Processing Status is dependent on the Date Status of the real Entity User that corresponds to this virtual Entity User, the User Date Status, the Date Status of the Admin Entity, and the Date Status of the Behalf(f Entity. If delegation is extended beyond one level (i.e., if a “delegated to” organization can delegate the delegated work to another organization), then the Date Status of all entities in the delegation chain between the BehalfOF entity and the Admin entity will need to be checked also. These dependencies are reflected in the Virtual Entity User Status Derivations matrix Virtual Entity User Status Derivations, which is set forth in Appendix B.

In general the rules affecting the status interactions are as follows:

1. If the processing status for the real entity-user corresponding to the virtual entity-user is Inactive, then the processing status for the virtual entity-user is Inactive. Essentially this means that if the company that employs this user has suspended or revoked the user, then any delegated access is also Inactive.

2. If any of the entities involved in the delegation is suspended or revoked, then the processing status is Inactive.

c) Actions and Activities Affecting Statuses

(1) Approve an Application

The IT security personnel of a sponsor organization can approve an application after going through a validation process. Also, the secured logon application can receive a pre-approved application from a trusted source. In both cases, this results in the entity being established, the user account for the PAA being established if it has not already been established, and the relationship between the entity and the PAA (Entity-User record created) being established. This results in registered and active status records being set up for the entity, the user if not already established, and the entity-user.

(2) Auto-Post Process

There is a process by which trusted sources can add an entity, PAA and the entity PAA relationship without going through the application process. As above, this results in registered and active status records being set up for the entity, the user if not already established, and the entity-user.

(3) Register a User

An access administrator for an entity or Internal Security can register a user for the entity. This is accomplished by the Register User function for the access administrator. For a sponsor organization's Internal Security personnel, this can be done in one of two places. First, on the Add New Relationship function on the Change/Update This Entity's Administrator Relationships page; and second, through the “Add an Administrator” function which appears in several places on the internal site.

In general, the rules affecting registration of a user are as follows:

1. When doing the registration, an Effective Date and Time must be provided. “Now” is an acceptable option, which should be interpreted by the software to an appropriate date and time. The Effective Date and Time must be “now” or in the future.

2. An End Date and Time is optional. If an End Date is provided, a revoke record will be created for that date. The End Date and Time must be greater than the Effective Date and Time.

3. It is possible to register a user in one entity and use an account that was established for the user in the context of a different entity. This is how a “single sign-on” is accomplished. That can be done by providing appropriate information at the time of registration. However, reusing an existing user account is not allowed if the user is suspended or revoked by Internal Security; or if the user has been previously registered with the entity and status is not revoked.

One result of registration of a user is that the user account comes into existence, and registered and active status records for the user are created, if the user has not already been established. It also results in registered and active status records being set up for the entity-user.

(4) Reinstate a User

Reinstate a User is equivalent to Register a User, where an existing user account is being used, where the user has been previously registered with the entity, and the status is Revoked. This results in reregistered and active status records being set up for the entity-user.

(5) Adjust Effective Date and Time

An Access Administrator for an entity or the sponsor organization's Internal Security can adjust any future Effective Dates and Times for a user for an entity. This is accomplished by selecting the Effective Date and Time for an entity user on the Action Selection page.

In general, the rules affecting the adjustment of Effective Date and Time are:

1. The Effective Date and Time must be “now” or in the future. If it is “now”, the software should interpret it to be an appropriate time.

2. The Effective Date and Time must be prior to the End Date and Time if an End Date exists.

3. The Effective Date and Time must be prior to all Suspense Dates and Times. If this situation is detected during edits, the user will be warned and will choose the remedy himself or herself. The two remedies are: Change the date(s) so that there is no issue; or cancel existing Suspense Period(s) until there is no issue. If canceling the existing Suspense Period(s) is chosen as the resolution, the record is marked as overridden so that if the effective date is ever changed again, the secured logon application can ask about these overridden records as well.

The result of an adjustment in the effective date and time is that the new effective date and time is recorded and an audit trail is created of the change.

(6) Suspend an Entity, User, or Entity-User

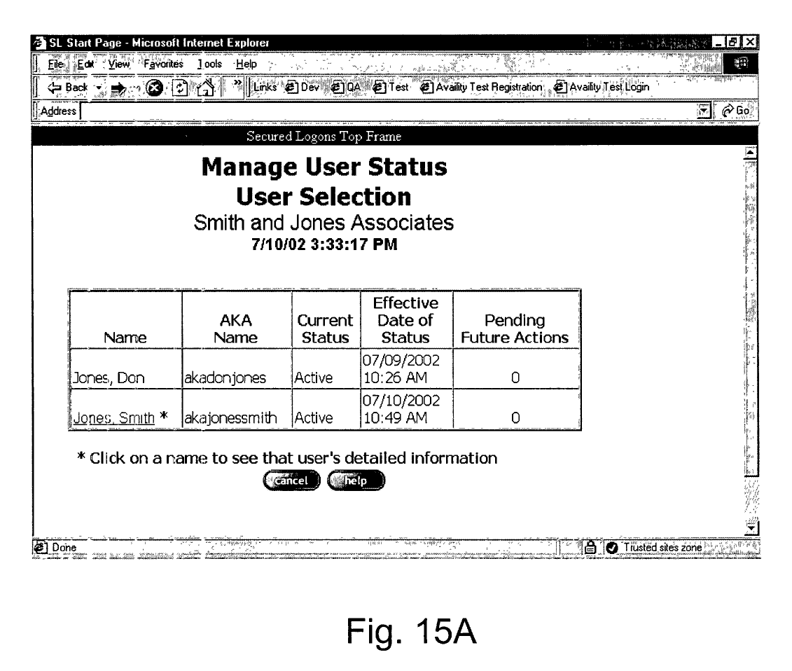

An access administrator for an entity or the IT security personnel of the sponsor organization can temporarily suspend a user for the entity. Only the IT security personnel can temporarily suspend an entity or a user. This is accomplished by defining a Suspense Period. Suspense Periods are managed from the Action Selection page. The result of setting up a Suspense Period is that records are created of the start date and the end date. The result of any changes to the dates associated with a Suspense Period is that records are made of the new dates and an audit trail is created of the changes to the old dates. FIGS. 15A and 15B illustrate the steps to temporarily suspend a user.

In general, the rules affecting the suspension of an entity, user, or entity-user are as follows:

1. A Suspense Period must begin after the entity, user or entity-user's Effective Date.

2. A Suspense Period must end before a revoke Date and Time if one exists

3. For each Suspense Period, the Suspense Date and Time must be provided. “Now” is an acceptable option, as long as the other edits are met. “Now” should be interpreted by the software to an appropriate time.

4. For each Suspense Period, a Reactivate Date and Time is optional, i.e., it can be open-ended as long as all the other edits are met. If it is given, it must be after the Suspense Date and Time. If no Reactivate Date and Time is entered, the default Reactivate Date and Time is used. This will be either a maximum date of 12/30/9999 or the revoke Date and Time, if one exits. When adjusting the dates for an active Suspense Period, “now” is an acceptable option for the Reactivate Date and Time if the other edits are met.

5. Multiple Suspense Periods can be specified. Only the last of these can be open ended.

6. There can be no overlap between Suspense Periods. When an overlap is detected during edits, the user will be warned and will choose the remedy himself or herself. The two remedies are: change the dates of the new Suspense Period so that there is no overlap; change the dates of existing Suspense Period(s); or cancel existing Suspense Period(s) until there is no overlap. If cancellation of the existing Suspense Period(s) is chosen as the resolution, the record is marked as overridden so that if the dates are ever changed again, the secured logon application can ask about these overridden records as well.

7. The Suspense Date and Time for an existing Suspense Period can be changed as long as:

a) The existing Suspense Date and Time is in the future,

b) The new Suspense Date and Time is in the future,

c) The new Suspense Date and Time is prior to the Reactivate Date and Time,

d) The new Suspense Date and Time is after the Effective Date and Time, and

e) No overlap with another Suspense Period is created.

8. The Reactivate Date and Time for an existing Suspense Period can be changed as long as:

a) the existing Reactivate Date and Time is in the future,

b) the new Reactivate Date and Time is in the future,

c) the new Reactivate Date and Time is after the Suspense Date and Time,

d) the new Reactivate Date and Time is less than or equal to the Revoke Date and Time if one exists, and

e) no overlap with another Suspense Period is created.

9. A Suspense Period will not cascade down to the entity-user access nor to virtual entity users associated with this entity user. As a result, status must be validated at the user, all entities, and real entity user levels to determine actual access privileges.

10. A Suspense Period can be canceled as long as both the Suspense Date and Time and Reactivate Date and Time are in the future.

11. while a user or entity is suspended by the IT security personnel of the sponsor organization, future suspense periods for the entity user can still be established. These will be allowed so that they can go into effect in case the user or entity suspense is lifted. The Access Administrator or IT security personnel can set up such periods while the user is suspended. Only IT security personnel will be able to set up such periods while the entity is Suspended, since an Access Administrator will not be able to do anything for the entity while it is Suspended.

12. The history of all actions surrounding the status will be shown to Access Administrators, Internal Security, and auditors.

(7) Revoke an Entity, User, or Entity-User

An access administrator for an entity or the IT security personnel of the sponsor organization can revoke a user for the entity. The IT security personnel can revoke an entity or a user. This is accomplished on the external site by clicking on the “revoke user” button on the Select Action screen or by choosing the “add an action” button and choosing Begin Revoke as the reason code and selecting a date and time for that action to begin. Regardless of which method you choose, you have the opportunity to enter the begin date of the revocation. The result of revoking is that a record is created of the revoke date. The result of any changes to a revoke date is that a record is made of the new date (if a new one is created) and an audit trail is created of the change to the old date.

In general, the rules affecting revocation of an entity, user, or entity-user are as follows:

1. The revoke date can be in the future or can be “now” as long as the other edits are met.

2. The revoke must be greater than any other action dates for them on file. If it is not greater than all other action dates, the user will be warned and will choose the remedy himself or herself. The remedies are: change the dates of Suspense Period(s) so that the edit is met; cancel existing Suspense Period(s) so that the edit is met (if cancellation of existing Suspense Period(s) is chosen as the resolution, the record is marked as overridden so that if the effective date is ever changed again, the secured logon application can ask about these overridden records as well); or change the action so that the edit is met.

3. There can be only one future revoke date.

(8) Entity User Access Status

The Assign Roles process and all its variations controls entity user access status for an entity user. Usually when a business function and its associated data are assigned to a user, the business function—data pair is set up with an immediate effective date and time. Usually, when a business function—data pair is removed from an entity user, it is tagged with an immediate End Date and time. If the assignment is done through a transaction acceptor transaction, there future effective and end dates can be established.

(9) Audit Records

Records must be kept of all actions that establish a planned future status change, change a status, or change a planned future status change.

F. Dynamic Menus in the Secured Logon Application

Dynamic menus are another way to control access. Based on information in the secured logon application, menus can be built which display to the user only those business functions to which he has access.

G. Session Management in the Secured Logon Application

The secured logon application performs session management for users logging on through it. This provides another way to control access. If a user does not perform any activity for a period of time, the session that his logon initiated expires.

H. User Accounts in the Secured Logon Application

The secured logon application requires that each user have a unique public name that can be used without revealing any security related information, enables a user to have a single sign-on for multiple contexts, and supports a requirement that each user agree to various conditions in order to gain access to the secured functionality and information. To gain access to a sponsor organization's secured functionality and information, each user must have a UserID, AKAName, and PIN/Password. The UserID and PIN/Password are used to log on with, and therefore are security related. The AKAName is a public user ID or alias for a user. AKA Names, like user ID's, are unique to a user. It is an alternate way to refer to the user without divulging any information that can be used to log on.

The secured logon application insures that the UserIDs and AKANames of its users are unique and at the same time supports logic to enable a user to use the same UserID and AKAName in multiple contexts. The conflict management process is utilized in the save application (both internal and external) and the save user (both internal and external) processes.

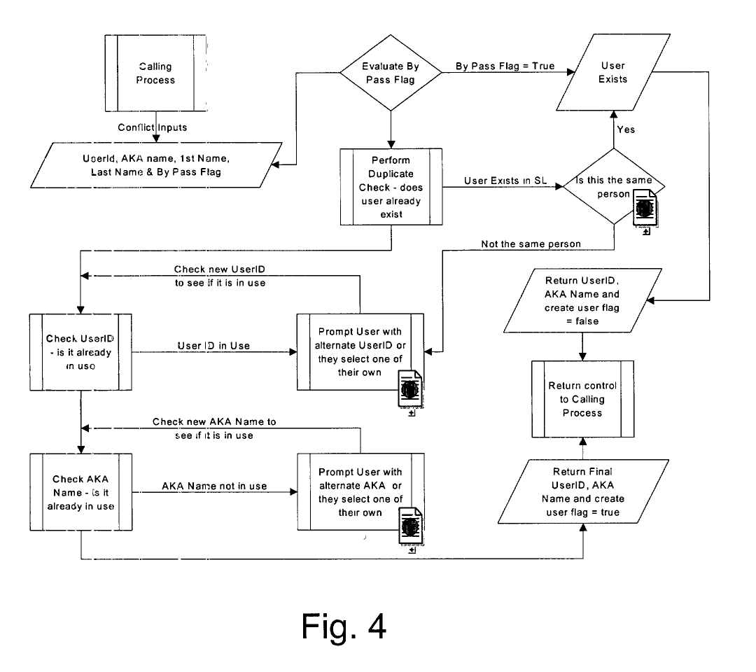

A flowchart illustrating the User ID and AKA name conflict management process is shown in FIG. 4.

There are two parts to the conflict management process, the duplicate checking logic and the User ID and AKA Name conflict management process. The duplicate checking logic checks to see if the User ID, AKA Name, first name, and last name of the user that is being added to the secured logon application already exists with an exact match on all four of these criteria. If a match is found then the user is presented with a screen that states that this may be a duplicate, as it appears this user already exists. The user has an option to agree and not create another user or to say, “no this is not the same user”. If he agrees, he is reusing his UserID and AKAName in a new context.

If the user says no, then the User ID and AKA Name conflict screens will force the user to select a new User ID and AKA Name that is not currently in use.

If no match is found for the User ID, AKA Name, first name, or last name of the user as described above, the User ID and AKA Name conflict management process is invoked next. This process checks the User ID against existing values and if taken, will suggest alternatives to the user or allow the user to select another of his or her own choosing. Once the user selects a new User ID, it is also checked to make sure it is not already in use. If the new User ID is already in use, the process is repeated until the user has selected a unique User ID. The process repeats for the AKA Name.

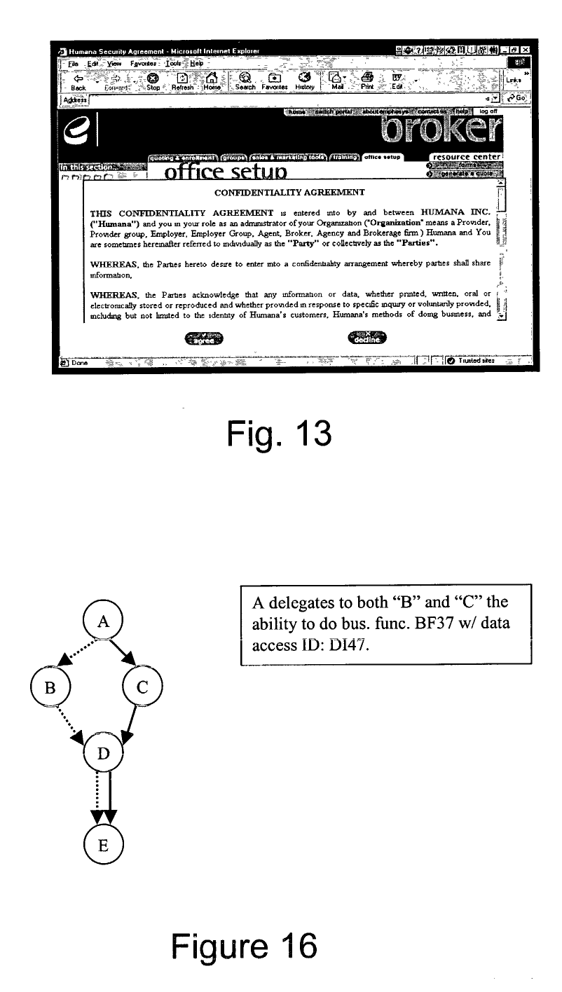

The first time that a user logs on, he or she can be required to review and accept conditions for gaining access to the secured functionality and information. Thereafter, if those conditions change or if new conditions are added, the user can be required to review and accept the new conditions the first time he or she logs on after the change. An example of an agreement that a person would agree to is the confidentiality agreement presented via a web page, such as shown in FIG. 13.

III. Support for Unknown Users

A. Registration Processes

There are multiple registration processes that are supported by the secured logon application. Entities that are people often have a direct relationship with the sponsor organization and therefore are known to the sponsor organization. For them, it is possible to have a streamlined process that takes advantage of the information the sponsor organization has about that person in its back-end systems.

For entities that are organizations, a more complex registration process is necessary. This is necessary largely for three reasons; namely that the person or people named on the registration are often unknown to the sponsor organization, that security is being granted to confidential information for the organization, and that security administration for the organization is being distributed to the organization. The first reason means that there is no information in the sponsor organization back-end systems that may be used to assist in the verification process. The second reason means that it is important that the person or people named on the registration are appropriate to the role(s) outlined for them on the registration. The third reason means that a security administrator (Primary Access Administrator) must be named on the registration and that a person who can legally bind the organization (Primary Controlling Authority) must sign legal agreements accepting the security responsibility and agreeing to behave in specific ways. Since the person who is named as the Primary Access Administrator on the application is likely to be unknown to the sponsor organization, some process is needed in order to confirm that the person is appropriate to be named the Primary Access Administrator. Some process is also needed to confirm that the person signing the registration is doing so appropriately.

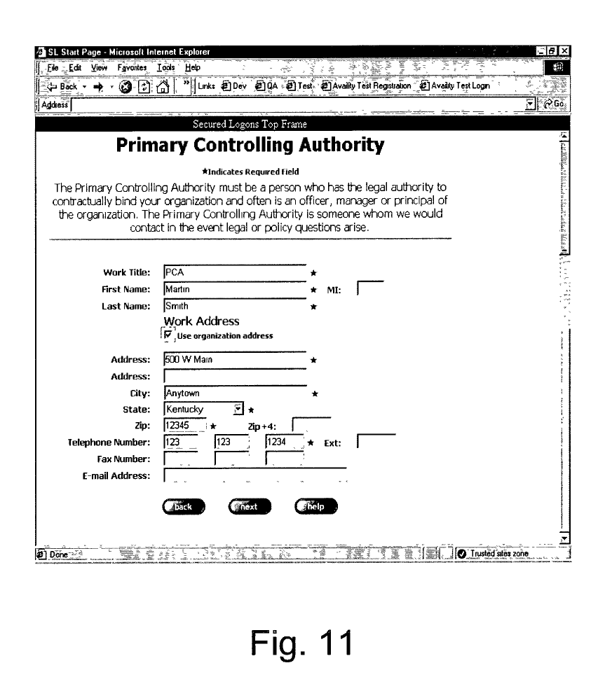

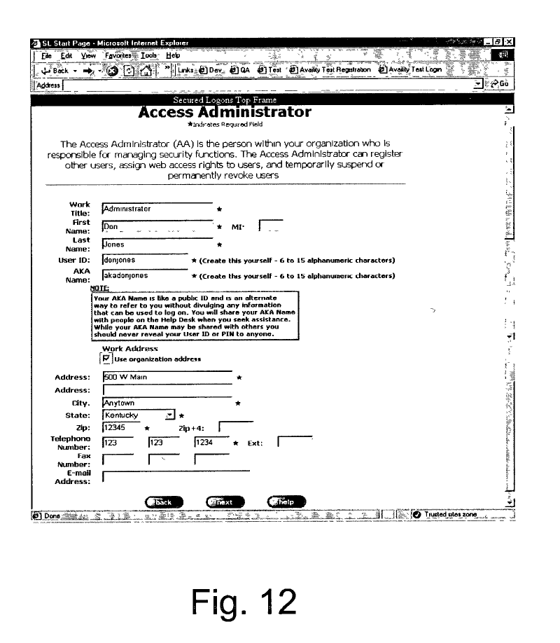

Registration for the organization entities includes three steps: registration, verification, and obtaining legal agreements. The first step, registration, is a process by which a person requests access on his organization's behalf to the secured web self-service functions and data of the sponsor organization. It is also the process by which the sponsor organization collects certain data about the person who will be the Primary Controlling Authority, the person who will be the Primary Access Administrator, and the organization. The application used for registration and data collection is a web-based application. Examples of screens employed in a web-based registration application for obtaining information about the person's organization and primary contact (Primary Controlling Authority) of the organization are shown in FIGS. 10-12.

The second registration step, verification, is the process of ascertaining the correctness of the information obtained from the registration application and of validating that there is a relationship with the sponsor organization such that the Primary Access Administrator and the organization with which he or she is associated have a right and a need to use the secure web self-service functions.

In the third registration step, obtaining legal agreements, specific legal agreements applicable to the interaction between the sponsor organization, any person gaining access on behalf of an organization, and the organization with which he or she is associated are signed or agreed to by the person and the organization. For the organization, this can be done at the time the registration is completed. For a person, this is done at first time logon, as referenced in a section above.

IV. Distribution of Security Administration

Security administration functionality is distributed to PAAs and AAs at External Entities and to System Application Owners.

A. Functions for PAAs and AAs at External Entities

Functions for PAAs and AAs at External Entities include the following items:

Register New Users

Assign Web Access Rights

Manage User Status

Maintain User Information

Maintain Organization Information

Monitor Security Changes

Review Current Security Profile

Segment Your Organization

Prepare to Accept Delegated Work

View Work Delegated to You

Assign Delegated Work

Delegate Work to Another Organization

Change Work Delegated to Another Organization

Stop Delegating Work to Another Organization

B. Functions for System Application Owners

There are three functions available for a system application owner to manage the business functions for which he or she is responsible and the access identifiers that are unique to those business functions.

1. System Application Owner Granting Access to Functions

The system application owner maintains the business functions of an organization by way of its primary access administrator. This process is similar to the sponsor organization IT security's maintenance function except that the system application owner is able to see, add, and delete only business functions for that system application owner and it is only able to maintain roles for the primary access administrator, not any of the organization's other users. This maintenance is done one organization at a time.

2. System Application Owner Identifier Maintenance

The process by which a system application owner maintains an organization's identifiers is quite similar to the sponsor organization IT security's access identifier maintenance function, except that the system application owner is able to edit, add, and delete only access identifiers for that system application owner. It may see access identifiers that are maintained by the sponsor organization IT security personnel. It will not see access identifiers that are maintained by owners of other system applications. This maintenance is done one organization at a time.

3. Establishing New Business Functions

The function of automating the distribution of new business functions to selected organizations' primary access administrators (PAAs) can be performed by the sponsor organization IT security personnel or by the system application owner. The screens would look the same for both groups, except that data is filtered by the system application owner when it is performed by the system application owner. The selection of organizations for this distribution of business functions is performed by broad categories of organizations, not, not by individual organization.

V. Support for Multiple Environments

A. Port of Origin Functionality

One of the key concepts in the secured logon application is port of origin. Using port of origin functionality and dynamic menuing, business function access can be controlled or limited based on the port of origin through which a user entered the secured logon application. An example of how the works is as follows: A user is an administrator for a Provider Organization. The user performs provider administrative activities for the Provider Organization (checks member eligibility and submits claims) and also performs employer benefit administration for the Provider Organization (enrolls new employees, reviews premium bills). This person effectively wears two hats for the Provider Organization. Wearing the hat of the administrator in the physician's office, the user enters the secured logon application through the sponsor organization's port of origin for healthcare providers. Once the user has been authenticated and enters the secured logon application, the user is presented with a list of business functions related to the access he or she has in the context of an administrator for a physician's organization (i.e. patient referrals, authorizations, etc.) as defined by that port of origin. Now that same administrator exits the sponsor organization's port of origin for healthcare providers and re-enters, but this time through the sponsor organization's port of origin for employers using the same User ID and PIN/Password. This time the administrator is presented with a menu of options related to things an employer group can do. Things such as online bill lookup, review of physician directories, etc. might be presented to the administrator after logging in utilizing this PO.

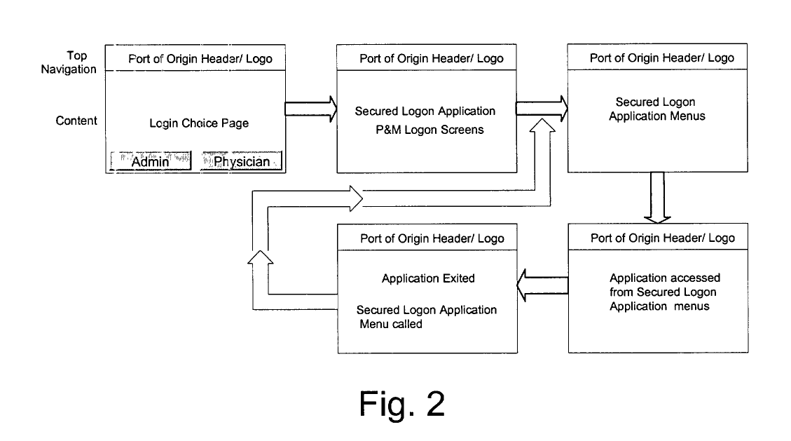

FIG. 2 is a flow chart that illustrates the flow a user of the secured logon application will follow when accessing business functions set up within the secured logon application from a registered port of origin.

In order for a PO to link to, and grant access to, the secured logon application resources, several things need to occur. These can be grouped into six categories, (1) accessing the secured logon application from a port of origin, (2) customizing the look and feel of the port of origin, (3) exiting the secured logon application, (4) making PDF and other documents available for download, (5) using a PO's own logon page, and (6) defining a PO's menu structure.

1. Secured Logon Application Access From a Port of Origin

Access to the secured logon application is defined as the requirements and processes required to invoke, call, or otherwise utilize the secured logon application. There are two methods for doing this, frameless and framed access. In addition to controlling access to business functions, the support for multiple PO's by the secured logon application also allows for the PO to control several other features of the secured logon application as described below:

a) Framed Access

In order for users to access the secured logon application from a PO using frames, that PO does the following:

1. Defines at a minimum, a two-frame page with the top frame being top justified. The lower frame may utilize the remainder of the page. Although the secured logon application permits the PO to define more than two frames, this may result in undesirable scrolling and layout of the secured logon application content.

2. Calls the secured logon application from the two-frame page.

3. Includes the header/logo it wants displayed while a user is utilizing secured logon application in the top frame.

4. Submits to the secured logon application administration team a style sheet that the PO wishes the secured logon application to adopt (this style sheet is used by the lower frame when the secured logon application is accessed). If the PO does not wish to use a specific style sheet, the default style sheet for secured logon application will be utilized. The style sheet is created by the port of origin using a template supplied by the secured logon application.

5. Submits the navigation and other graphics it wishes to utilize.

6. Submits the help text it wishes to provide to the user on each screen.

7. Passes the port of origin key assigned to the PO when a user logs onto a port of origin secured by the secured logon application. The port of origin key is assigned to the PO by the secured logon application administrator when the PO was initially registered. This Port of Origin key is also used to reference the folder that contains the other PO specific items such as: the top, left, and bottom navigation bar that can be used if frameless access to the secured logon application is utilized, as described hereinafter; the navigation graphics; the help text; and all other port of origin specific content. All content used for framed access is contained in the PO assigned folder and is referenced by the same PO key.

b) Frameless Access

If a PO wishes to utilize frameless access, it must do the following in addition to performing the acts described above in connection with framed access:

1. Provide a top navigation file that is included by the secured logon application and presented to the user in the same location as for framed access. The top navigation file replaces the top frame graphic employed in framed access.

2. Provide an optional left and bottom navigation or other include file that the PO wishes to display to the user

3. Give the top, left, and bottom navigation include files (hereafter, respectively, the “top navigation file,” “left navigation file,” and “bottom navigation file”) names specified by the secured logon application.

4. Supply the display size of the top, left, and bottom navigation files (i.e. 800×100 pixels). This information is recorded in the secured logon application in order to control the placement of certain items that require absolute positioning or presentation within a frameset.

2. Customizing the Look and Feel of a Port of Origin

In addition to choosing either framed or frameless access, the PO can further customize the “look and feel” of the pages supplied by the secured logon application subsequent to the logon page. Some of the features that can be controlled through the secured logon application are:

1. The header/logo displayed at the top of the page.

2. A left and bottom navigation bar.

3. The look and feel of the menu items displayed by secured logon application via a style sheet.

4. The location users are returned to when they complete a business function served up by secured logon application. Setting the Port of Origin return URL in the secured logon application does this.

5. The buttons or GIFs used for navigation.

6. The GIFs used to designate required fields and missing data.

7. The help text presented on each external screen provided by the secured logon application.

8. The menu items presented to the user when access is granted.

9. The text of most of the error messages presented to a user while utilizing the secured logon application functionality.

The manner in which these features is controlled is generally conventional. If the PO elects to utilize its own navigation graphics, the port of origin must supply the secured logon application with the files for its navigation graphics, and must strictly adhere to the naming convention specified by the secured logon application. The secured logon application stores these files on its server and the images are served up as the user navigates the secured logon application functionality.

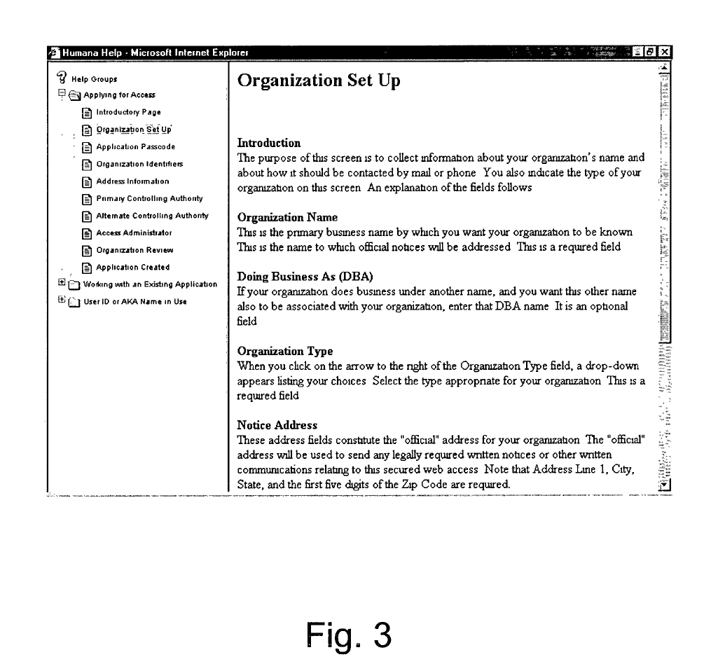

The secured logon application also allows each port of origin to develop the help text that is displayed when a user clicks one of the help buttons located on the screens supplied by secured logon application. A sample of a help text screen is shown in FIG. 3. The help file may contain whatever help text the port of origin wishes to display to the user.

In addition to the PO customizations described above, the secured logon application also allows the port of origin to customize the style sheet template used to control the “look and feel” of the screens presented by the secured logon application.

For handling server-side errors, the secured logon application provides a port of origin with the ability to customize the error message presented to a user in certain circumstances. Further, the port of origin is able to direct that user to a specific page once the user acknowledges the error by clicking on the OK button. The manner by which the secured logon application achieves these functions is largely conventional.

In order to support these functionalities, the secured logon application handles server-side errors by redirecting to a central error-handling dialog page. Error types are defined in an error message table and are port of origin-specific with port of origin 0 being the default port of origin. The error dialog retrieves an error message from the database based on the Port of Origin ID and Error Message ID. The default message is displayed if one does not exist for the port of origin. The Error dialog always displays the error message and an OK button, which performs a redirect when clicked. The OK redirect URL is stored in the error message table.

3. Exiting the Secured Logon Application

A PO can request that a user be returned to a specific URL when he or she exits the secured logon application by setting up a business function within the secured logon application that will ultimately become a menu item displayed within the secured logon application menus. This business function is merely a URL to a web page that contains the URL/redirect to the location the PO wishes the user returned to and a string of static data the PO wishes returned (if returned data is required).

4. Making PDF and Other Documents Available for Download

The secured logon application enables a port of origin to store documents for later presentation and downloading online by a user. The secured logon application supports this functionality by storing these documents in a folder called “documents” under the port of origin's directory structure. The secured logon application then displays the contents of the directory as links on an ASP page. When the user selects one of the links a download session is automatically started between the user's computer and the secured logon application. To utilize this functionality, the port of origin's documents must be uploaded into the system. Once this is done, a business function is registered for the port of origin with a link to the page that will display the directory's contents.

5. Using a PO's Own Logon Page

Recognizing that different Ports of Origin's (“PO”) may wish to carry their “look and feel” through the authentication process (the authentication process is common to all PO's that use secured logon application to secure and manage access to their resources), the secured logon application provides the ability for a PO to create its own login page in lieu of the standard ASP login screen page/process that is available via the secured logon application. If a PO wishes to do this, it must post a form to the page in the secured logon application that contains the User ID (userid), PIN/Password (txtpassword), the value “SECURITYLINK” (_referrer) and the PO numeric value (portoforigin) assigned to them by secured logon application (hereafter referred to as the “security link page”).

A Port of Origin may also initiate the PIN/Password change process by posting the User ID, PIN/Password and a PIN/Password change value of 1 to a specified variable in the page referenced above.

6. Defining a PO's Menu Structure

Dynamic menus are available from the secured logon application to allow for customized menus within a web application for each Port of Origin. This incorporates a level of personalization by allowing a Port of Origin to define the navigation for the functions for which the secured logon application controls access. The secured logon application stores the security information for user access, as well as the menu structure as defined by the Port of Origin. The Port of Origin can define the levels, sequence, and details of the menu templates

The secured logon application also provides data storage for Port of Origins to define the look and feel of their own menus. This is accomplished through both predefined fields in the database and user-defined fields.

A Port of Origin may develop its own menu, making use of the information defined within the secured logon application or it may use the menu that the secured logon application provides.

VI. System Integrators Interfaces

A. Getting Data From the Secured Logon Application

When a business function is launched from the dynamic menu, the secured logon application provides a launch string to the business function URL with the AKA Name of the user who is logged on and an identification of the menu item that was launched. Thereafter, the business function uses the AKA Name and the menu information with various methods to obtain information from the secured logon application for its own processing purposes.

A VB6 COM DLL exposes a single class (b_SystemApplication) containing methods to allow business functions to access data associated with the sponsor organization's secured logon application. Data stored and exposed includes Entity and User security information, as well as the function sets that are defined within the secured logon application data store. Data is returned in XML format or as an ADODB.recordset with a flat data representation of the information. An equivalent Java version of the VB6 COM DLL also is available which provides the same functionality except for non COM compliant systems.

Systems developers can call the exposed methods via COM interfaces as long as a trusted connection can be made to the secured logon application component and the component can run under the context of an account that has access to the secured logon application Database.

B. Registering System Applications

In order for business functions to be presented as menu items within the secured logon application, the application that “serves” them up must be registered within the secured logon application. An example of a system application is Trizetto's ePlan application, a system application that serves up eligibility, claims, authorizations (each of these are individual business functions), etc.

The secured logon application maintains required information about individual System Applications. To add a new System Application to the secured logon application, System Application Administrators must provide the secured logon application Administrator with the System Application Short Name and the System Application Description.

C. Registering Business Functions

As described above, the secured logon application provides a gateway to secured resources at a sponsor organization. As new PO's and/or system applications are added, they may have additional business functions that they wish to make available to users via the secured logon application. Such new business functions can be registered or implemented by having representatives from the PO's and/or system application's project team contact the secured logon application administrator and provide various descriptive and processing information about the business function.

D. Business Functions and Business Function Set Limitations

Initially, a business function can only exist in one business function set and in one port of origin. If there is a need to have a business function exist in more than one business function set or in more than one port of origin, that business function must be duplicated (registered more than once) for each instance that it is to be used.

An example would be if the sponsor organization wanted to create a business function called “view claims,” which it intended to utilize in both the provider portal and in the member portal. In the provider portal, office clerks would use this function to review patient claims. In the member portal, members would utilize this function to review their personal claims. In this example, the business function “view claims” would need to be registered twice. Both business functions could utilize the same description and use the same launch URL, but each would be associated with different ports of origin through their business function set association.

Although the secured logon application is designed so that a business function cannot be shared by multiple business function sets or multiple ports of origins, there are situations where a business function might need to exist in more than one business function set. An example of such a situation is where a set was created for office clerks called “clerks” and one was created for managers called “management”. Both groups might utilize a business function set such as “user demographics”.

The primary problem with such an arrangement is in the user interface area. FIG. 6 shows an exemplary screen for an “Assign roles” menu in which the user “Joe Alpha” is listed. As an example, assume that the intention is to grant the user “Joe Alpha” access to all of the functions in the “clerks” business function set but nothing in the “management” business function set. If the secured logon application allowed the “user demographics” business function to be shared by both sets, as soon as the user “Joe Alpha” was granted access to the “clerks” business function set, the business function “user demographics” would also appear as being checked in the “management” set, because the “user demographics” is the same function in both sets.

A likely reaction by the user would be to deselect or uncheck the “user demographics” option in the “management” business function set. If the user did this, he or she would inadvertently remove “Joe Alpha's” access to the “user demographics” business function from the “clerks” set as well. This result would be especially confusing to a user if he or she removed an administrators' clerk functions and then gave them manager functions, only to see on the screen that now the common functions to both sets have been activated in the clerk set again.

There are also situations where a business function might need to exist across multiple ports of origin. However, the secured logon application does not allow a business function set to be used in more than one port of origin because unwanted access might result. For example, assume that a business function called “view claims” has been created. This is a fairly common business function and likely will be used in some fashion in many portals.

Under the architecture of the secured logon application, if a business function is granted to a user and that business function is used in multiple portals, there is no way to prevent that user from having access to all portals that contain that business function. In other words, a member that has access to “view claims” could log into the provider portal and get access to secured provider functions, because that member has an active business function, “view claims,” that is valid for the provider portal. Although the access identifiers would prevent the member from viewing claims that were not his or her own, the member may have access to other secured content that may not require access identifiers (e.g., provider manuals, formularies, etc.).

E. Keeping the Secured Logon Application Session Alive

When a user logs into the secured logon application, a session is established. As long as the user is performing a function supplied by the secured logon application (e.g., manage organization information) or returns to the secured logon application supplied user menu, the secured logon application keeps the session current and up to date. However, once a user launches a menu item not provided by the secured logon application or if the PO uses a menu not supplied by the secured logon application, the secured logon application has no way to update the user's session and after a specified number of minutes the user's session will time out. The user will be forced to log back in if he/she attempts to return to the menu or access any of the functions that utilize the secured logon application session management. Each page that is part of the transaction should be attempting to keep the session alive. This is done by one of two methods depending on whether the transaction is running under the same domain or a different domain than the one the secured logon application is running under.

Same Domain Use the getSession_RS API

Different Domain—Post to an ASP page that does this for the application

F. Verifying User Access at the Page Level

As an added level of security, each page that serves up a secured business function can integrate an include file or method that performs page level access verification. This process performs a final validation to verify that the user still has current access to a business function that he or she is attempting to access. This prevents users from accessing a business function by typing the URL directly into the browser.

G. Transactions Via Posting to Forms

The secured logon application gives a port of origin the ability to perform certain functions by posting specified fields to a form. The functions supported are to “auto-create” an entity and a user and to “auto-create” an application. The URL from which the post comes must be registered in the secured logon application first. For security reasons, this method also requires that a specific page in the secured logon application be posted to.

For both functions, in addition to the post, the port of origin also must implement screens to capture the desired User ID, AKA Name, and PIN/Password the user wants. For usability reasons, it is preferable that the post should originate from this selection screen, although it does not have to. This will allow for the presentation of User ID and AKA Name conflict screens by the secured logon application as the next step, should the User ID or AKA Name the user selected already be in use in the secured logon application.

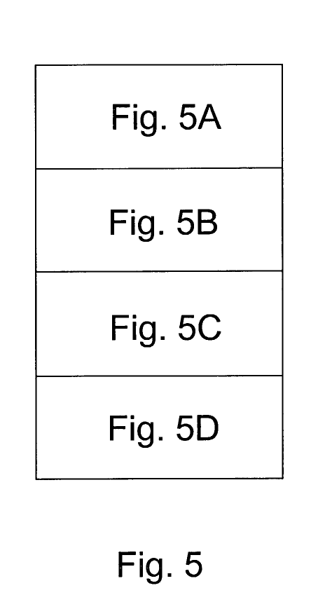

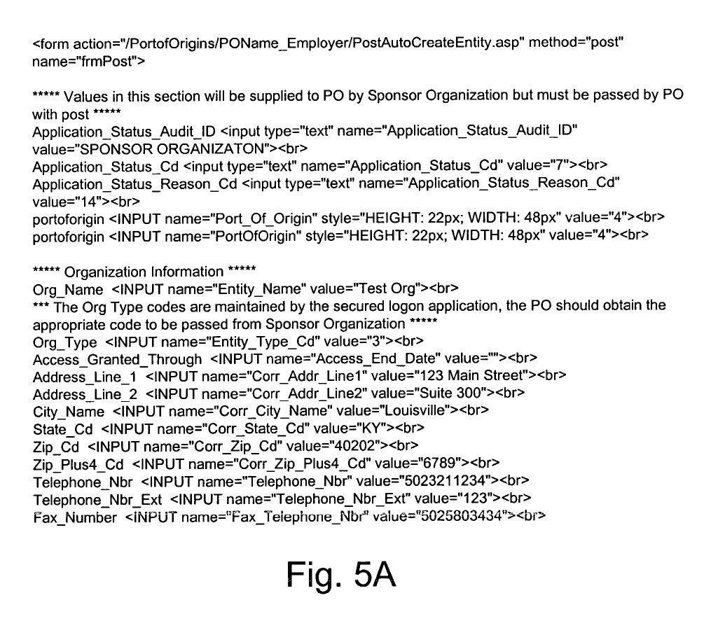

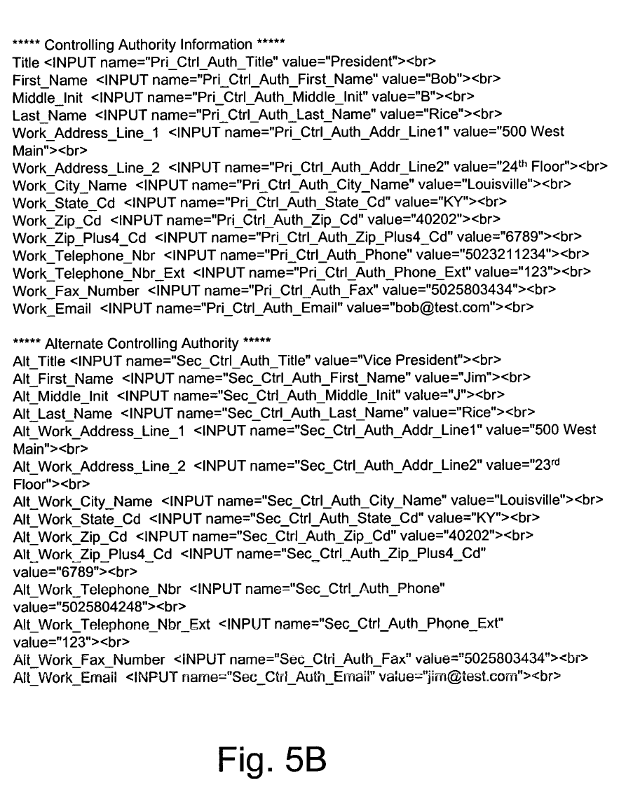

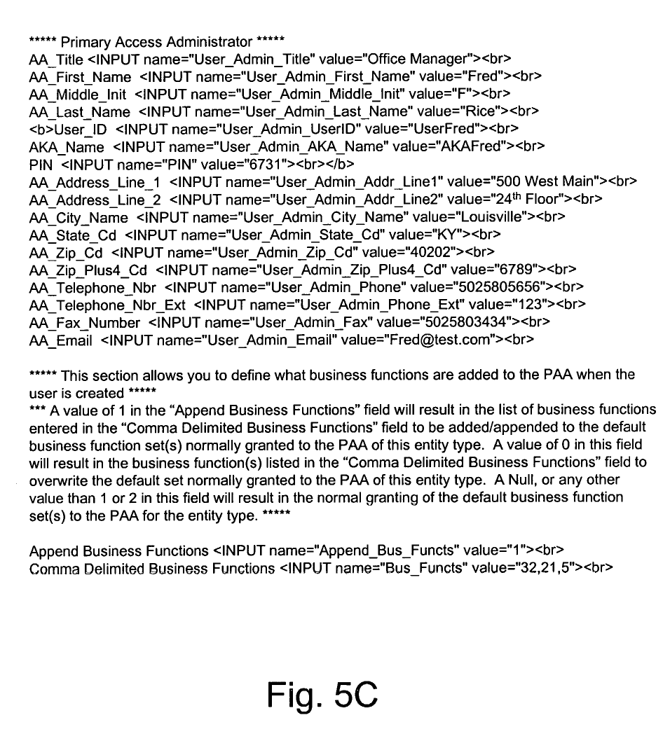

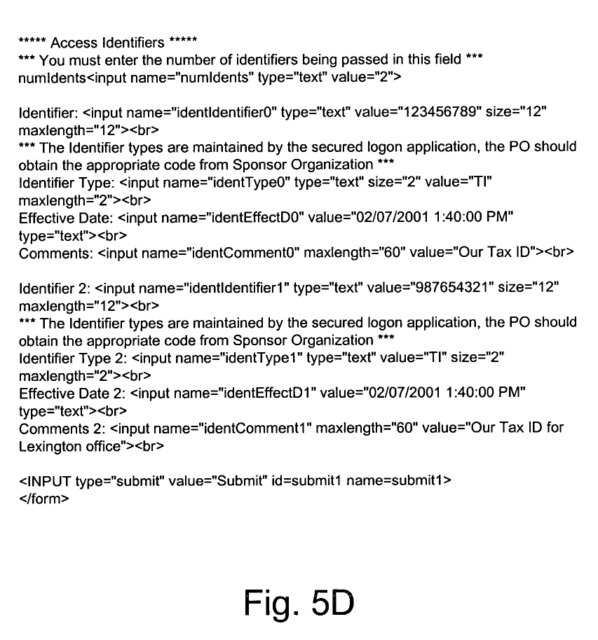

An example of a form post used to give a port of origin the ability to “auto-create” an entity and a user is shown in FIG. 5.

H. Updating Data Programmatically in the Secured Logon Application

In certain instances it may be necessary or desirable for a system application or process to update the data in the secured logon application. In order to accommodate this functionality, the secured logon application includes a generic XML transaction processor. Access to the transaction access handler is available via the SecLinkSysApp.dll.

In order to utilize the transaction handler, the system application owner must register the system application in the secured logon application and build the processes to enforce the business and security rules for the transaction.

The present embodiment of the secured logon application includes support for the following transaction types, although it is contemplated that other transactions can be added.

1. PAA Function Data Access Transaction

2. Access Identifier Transaction

3. Access Identifier Group Transaction

4. User Access Transaction

5. Entity User Attribute Transaction

6. User Attribute Transaction

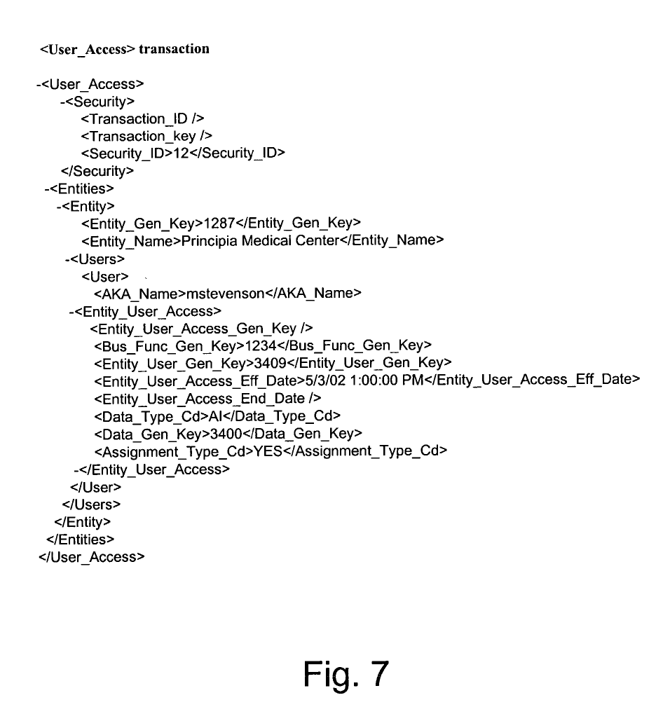

An exemplary XML transaction for updating a user's access programmatically is shown in FIG. 7.

I. Notification of Security Profile Changes in the Secured Logon Application

The secured logon application provides notification to interested parties of changes in security profiles. The notification takes place via an XML transaction. The present embodiment of the secured logon application includes support for the following transaction types, although it is contemplated that other transactions can be added.

1. Application reaching entered status

2. Application being approved

3. Entity information changing

4. Entity access identifiers changing

5. PAA information changing

6. PAA business functions changing

7. User information changing

8. User business functions changing

9. Controlling authority information has changed

VII. Miscellaneous System Information

A. Secured Logon Application Internal Screens

ASP screens are used in a conventional manner to manage access and administer the secured logon application internally. These screens are only available to associates of the sponsor organization with the proper access rights.

B. The Secured Logon Application Data Objects

Data objects are used by the business object to provide data access. They cannot be directly accessed from a web application. The data objects in turn use the u_Util object to provide database connectivity and to execute the actual commands against the database.

C. Secured Logon Application Utility Objects

Utility objects are employed to provide methods for the data objects to use to connect to the database and execute commands against it.

VIII. Data Model

The secured logon application is supported by the following MS SQL Server tables:

ACCESS_APPLICATION

ACCESS_APPLICATION_ADDRESS

ACCESS_GROUP

ACCESS_GROUP_ID_ASSOC

ACCESS_GROUP_ID_ASSOC_LOG

ACCESS_GROUP_LOG

ACCESS_IDENTIFIER

ACCESS_IDENTIFIER_LOG

ACCESS_MODULE_SEQUENCE

AGREEMENTS

ALLOWED_APPLICATION_STATUS_TO_REASON_ASSOCIATION

ALLOWED_MILESTONES_AND_STATE_TRANSITIONS

APPL_ACCESS_IDENTIFIER

APPLICATION_MODULE

APPLICATION_PORT_OF_ORIGIN_ENTITY_TYPE_ACCESS_ID_TYPE_ASSOCIATION

APPLICATION_PROCESSING_TYPE

APPLICATION_REPORTING_TABLE

APPLICATION_ROUTING_CONTROL

APPLICATION_STATUS

APPLICATION_STATUS_HISTORY

APPLICATION_TYPE_REPORTING

APPLICATION_VIEW_CONTROL

BF_ALLOWED_BYCOVERAGE

BUS_FUNC_ID_TYPE_ASSOC

BUSINESS_FUNCTION

BUSINESS_FUNCTION_ASSOC

BUSINESS_FUNCTION_SET

CONTROLLING_AUTHORITY

CONTROLLING_AUTHORITY_HIST

COVERAGE₁₃ QUALIFIERS

COVERAGES

DELEGATION

DELEGATION_AUTHORIZATION

DEMO_IDS

DYNAMIC_LINK

DYNAMIC_LINK_TYPE

EMAIL_ADDRESS

ENTITY_TYPE_ENTITY_TYPE_ASSOC

ENTITY_TYPE_FUNCTION

ENTITY_USER

ENTITY_USER_ACCESS

ENTITY_USER_ACCESS_LOG

ENTITY_USER_ATTRIBUTES

ENTITY_USER_LOG

ERROR_EMAIL_ASSOC

ERROR_KEYWORD

ERROR_KEYWORD_ASSOC

ERROR_MSG

ERROR_REFERENCE

EU_ATTRIBUTE_HIST

EUA_DELEGATION_ASSOC

EXCEPTION_PROFILE

EXCEPTION_PROFILE_LOG

EXCEPTION_SET

EXCEPTION_SET_LOG

EXTERNAL_ENTITY

EXTERNAL_ENTITY_ADDRESS

EXTERNAL_ENTITY_ADDRESS_HIST

EXTERNAL_ENTITY_ATTRIBUTES

EXTERNAL_ENTITY_HIST

FINAL_DISPOSITION_REPORTING

HELP_GROUP

HELP_GROUP_ORIGIN_ASSOC

HELP_GROUP_ORIGIN_BUS_FUNC_ASSOC

HELP_GROUP_TOPIC_ASSOC

HELP_SECTION

HELP_TOPIC

IMMUTABLE_BUSINESS_FUNCTIONS

INCOMPLETE_DB2_UPDATES

LOG_DETAIL

LOG_ROLE

LOG_SUMMARY

LOOKUP_CODE_GROUPS

LOOKUP_CODES

MEMBER_XML_HIST

MENU_TEMPLATE

NOTIFICATION

NOTIFICATION_CONFIRMATIONS

NOTIFICATION_HIST

NOTIFICATION_MSG_CREATION_FAILED

NOTIFICATION_PAYOR_LIST

NOTIFICATION_PAYOR_MSGQ

NOTIFICATION_PAYOR_MSG_TYPES

NOTIFICATION_POST_FAILURES

NOTIFICATION_TRANSACTION

NOTIFICATION_TRANSACTION_HIST

ORIGIN_LOOKUP_CODE_OVERRIDES

PASSWORD_CHANGE_HISTORY

PORT_OF_ORIGIN

PORT_OF_ORIGIN_ATTRIBUTES

SITE_MONITOR

STATUS_CONTROL

SYSTEM_APPLICATION

SYSTEM_APPLICATION_ATTRIBUTES

SYSTEM_CONFIG

SYSTEM_NOTIFICATIONS

SYSTEM_NOTIFICATIONS_HIST

TRANSACTION_DEFINITION

TRANSACTION_SCRIPT_SEQUENCE

TRANSACTION_SCRIPTS

USER

USER_AGREEMENT_ACCEPTANCE

USER_ATTRIBUTES

USER_ATTRIBUTE_HIST

USER_HIST

USER_LOGIN

USER_SESSION

USER_SESSION_HIST

XML_TRANS_DEF

XML_TRANS_TYPES

All data retrieval is performed through the external class and its associated methods.

The ACCESS_APPLICATION table contains information that is collected about an External Entity during the registration process for gaining access to functions and information secured by Secured Logons.

The The ACCESS_APPLICATION_ADDRESS table contains information about alternate addresses that may be captured during the completion of an ACCESS APPLICATION.

The ACCESS_GROUP table contains definitional information about Access ID Groups (segments), which are used to define pieces of organizations (segments) based on groupings of access identifiers.

The ACCESS_GROUP_ID_ASSOC table contains the association between Access ID Groups (segments) and the Access Identifiers that make up the content of the Access ID Groups (segments).

The ACCESS_GROUP_ID_ASSOC_LOG table captures an audit trail of all the changes made to ACCESS_GROUP_ID_ASSOC, including the initial creation of an Access_Group_ID_Assoc.

The ACCESS_GROUP_LOG table captures an audit trail of all the changes made to ACCESS_GROUP, including the initial creation of an Access_Group (segment).

The ACCESS_IDENTIFIER table contains information about Access Identifiers for external entities. These are keys to the data about the external entities in the back-end systems. Example identifiers may be Federal Tax Identification Numbers (TIN), Broker Id, State License Number, etc.

The ACCESS_IDENTIFIER_LOG table captures an audit trail of all the changes made to ACCESS_IDENTIFIER, including the initial creation of an Access_Identifier.

The process to collect Access_Application_New information can consist of several application modules. The ACCESS_MODULE_SEQUENCE table defines the sequence in which the application modules are executed for specific Ports of Origin and Entities.

The AGREEMENTS table stores information about each agreement that users must consent to in order to gain access to functions and information secured by Secured Logons.

The ALLOWED_APPLICATION_STATUS_TO_REASON_ASSOCIATION table associates application statuses to valid reason codes for that status.

The ALLOWED_MILESTONES_AND_STATE_TRANSITIONS table indicates for a given application milestone and status, the set of valid application milestones and statuses possible for the next step in application processing.

The APPL_ACCESS_IDENTIFIER table contains information about Access Identifiers for an External Entity that are captured during the registration process for gaining access to functions and information secured by Secured Logons. Access Identifiers are keys to the data about the External Entities in the back-end systems.

The APPLICATION_MODULE table contains information about each of the modules that are used to collect Access_Application_New information There can be different sets of modules for each Port of Origin and Entity Type.

The APPLICATION_PORT_OF_ORIGIN_ENTITY_TYPE_ACCESS_ID_TYPE_ASSOCIATION table associates Ports of Origin and Entity Types with Access Identifier Types to determine which Access Identifier Types can be collected for a given Port of Origin/Entity Type pair during the registration process for gaining access to functions and information secured by Secured Logons.

The APPLICATION_PROCESSING_TYPE table indicates what kind of application process is to take place for a given Entity Type and Port of Origin. Examples are “Paper”, “Paperless”, “Autoapproved”.

The APPLICATION_REPORTING_TABLE table contains one row for each Access_Appplication_New that contains dates and times that each milestone is reached and indicates the latest status. table provides metrics on the approval and completion of applications.

The APPLICATION_ROUTING_CONTROL table indicates valid routing destinations for an Access Application based upon Port of Origin, Entity Type, Current Status/Milestone, and group currently responsible for the Access Application.

The APPLICATION_STATUS table contains records of each milestone, status, and activity combination that has occurred for an application. These records document the progress of the application through the approval process.

The APPLICATION_STATUS_HISTORY table captures an audit trail of all the changes made to APPLICATION_STATUS.

The APPLICATION_TYPE_REPORTING is a specialized table used in determining counts quickly. It contains a row for each type of application (autoapproved, paper, paperless) and columns for each type of application, which contain values of 0 or 1.

The APPLICATION_VIEW_CONTROL table controls which groups of people can see the status of an application based upon Port of Origin and Entity Type.

The BF_ALLOWED_BYCOVERAGE table relates Business Functions to specific coverage types.

The BUS_FUNC_ID_TYPE_ASSOC table relates each Business Function to the type(s) of Access ID's that the Business Function uses for its processing. If a Business Function does not appear in this table, it means that the Business Function does not require any Access Ids in order to perform it processing.

The BUSINESS_FUNCTION table defines each Business Function, which is a function or activity that a user can perform and which is secured by Secured Logons.

The BUSINESS_FUNCTION_ASSOC table associates each Business Function to the Business Function Set to which it belongs.

The BUSINESS_FUNCTION_SET table defines each Business Function Set, which is a logical grouping of Business Functions.

The CONTROLLING_AUTHORITY table contains information about the person(s) who have the legal right to control the External Entity and bind the External Entity in contractual agreements.

The CONTROLLING_AUTHORITY_HIST table contains after update images of rows in the CONTROLLING_AUTHORITY table.

The COVERAGE_QUALIFIERS table defines applicable coverage qualifiers based upon member status. Qualifiers allow coverages to extend beyond the standard rule set.

The COVERAGES table identifies coverages available for use in determining Business Function rules.

The DELEGATION table defines the information that allows a third-party organization (entity) to do work for another organization with which it has a business relationship.

The DELEGATION_AUTHORIZATION table holds Delegation Acceptance Codes that indicate the willingness of an organization to do work for another.

The DEMO_IDS table identifies the External Entities and Users which are set up for guest access to Secured Logons for testing and demonstration purposes.

The DYNAMIC_LINK table contains information that is used to define dynamically generated links that can appear on screens.

The DYNAMIC_LINK_TYPE table is a list of criteria defining types of dynamic links available for use. The only one available at this time is a “derivative” link.

The EMAIL_ADDRESS table contains e-mail addresses for members of a support team. table is used for sending error message notification to team members.

The ENTITY_TYPE_ENTITY_TYPE_ASSOC table is used in the Delegation process to define what kind of organization (From_Entity_Type) can delegate to another kind of organization (To_Entity_Type).

The ENTITY_TYPE_FUNCTION table associates Business Function Sets to the Entity Types of External Entities that can validly execute the Business Functions within the Business Function Set.

The ENTITY_USER table contains an association of External Entities to Users that have received permission to do work on behalf of the External Entity. A “real” Entity_User identifies a User who works for the External Entity and has received permissions through the regular assignment process. A “virtual” Entity_User identifies a user who works for another External Entity and has received permissions through a delegation process.

The ENTITY_USER_ACCESS table defines the access rights a User has for a External Entity in terms of the Business Function:Data pairs that the User can work with.

The ENTITY_USER_ACCESS_LOG table captures an audit trail of all the changes made to ENTITY_USER_ACCESS, including the initial creation of an Entity_User_Access.

The ENTITY_USER_ATTRIBUTES table stores information about the ENTITY_USERs.

The ENTITY_USER_LOG table captures an audit trail of all the changes made to ENTITY_USER, including the initial creation of an Entity_User.

The ERROR_EMAIL_ASSOC table associates server-side system errors with specific e-mail addresses.

The ERROR_KEYWORD table establishes words that relate to server-side system errors. Some current keywords are “application” and “logon.”

The ERROR_KEYWORD_ASSOC table associates custom keywords with server-side system errors so that a Customer Service Rep can retrieve all errors that relate to that keyword.

The ERROR_MSG table stores error messages for server-side system errors. The message content can differ by Port of Origin. Default error messages are stored for Port of Origin=0.

The ERROR_REFERENCE table contains information about the server-side system errors.

The EU_ATTRIBUTE_HIST table captures an audit trail of all the changes made to ENTITY_USER_ATTRIBUTES, including the initial creation of an Entity_User_Attribute.

The EUA_DELEGATION_ASSOC table gives the reason why (the Delegation referenced in the table) a row in the Entity_User_Access table is permitted to exist for a “virtual user.” This table is only used when delegation is being dealt with. There can be multiple rows in this table to justify a row in the Entity_User_Access table; i.e., there are multiple delegation chains for this entity/user/business function/access Id (or access group). The EUA_Delegation_Assoc table is a self-documenting table. No deletions are permitted.

The EXCEPTION_PROFILE table defines business functions that are excepted from a user's view.

The EXCEPTION_PROFILE_LOG table captures an audit trail of all the changes made to EXCEPTION_PROFILE.

The EXCEPTION_SET table relates to ASO Group Profiling. table contains definitions of the groups used to override a user's access.

The EXCEPTION_SET_LOG table captures an audit trail of all the changes made to EXCEPTION_SET.

The EXTERNAL_ENTITY table contains information about an External Entity that has been approved to gain access to functions and information secured by Secured Logons.

The EXTERNAL_ENTITY_ADDRESS table contains information about alternate addresses that may be available for an External Entity.

The EXTERNAL_ENTITY_ADDRESS_HIST table contains update after images for the EXTERNAL_ENTITY_ADDRESS table.

The EXTERNAL_ENTITY_ATTRIBUTES table stores information about the EXTERNAL_ENTITY.

The EXTERNAL_ENTITY_HIST table contains update after images for the EXTERNAL_ENTITY table.

The FINAL_DISPOSITION_REPORTING table is a specialized table used in determining counts quickly. It contains a row for each final disposition of an application (approved, denied, withdrawn, etc.) and columns for each final disposition, which contain values of 0 or 1.

The HELP_GROUP table defines the Help Groups, which organize the Help information relating to the various business functions performed by the user when using Secured Logons.

The HELP_GROUP_ORIGIN_ASSOC table associates each Help Group with the Ports of Origin for which it is valid. Each Help Group is associated first with the Port of Origin in which it was added, but can be assigned to multiple Ports of Origin within the Secured Logons Help system.

The HELP_GROUP_ORIGIN_BUS_FUNC_ASSOC table associates each Help Group in a Port of Origin to the Business Function(s) for which it organizes the Help information. Every Help Group in every Port of Origin must be assigned business functions.

The HELP_GROUP_TOPIC_ASSOC table associates each Help Group to the Help Topic(s) making up that Help Group and indicates the sequence in which the Help Topics will be displayed within that Help Group.

The HELP_SECTION table defines the Help Sections, which are the actual content within the Help information. Within Help Topics, Help Sections provide the place to write text documenting each task.

The HELP_TOPIC table defines the Help Topics, which organize the Help information relating to each screen within a Business Function.

The IMMUTABLE_BUSINESS_FUNCTIONS table allows a method of overriding entries in EXCEPTION_PROFILE and EXCEPTION_SET.

When transactions apply changes to both SQL Server and DB2, it is possible for DB2 to be unavailable. Rather than force the entire transaction to fail, any DB2 updates in the transaction will be written to this table where they will be stored for execution at a later time. By executing the DB2 updates stored in the INCOMPLETE_DB2_UPDATES table in sequential order at a later time, the integrity of the transactions will be maintained.

The LOG_DETAIL table contains detailed information about errors in LOG_SUMMARY if the detail log option is “on.”

The LOG_ROLE table defines the processes where error logging takes place.

The LOG_SUMMARY table contains information about errors generated in Secured Logons

The LOOKUP_CODE_GROUPS table provides a way to group the codes in the Lookup_Codes table into logically distinct code groups. The Lookup_Code_Groups table defines the different code groups. LOOKUP_CODE_GROUPS and LOOKUP_CODES together form a generic structure that replaces multiple physical tables that would otherwise be created to hold codes and their descriptions for dropdown boxes and lists.

The LOOKUP_CODES table contains the code values that make up the code groups defined in the Lookup_Code_Groups table.. Together with LOOKUP_CODE_GROUPS, these two tables form a generic structure that replaces multiple physical tables that would otherwise be created to hold codes and their descriptions for dropdown boxes and lists.

The MENU_TEMPLATE table defines templates that can be used in preparing custom menus for each user containing the Business Functions each has a right to perform.

The NOTIFICATION_CONFIRMATIONS table contains confirmation information regarding the receipt of XML Notifications.

The NOTIFICATION_PAYOR_LIST table contains a list of the System Application owners that elect to received XML Notifications of one type or another and the URL to which the XML notifications are to be sent.

The NOTIFICATION_PAYOR_MSG_Q table contains a queue of the Notifications that are ready to be processed for each System Application owner.

The NOTIFICATION_PAYOR_MSG_TYPES table contains a list by System Application owner of the Notification types the owner elects to receive.

The NOTIFICATION_POST_FAILURES stores a history of all Notifications that were not processed successfully.

The NOTIFICATION_TRANSACTION table contains a queue of the Notifications that are waiting for the XML notification processor to process.

The NOTIFICATION_TRANSACTION_HIST table stores a history of all Notifications that have been processed successfully by the XML transaction processor. This includes Notifications that no one wanted and therefore were not transmitted anywhere.

The ORIGIN_LOOKUP_CODE_OVERRIDES table contains Port of Origin specific additions, replacements and exclusions to the LOOKUP_CODES table.

The PASSWORD_CHANGE_HISTORY table records password change history for users.

The PORT_OF_ORIGIN table defines the Ports of Origin secured by Secured Logons, where a Port of Origin is a starting point or entry point for getting access to secured business functions and resources via Secured Logons..

The PORT_OF_ORIGIN_ATTRIBUTES table stores information about the Ports of Origin.

The Site_Monitor table contains information used in monitoring the site to see that it remains active.

The STATUS_CONTROL table controls the “status” of Users, Entities, and Entity_Users. Status may include “Active,” “Revoked,” or “Inactive.”

The SYSTEM_APPLICATION table contains information about each System Application, which is the code implementing a business function or set of business functions.

The SYSTEM_APPLICATION_ATTRIBUTES table stores information about the System Applications.

The SYSTEM_CONFIG table stores information regarding a particular installation/configuration of Secured Logons.

The SYSTEM_NOTIFICATIONS table contains information enabling the broadcast of System Notifications to broad classes of users.

The SYSTEM_NOTIFICATIONS_HIST table stores history for SYSTEM_NOTIFICATIONS.

The USER table contains information about each user who has ever had rights granted by an External_Entity to business functions and resources secured by Secured Logons.

The USER_AGREEMENT_ACCEPTANCE table stores information about each Agreement to which each User has consented.

The USER_ATTRIBUTES table stores information about the USERs.

The USER_ATTRIBUTE_HIST table stores history for USER_ATTRIBUTES.

The USER_HIST table contains after update images of the USER table.

The USER_LOGIN table stores security verification information for each User and accumulates statistics related to unsuccessful User logon attempts.

The USER_SESSION table stores information about Logon Sessions that are currently active.

The USER_SESSION_HIST table stores information about all prior Logon Sessions for each User to Secured Logons.

TheXML_TRANS_DEF table stores information regarding the versions of the XML Notification processor.

TheXML_TRANS_TYPES table stores information describing the events that can trigger an XML notification transaction.

The data definitions for some of the tables are as follows:

| Table | Column | Format | Definition |
|---|---|---|---|
| ACCESS_GROUP | Access_Group_Comment | varchar | This field contains comments related to |
| | | (60) | the Access Group (segment). The field |
| | | | may contain any value. This value is |
| | | | permitted to change. |
| ACCESS_GROUP | Access_Group_Eff_Date | datetime | The date in GMT when the this Access |
| | | (8) | Group (segment) is added. It is the date |
| | | | when the Access Group (segment) is |
| | | | first available for use within Secured |
| | | | Logons. |
| ACCESS_GROUP | Access_Group_End_Date | datetime | The date in GMT when this Access |
| | | (8) | Group (segment) is no longer to be used. |
| | | | This field is initialized to <NULL>. It is set |
| | | | when a user wants to ‘delete’ this Access |
| | | | Group (segment). |
| ACCESS_GROUP | Access_Group_Gen_Key | int | This is a unique key that identifies this |
| | | (4) | Access Group (segment). It is generated |
| | | | when the Access Group (segment) is |
| | | | added to the data base. |
| ACCESS_GROUP | Access_Group_Long_Desc | varchar | This is a descriptive explanation of the |
| | | (255) | purpose and contents of the Access |
| | | | Group. This value is permitted to |
| | | | change. |
| ACCESS_GROUP | Access_Group_Short_Desc | varchar | The administrator created name of the |
| | | (25) | Access Group. It should be descriptive |
| | | | and brief. This value is permitted to |
| | | | change. |
| ACCESS_GROUP | Access_Group_Source | varchar | Tells which of the source types created |
| | | (15) | this AccessGroup (segment). If the |
| | | | source type is UR (User), this value is |
| | | | the AKA name of the user; if the source |
| | | | type is SC (Security), this value is the |
| | | | AKA name of the security user; if the |
| | | | source type is SA (System Application), |
| | | | it is the Gen_key of the system |
| | | | application; etc. |
| ACCESS_GROUP | Access_Group_Source_Type Cd | varchar | From the Lookup_Codes table. Tells |
| | | (5) | where the source for the Access Group |
| | | | segment) points to: System_Application |
| | | | or Business_Function or which user |
| | | | created or any other value. |
| ACCESS_GROUP | Access_Group_Source_Type_Cd_{—} | varchar | This code identifies the code table within |
| | Table_Id | (8) | the lookup codes table which contains |
| | | | the Source_Type values |
| ACCESS_GROUP | Admin_Entity_Gen_Key | int | This is a key within the External_Entity |
| | | (4) | table, pointing to the entity of the PAA or |
| | | | AA that created this group (segment). |
| | | | For situations that do not involve |
| | | | delegation, this will have the same value |
| | | | as the BehalfOf_Entity_Gen_Key. For |
| | | | situations that involve delegation, the |
| | | | ‘delegated-to (Admin)’ entity is creating |
| | | | and managing its own set of groups |
| | | | segments) from identifiers for the |
| | | | ‘BehalfOf_Entity’ and this points to the |
| | | | Entity that has been ‘delegated-to’. When |
| | | | delegation is involved, the |
| | | | Admin_Entity_Gen_Key is different from |
| | | | the BehalfOf_Entity_Gen_Key. |
| ACCESS_GROUP | BehalfOf_Entity_Gen_Key | int | This is a key within the External_Entity |
| | | (4) | table, pointing to the entity to which all |
| | | | the Access Ids in this group (segment) |
| | | | belong. For situations that do not involve |
| | | | delegation, this is the same value as |
| | | | Admin_Entity_Gen_Key. For situations |
| | | | that involve delegation, this points to the |
| | | | entity whose ids are being grouped and |
| | | | the value is different from |
| | | | Admin_Entity_Gen_Key. |
| ACCESS_GROUP | Created_By_User_Id | varchar | This is the AKAName of the user who |
| | | (25) | created the Access Group (segment). It |
| | | | may be NULL if the AccessGroup |
| | | | (segment) was created by a non-GUI |
| | | | program. |
| ACCESS_GROUP | DT_Created | datetime | The date and time in GMT that this |
| | | (8) | Access Group (segment) was added to |
| | | | the data base. |
| ACCESS_GROUP_ID_ASSOC | Access_Group_Gen_Key | int | This is a key within the Access_Group |
| | | (4) | table, pointing to the group (segment) |
| | | | this row is associated with. |
| ACCESS_GROUP_ID_ASSOC | Access_Group_Id_Assoc_Gen_{—} | int | This is a unique key that identifies this |
| | Key | (4) | Access Group ID Assoc. It is generated |
| | | | when the Access Group ID Assoc is |
| | | | added to the data base. |
| ACCESS_GROUP_ID_ASSOC | Access_Group_Id_Eff_Date | datetime | The date in GMT when the this Access |
| | | (8) | Group ID Assoc is added. It is the date |
| | | | when the Access Group ID Assoc is first |
| | | | available for use within Secured Logons. |
| | | | It represents when this Access Id was |
| | | | first added to this group (segment). |
| ACCESS_GROUP_ID_ASSOC | Access_Group_Id_End_Date | datetime | The date in GMT when this Access |
| | | (8) | Group ID Assoc is no longer to be used. |
| | | | This field is initialized to <NULL>. It is set |
| | | | when a user wants to ‘delete’ this Access |
| | | | Group ID Assoc. It represents when this |
| | | | Access ID was removed from the group |
| | | | segment). |
| ACCESS_GROUP_ID_ASSOC | Access_Group_Id_Source | varchar | Tells which of the source types created |
| | | (15) | this Access Group ID Assoc. If the |
| | | | source type is UR (User), this value is |
| | | | the AKA name of the user; if the source |
| | | | type is SC (Security), this value is the |
| | | | AKA name of the security user; if the |
| | | | source type is SA (System Application), |
| | | | it is the Gen_key of the system |
| | | | application; etc. |
| ACCESS_GROUP_ID_ASSOC | Access_Group_Id_Source_Type_Cd | varchar | From the Lookup_Codes table. Tells |
| | | (5) | where the source for the Access Group |
| | | | ID Assoc points to: System_Application |
| | | | or Business_Function or which user |
| | | | created or any other value. |
| ACCESS_GROUP_ID_ASSOC | Access_Group_Id_Source_Type_Cd_{—} | varchar | This code identifies the code table within |
| | Table_Id | (8) | the lookup codes table which contains |
| | | | the Source Type values |
| ACCESS_GROUP_ID_ASSOC | Access_ID_Gen_Key | int | This is a key within the Access_Identifier |
| | | (4) | table, pointing to the Access ID this row |
| | | | is associated with. This association |
| | | | indicates the Access ID is a member of |
| | | | the group (segment) referenced on this |
| | | | row. |
| ACCESS_GROUP_ID_ASSOC | Created_By_User_Id | varchar | This is the AKAName of the user who |
| | | (25) | created the Access Group ID Assoc. It |
| | | | may be NULL if the Access Group ID |
| | | | Assoc was created by a non-GUI |
| | | | program. |
| ACCESS_GROUP_ID_ASSOC | DT_Created | datetime | The date and time in GMT that this |
| | | (8) | Access Group ID Assoc was added to |
| | | | the data base. |
| ACCESS_IDENTIFIER | Access_Id | varchar | This is an identifier associated with an |
| | | (60) | entity and with the back-end data |
| | | | associated with that entity. It is used to |
| | | | provide the connection between an entity |
| | | | and the back-end data supporting the |
| | | | business functions used by the entity. |
| | | | This is essentially a key to that data. |
| ACCESS_IDENTIFIER | Access_Id_Class_Cd | varchar | This is a code indicating whether this |
| | | (5) | Access ID is a Primary or Derivative |
| | | | Access ID. Values are in the Lookup |
| | | | Codes table |
| ACCESS_IDENTIFIER | Access_Id_Class_Cd_Table_Id | varchar | This code identifies the code table within |
| | | (8) | the lookup codes table which contains |
| | | | the Class_Cd values |
| ACCESS_IDENTIFIER | Access_Id_Comment | varchar | This field contains comments related to |
| | | (60) | the Access ID. The field may contain |
| | | | any value. This value is permitted to |
| | | | change. |
| ACCESS_IDENTIFIER | Access_Id_Eff_Date | datetime | The date in GMT when the this Access |
| | | (8) | ID is added. It is the date when the |
| | | | Access ID is first available for use within |
| | | | Secured Logons. |
| ACCESS_IDENTIFIER | Access_Id_End_Date | datetime | The date in GMT when this Access ID is |
| | | (8) | no longer to be used. This field is |
| | | | initialized to <NULL>. It is set when a |
| | | | user wants to ‘delete’ this Access ID. |
| ACCESS_IDENTIFIER | Access_ID_Gen_Key | int | This is a unique key that identifies this |
| | | (4) | Access ID. It is generated when the |
| | | | Access ID is added to the data base. |
| ACCESS_IDENTIFIER | Access_Id_Long_Desc | varchar | This is a long descriptive explanation of |
| | | (255) | what the Access ID represents. This |
| | | | value is permitted to change. Examples |
| | | | are “Dr Jones in Maryland at the |
| | | | Germantown Facility” and “Harry Cotter, |
| | | | Broker for ExecPlan in Mid_Atlantic |
| | | | Territory.” |
| ACCESS_IDENTIFIER | Access_Id_Parent | int | This is the Access_Id_Gen_Key for the |
| | | (4) | immediate parent of a Derivative Access |
| | | | ID. For Primary Access Ids, this is |
| | | | NULL. |
| ACCESS_IDENTIFIER | Access_Id_Short_Desc | varchar | This is the a short description of what the |
| | | (25) | Access ID represents. It should be |
| | | | descriptive and brief. This value is |
| | | | permitted to change. Examples are “Dr. |
| | | | Jones” and “Harry Cotter”. |
| ACCESS_IDENTIFIER | Access_Id_Source | varchar | Tells which of the source types created |
| | | (15) | this Access ID. If the source type is UR |
| | | | (User), this value is the AKA name of the |
| | | | user; if the source type is SC (Security), |
| | | | this value is the AKA name of the |
| | | | security user; if the source type is SA |
| | | | (System Application), it is the Gen_key |
| | | | of the system application; etc. |
| ACCESS_IDENTIFIER | Access_Id_Source_Type_Cd | varchar | From the Lookup_Codes table. Tells |
| | | (5) | where the source for the Access ID |
| | | | points to: System_Application or |
| | | | Business_Function or which user |
| | | | created or any other value. |
| ACCESS_IDENTIFIER | Access Id_Source_Type_Cd_Table_Id | varchar | This code identifies the code table within |
| | | (8) | the lookup codes table which contains |
| | | | the Source_Type values |
| ACCESS_IDENTIFIER | Access_Id_Type_Cd | varchar | This is a categorization of the access |
| | | (5) | identifiers. Examples are Tax ID, |
| | | | Customer Number, and State License |
| | | | Number. |
| ACCESS_IDENTIFIER | Access_Id_Type_Cd_Table_Id | varchar | This code identifies the code table within |
| | | (8) | the lookup codes table which contains |
| | | | the Access_ID_Type values |
| ACCESS_IDENTIFIER | Created_By_User_Id | varchar | This is the AKAName of the user who |
| | | (25) | created the Access Identifier. It may be |
| | | | NULL if the Access Identifier was |
| | | | created by a non-GUI program. |
| ACCESS_IDENTIFIER | DT_Created | datetime | The date and time in GMT that this |
| | | (8) | Access ID was added to the data base. |
| ACCESS_IDENTIFIER | Entity_Gen_Key | int | This is a key within the External_Entity |
| | | (4) | table, pointing to the entity to which this |
| | | | Access ID belongs. |
| BUS_FUNC_ID_TYPE_ASSOC | Access_Id_Cd_Table_Id | varchar | This code identifies the code table within |
| | | (8) | the lookup codes table which contains |
| | | | the Access_ID_Type_Cd values |
| BUS_FUNC_ID_TYPE_ASSOC | Access_Id_Class_Cd_Table_Id | varchar | This code identifies the code table within |
| | | (8) | the lookup codes table which contains |
| | | | the Access_ID_Class_Rule_Cd values |
| BUS_FUNC_ID_TYPE_ASSOC | Access_Id_Class_Rule_Cd | varchar | If present, indicates this business |
| | | (5) | function uses only those access ID'S |
| | | | whose class matches this code; |
| | | | otherwise, the business function uses all |
| | | | classes. Access ID Class Rule code |
| | | | values include “primary” and “derivative.” |
| BUS_FUNC_ID_TYPE_ASSOC | Access_Id_Type_Cd | varchar | This is a categorization of the access |
| | | (5) | identifiers and indicates an access ID |
| | | | type that is associated with the business |
| | | | function identified by |
| | | | Bus_Func_Gen_Key. |
| BUS_FUNC_ID_TYPE_ASSOC | Bus_Func_Gen_Key | int | This is a key within the |
| | | (4) | Business_Function table, pointing to a |
| | | | business function associated with the |
| | | | Access_ID_Type_Cd. |
| BUSINESS_FUNCTION | ActiveDate | datetime | The date and time in GMT that this |
| | | (8) | Business Function became active. |
| BUSINESS_FUNCTION | Bus_Func_Gen_Key | int | This is a unique key that identifies this |
| | | (4) | Business_Function row. It is generated |
| | | | when the Business_Function row is |
| | | | added to the data base. |
| BUSINESS_FUNCTION | Business_Func_Desc | varchar | A detailed description or definition of this |
| | | (255) | business function |
| BUSINESS_FUNCTION | Business_Func_Name | varchar | The name by which this business |
| | | (40) | function or process is known to the |
| | | | business community |
| BUSINESS_FUNCTION | DeActiveDate | datetime | The date and time in GMT that on which |
| | | (8) | this Business Function became inactive. |
| BUSINESS_FUNCTION | Default_Navigation_Name | varchar | The default name by which this function |
| | | (40) | is presented in a navigation menu or link |
| BUSINESS_FUNCTION | Delegation_Type_Cd | varchar | Code indicating whether or not the |
| | | (5) | business function may be delegated. |
| | | | Values are “Yes” or “No.” |
| BUSINESS_FUNCTION | Delegation_Type_Cd_Table_Id | varchar | This code identifies the code table within |
| | | (8) | the lookup codes table which contains |
| | | | the Delegation_Type_Cd values |
| BUSINESS_FUNCTION | DT_Created | datetime | The date and time in GMT that this |
| | | (8) | Business_Function row was added to the |
| | | | data base. |
| BUSINESS_FUNCTION | DT_Updated | datetime | The date and time in GMT that the |
| | | (8) | information in this Business_Function |
| | | | row was last updated. |
| BUSINESS_FUNCTION | Initial_URL | varchar | The URL to which the browser is |
| | | (255) | redirected when this business function is |
| | | | invoked. |
| BUSINESS_FUNCTION | PortOrigin_Gen_Key | int | This a key within the Port_Of_Origin |
| | | (4) | table, pointing to the Port of Origin to |
| | | | which this Business Function belongs. |
| BUSINESS_FUNCTION | Segment | bit | A code indicating whether or not this |
| | | (1) | business function is able to work with |
| | | | discrete segments or parts of an |
| | | | organization versus the entire |
| | | | organization. Yes = 1; No = 0. |
| BUSINESS_FUNCTION | System_Application_ID | int | This a key within the System_Application |
| | | (4) | table, pointing to the System Application |
| | | | to which this Business Function belongs. |
| BUSINESS_FUNCTION_ASSOC | ActiveDate | datetime | The date and time in GMT that this |
| | | (8) | Business Function Association became |
| | | | active. |
| BUSINESS_FUNCTION_ASSOC | Bus_Func_Gen_Key | int | This is a key within the |
| | | (4) | Business_Function table, pointing to a |
| | | | Business Function that is associated with |
| | | | the Business Function Set identified by |
| | | | Bus_Func_Set_Gen_Key. |
| BUSINESS_FUNCTION_ASSOC | Bus_Func_Set_Gen_Key | int | This is a key within the |
| | | (4) | Business_Function_Set table, pointing to |
| | | | a Business Function Set that is |
| | | | associated with the Business Function |
| | | | identified by Bus_Func_Gen_Key. |
| BUSINESS_FUNCTION_ASSOC | DeactiveDate | datetime | The date and time in GMT that this |
| | | (8) | Business Function Association became |
| | | | deactivated. |
| BUSINESS_FUNCTION_ASSOC | DT_Created | datetime | The date and time in GMT that this |
| | | (8) | Business Function Association was |
| | | | added to the database. |
| BUSINESS_FUNCTION_ASSOC | DT_Updated | datetime | The date and time in GMT that |
| | | (8) | information about this Business Function |
| | | | Association was last updated. |
| BUSINESS_FUNCTION_SET | ActiveDate | datetime | The date and time in GMT that this |
| | | (8) | Business Function Set became active. |
| BUSINESS_FUNCTION_SET | Bus_Func_Set_Desc | varchar | A detailed description or definition of this |
| | | (255) | Business Function Set. |
| BUSINESS_FUNCTION_SET | Bus_Func_Set_Gen_Key | int | This is a unique key that identifies this |
| | | (4) | Business_Function_Set row. It is |
| | | | generated when the |
| | | | Business Function Set row is added to |
| | | | the data base. |
| BUSINESS_FUNCTION_SET | Bus_Func_Set_Name | varchar | A name that implies the purpose of this |
| | | (40) | Business Function Set. |
| BUSINESS_FUNCTION_SET | DeactiveDate | datetime | The date and time in GMT that this |
| | | (8) | Business Function Set became |
| | | | deactivated. |
| BUSINESS_FUNCTION_SET | DT_Created | datetime | The date and time in GMT that this |
| | | (8) | Business Function Set was added to the |
| | | | database. |
| BUSINESS_FUNCTION_SET | DT_Updated | datetime | The date and time in GMT that |
| | | (8) | information about this Business Function |
| | | | Set was last updated. |
| BUSINESS_FUNCTION_SET | Origin_Gen_Key | int | This a key within the Port_Of_Origin |
| | | (4) | table, pointing to the Port of Origin to |
| | | | which this Business Function Set |
| | | | belongs. |
| DELEGATION | Admin_Entity_Gen_Key | int | This is a key within the External_Entity |
| | | (4) | table, pointing to the entity that is given |
| | | | the rights to do work as a result of this |
| | | | Delegation. This value will never be the |
| | | | same as the |
| | | | GrantedBy_Entity_Gen_Key or the |
| | | | BehalfOf_Entity_Gen_Key. |
| DELEGATION | BehalfOf_Entity_Gen_Key | int | This is a key within the External_Entity |
| | | (4) | able, pointing to the entity whose |
| | | | business function and data are |
| | | | delegated as a result of this Delegation. |
| DELEGATION | Bus_Func_Gen_Key | int | This is a key within the |
| | | (4) | Business_Function table, pointing to the |
| | | | business function being delegated by |
| | | | this Delegation. |
| DELEGATION | CreatedBy_User_Id | varchar | The AKAName of the user who created |
| | | (25) | this delegation. |
| DELEGATION | Data_Gen_Key | int | This is a key for either the |
| | | (4) | ACCESS_IDENTIFIER or |
| | | | ACCESS_GROUP table, pointing to the |
| | | | Access Id or Access Group (segment) |
| | | | that is being delegated. |
| DELEGATION | Data_Type_Cd | varchar | Code indicating whether the |
| | | (5) | Data Gen Key is from the |
| | | | ACCESS_IDENTIFIER table or the |
| | | | ACCESS GROUP table. |
| DELEGATION | Data_Type_Cd_Table_Id | varchar | This code identifies the code table within |
| | | (8) | the lookup codes table which contains |
| | | | the Data_Type_CD values. |
| DELEGATION | DeactivatedBy_Entity_User_Gen_{—} | int | This is a key within the Entity_User table, |
| | Key | (4) | pointing to the Entity_User who canceled |
| | | | this Delegation. |
| DELEGATION | Deactivation_Method_Type_Cd | varchar | A code that indicates whether a |
| | | (5) | Delegation deactivation resulted from an |
| | | | explicit deactivation of rights for the |
| | | | entity_user or was the side-effect |
| | | | (cascading delete) of a deactivation of |
| | | | rights for another entity_user. |
| DELEGATION | Deactivation_Method_Type_Cd | varchar | This code identifies the code table within |
| | Table_Id | (8) | the lookup codes table which contains |
| | | | the Deactivation_Method_Type_Cd |
| | | | values. |
| DELEGATION | Delegation_Chain | int | This is an identifier for a delegation |
| | | (4) | chain. When a delegation is initiated, |
| | | | this field gets a unique value. All |
| | | | subsequent instances of a delegation of |
| | | | this “business function : access pair” |
| | | | copies this value. |
| DELEGATION | Delegation_End_Date | datetime | The date and time in GMT when this |
| | | (8) | Delegation is inactivated. It is initially |
| | | | NULL. |
| DELEGATION | Delegation_Gen_Key | int | This is a unique key that identifies this |
| | | (4) | Delegation. It is generated when the |
| | | | Delegation is added to the data base. |
| DELEGATION | Delegation_Level | int | For the first delegation in a delegation |
| | | (4) | chain of a “business function : access |
| | | | pair”, this is set to 1. Subsequent |
| | | | delegations increment the value by 1. |
| DELEGATION | Delegation_Parent | int | This is a key within the Delegation table |
| | | (4) | itself, pointing to the row in this table that |
| | | | immediately precedes this row in a |
| | | | delegation chain. For the first delegation |
| | | | this field is set to NULL. For subsequent |
| | | | delegations (level > 1), this is the value |
| | | | of the Delegation_Gen_Key of the entry |
| | | | that is creating this new entry. When A |
| | | | delegates to B, this column is NULL, |
| | | | when B further delegates A's work to D, |
| | | | this field points to the row where A |
| | | | delegated to B. |
| DELEGATION | Delegation_Type_Cd | varchar | A code indicating whether this |
| | | (5) | Delegation may be further delegated, the |
| | | | type of delegation (with or without |
| | | | permission), etc. (Not currently used.) |
| DELEGATION | Delegation_Type_Cd_Table_Id | varchar | This code identifies the code table within |
| | | (8) | the lookup codes table which contains |
| | | | the Delegation_Type_Cd values. |
| DELEGATION | DT_Created | datetime | The date and time in GMT that this |
| | | (8) | Delegation was added to the data base. |
| DELEGATION | DT_Updated | datetime | The date and time in GMT that |
| | | (8) | information about this Delegation was |
| | | | last updated. |
| DELEGATION | GrantedBy_Entity_Gen_Key | int | This is the key within the External_Entity |
| | | (4) | table, pointing to the entity whose |
| | | | PAA/AA did the delegation. For the |
| | | | initial delegation, this is the same as the |
| | | | BehalfOf_Entity, i.e. A delegates to B |
| | | | (Admin) to do work for itself, A (BehalfOf) |
| | | | and A (GrantedBy). If B subsequently |
| | | | delegates A's work to D, this value |
| | | | (GrantedBy) would be B, Admin would |
| | | | be D, and BehalfOf would be A. |
| DELEGATION | GrantedBy_User_Id | varchar | The AKAName of the user who granted |
| | | (30) | his delegation. |
| DELEGATION_{—} | Admin_AKAName | varchar | The AKAName of the PAA of the entity |
| AUTHORIZATION | | (30) | that will be delegated to as a result of |
| | | | this Delegation Authorization. |
| DELEGATION_{—} | Admin_Entity_Gen_Key | int | This is a key within the External_Entity |
| AUTHORIZATION | | (4) | table, pointing to the entity that will be |
| | | | delegated to as a result of this |
| | | | Delegation Authorization. |
| DELEGATION_{—} | Created By_Entity_User_Gen_Key | int | This is a key within the Entity_User |
| AUTHORIZATION | | (4) | Table, pointing to the Entity_User who |
| | | | initiated this particular Delegation |
| | | | Authorization. |
| DELEGATION_{—} | Delegation_Authorization_Eff_Date | datetime | The date and time in GMT that this |
| AUTHORIZATION | | (8) | Delegation Authorization is available for |
| | | | use. Usually it is the same as the |
| | | | DT_Created. |
| DELEGATION_{—} | Delegation Authorization_End_Date | datetime | The date and time in GMT that this |
| AUTHORIZATION | | (8) | Delegation Authorization is deactivated. |
| DELEGATION_{—} | Delegation_Authorization_Use_Count | int | Initialized to zero. It tracks the number |
| AUTHORIZATION | | (4) | of times this record was invoked to |
| | | | authorize a delegation. |
| DELEGATION_{—} | Delegation_Transaction_Code | varchar | This is the Delegation Acceptance Code. |
| AUTHORIZATION | | (40) | It is given to a PAA/AA at another entity |
| | | | in order for that PAA/AA to delegate to |
| | | | the entity referenced by the |
| | | | Admin Entity Gen Key. |
| DELEGATION_{—} | DT_Created | datetime | The date and time in GMT that this |
| AUTHORIZATION | | (8) | Delegation Authorization was added to |
| | | | the data base. |
| DELEGATION_{—} | DT_Updated | datetime | The date and time in GMT that |
| AUTHORIZATION | | (8) | information about this Delegation |
| | | | Authorization was last updated. |
| DELEGATION_{—} | UpdatedBy_Entity_User_Gen_Key | int | This is a key within the Entity_User |
| AUTHORIZATION | | (4) | Table, pointing to the Entity_User who |
| | | | most recently updated this particular |
| | | | Delegation Authorization. |
| ENTITY_TYPE_FUNCTION | Bus_Func_Set_Gen_Key | int | This is a key within the |
| | | (4) | Business_Function_Set table, pointing to |
| | | | a Business Function Set that may be |
| | | | associated with the Entity Type identified |
| | | | by Entity_Type_Cd. |
| ENTITY_TYPE_FUNCTION | Default_For_Category_Ind | char | Not currently used. |
| | | (1) | |
| ENTITY_TYPE_FUNCTION | DT_Created | datetime | The date and time in GMT that this |
| | | (8) | Entity_Type_Function row was added to |
| | | | the data base. |
| ENTITY_TYPE_FUNCTION | DT_Updated | datetime | The date and time in GMT that the |
| | | (8) | information in this Entity_Type_Function |
| | | | row was last updated. |
| ENTITY_TYPE_FUNCTION | Entity_Type_Cd | char | A code that identifies the type of entity |
| | | (6) | which may be associated with the |
| | | | Business Function Set identified by |
| | | | Bus_Func_Set_Gen_Key. |
| ENTITY_USER | Access_Granted_By_UserId | char | The AKA_Name of the person who |
| | | (15) | granted this user the right to do work on |
| | | | behalf of this entity. |
| ENTITY_USER | Admin_Entity_Gen_Key | int | This is a key to the External_Entity table, |
| | | (4) | pointing to the External_Entity that the |
| | | | person, in this context, works for (is |
| | | | employed by or for Members, it is their |
| | | | own account). When the |
| | | | BehalfOf_Entity and Admin_Entity are |
| | | | the same, the person is associated with |
| | | | the entity that controls the business |
| | | | function : data access. If the |
| | | | BehalfOf_Entity and Admn_Entity are |
| | | | different, then the person is a ‘Virtual’ |
| | | | user for the BehalfOf_Entity and will be |
| | | | allowed to do work (process |
| | | | transactions) using the BehalfOf_Entity's |
| | | | data and functions. This is done via |
| | | | delegation. |
| ENTITY_USER | BehalfOf_Entity_Gen_Key | int | This is a key to the External_Entity table, |
| | | (4) | pointing to the External_Entity that the |
| | | | person will do work on behalf of. |
| ENTITY_USER | Block_Cd | char | Obsolete as of SL 4.0. Y if access to |
| | | (2) | Humana's resources by this person have |
| | | | been blocked. Any other value allows |
| | | | access based on access rights granted |
| | | | by user administrators. |
| ENTITY_USER | Block_Date | datetime | Obsolete as of SL 4.0. |
| | | (8) | |
| ENTITY_USER | Block_Reason_Audit_ID | char | Obsolete as of SL 4.0. The Id of the |
| | | (15) | person who last changed the block code |
| | | | and block reason code. |
| ENTITY_USER | Block_Reason_Cd | char | Obsolete as of SL 4.0. A code indicating |
| | | (2) | the reason this person's access to |
| | | | Humana's resources has been blocked. |
| ENTITY_USER | CD_Table_ID_BlockCd | char | Obsolete as of SL 4.0. Holds the code |
| | | (8) | table id under which the block reason |
| | | | code definitions are stored within the |
| | | | code tables. |
| ENTITY_USER | CD_Table_ID_ReasonCd | char | Obsolete as of SL 4.0. Holds the code |
| | | (8) | table id under which the block code |
| | | | definitions are stored within the code |
| | | | tables |
| ENTITY_USER | DT_Created | datetime | The date and time in GMT that this |
| | | (8) | Entity_User row was added to the data |
| | | | base. |
| ENTITY_USER | DT_Updated | datetime | The date and time in GMT that the |
| | | (8) | information in this Entity_User row was |
| | | | last updated. |
| ENTITY_USER | Entity_User_Eff_Date | datetime | Obsolete in SL 4.0. The date and time in |
| | | (8) | GMT on which this Entity_User entry is |
| | | | first valid. |
| ENTITY_USER | Entity_User_End_Date | datetime | Obsolete in SL 4.0. The date and time in |
| | | (8) | GMT when this Entity_User entry is no |
| | | | longer valid. This field is initialized to |
| | | | <NULL>. It is set when the Entity_User |
| | | | relationship is severed. |
| ENTITY_USER | Entity_User_Gen_Key | int | This is a unique key that identifies this |
| | | (4) | Entity_User row. It is generated when |
| | | | the Entity_User row is added to the data |
| | | | base. |
| ENTITY_USER | Entity_User_Title | varchar | A free text title of the person working at |
| | | (30) | the company. This field will be NULL for |
| | | | ‘virtual’ users. |
| ENTITY_USER | Entity_User_Type_Cd | varchar | This code is used to identify the type of |
| | | (5) | user this person is in relation to the entity |
| | | | 1 = PAA, 2 = AA, 3 = OA). Valid values |
| | | | come from the Lookup_Codes table. |
| ENTITY_USER | Entity_User_Type_Cd_Table_Id | varchar | This code identifies the code table within |
| | | (8) | the lookup codes table which contains |
| | | | the Entity_User_Cd values. |
| ENTITY_USER | GrantedBy_Entity_Gen_Key | int | This is a key to an entry in the |
| | | (4) | External_Entity table, pointing to the |
| | | | External_Entity that was responsible for |
| | | | creating the relationship between the |
| | | | User and the Entity in this Entity_User |
| | | | row. For virtual users this will be NULL |
| | | | because this information is captured in |
| | | | the DELEGATION table. For initial PAAs |
| | | | this will be the internal security. |
| | | | organization; for AA and OA this will be |
| | | | the same as the Admin_Entity and |
| | | | BehalfOf_Entity. |
| ENTITY_USER | Is_Employed | bit | Obsolete as of SL 4.0, although it may |
| | | (1) | still be populated. A value of True |
| | | | indicates this User is employed by the |
| | | | entity that granted these access rights. |
| | | | False indicates this User is not employed |
| | | | by the entity that granted these access |
| | | | rights. |
| ENTITY_USER | User_ID | varchar | This is a key to an entry in the User |
| | | (25) | Table, pointing to the user who is being |
| | | | associated with the BehalfOf_Entity. |
| ENTITY_USER_ACCESS | Assignment_Type_Cd | varchar | This is a code that indicates whether or |
| | | (5) | not this entry may be assigned to |
| | | | another person. As of SL 4.0, it is not |
| | | | used. |
| ENTITY_USER_ACCESS | Assignment_Type_Cd_Table_Id | varchar | This code identifies the code table within |
| | | (8) | the lookup codes table which contains |
| | | | the Assignment_Type_Cd values. |
| ENTITY_USER_ACCESS | Bus_Func_Gen_Key | int | This is a key within the |
| | | (4) | Business_Function table, pointing to the |
| | | | business function with which this |
| | | | Entitiy_User_Access row is associated. |
| ENTITY_USER_ACCESS | Data_Gen_Key | int | This is a key to an entry in either the |
| | | (4) | ACCESS_GROUP or |
| | | | ACCESS_IDENTIFIER tables. It points |
| | | | to the data with which this |
| | | | Entity_User_Access row is associated. If |
| | | | this is an Access_Group entry, Secured |
| | | | Logons will expand the group into its |
| | | | contents when this Entity_User_Access |
| | | | row is used, but will not store the |
| | | | Access_Group content in this table. |
| ENTITY_USER_ACCESS | Data_Type_Cd | varchar | This code indicates whether the |
| | | (5) | Data_Gen_Key is from the |
| | | | Access_Identifier table or the |
| | | | Access_Group table. |
| ENTITY_USER_ACCESS | Data_Type_Cd_Table_Id | varchar | This code identifies the code table within |
| | | (8) | the lookup codes table which contains |
| | | | the Data_Type_Cd values. |
| ENTITY_USER_ACCESS | DT_Created | datetime | The date and time in GMT that this |
| | | (8) | Entity_User_Access row was added to |
| | | | the data base. |
| ENTITY_USER_ACCESS | DT_Updated | smalldatetime | The date and time in GMT that the |
| | | | information in this Entity_User_Access |
| | | | row was last updated. |
| ENTITY_USER_ACCESS | Entity_User_Access_Eff_Date | datetime | The date and time in GMT on which this |
| | | (8) | Entity_User_Access entry is first valid. |
| ENTITY_USER_ACCESS | Entity_User_Access_End_Date | datetime | The date and time in GMT when this |
| | | (8) | Entity_User_Access entry is no longer |
| | | | valid. This field is initialized to <NULL>. |
| | | | It is set when the access rights implied |
| | | | by the entry are removed from the user. |
| ENTITY_USER_ACCESS | Entity_User_Access_Gen_Key | int | This is a unique key that identifies this |
| | | (4) | Entity_User_Access row. It is generated |
| | | | when the Entity_User_Access row is |
| | | | added to the data base. |
| ENTITY_USER_ACCESS | Entity_User_Gen_Key | int | This is a key to an entry in the Entity- |
| | | (4) | User table that points to the Entity_User |
| | | | with which this Entity_User_Access row |
| | | | is associated. |
| EUA_Delegation_Assoc | Created By_Entity_User_Gen_Key | int | This is a key within the |
| | | (4) | Entity_User_Table, pointing to the entity |
| | | | and the person within that entity which |
| | | | assigned the delegated access. |
| EUA_Delegation_Assoc | DeactivatedBy_Entity_User_Gen_{—} | int | This is a key within the |
| | Key | (4) | Entity_User_Table, pointing to the entity |
| | | | and the person within that entity which |
| | | | revoked the delegation. |
| EUA_Delegation_Assoc | Deactivation_Method_Type_Cd | varchar | A code that indicates whether a |
| | | (5) | Delegation deactivation resulted from an |
| | | | explicit deactivation of rights for the |
| | | | entity_user or was the side-effect |
| | | | (cascading delete) of a deactivation of |
| | | | rights for another entity_user. |
| EUA_Delegation_Assoc | Deactivation_Method_Type_Cd | varchar | This code identifies the code table within |
| | Table_Id | (8) | the lookup codes table which contains |
| | | | the Deactivation_Method_Type_Cd |
| | | | values |
| EUA_Delegation_Assoc | Delegation_Gen_Key | int | This is a key within the Delegation table, |
| | | (4) | pointing to the Delegation that explains |
| | | | how and why the Entity_User_Access |
| | | | identified by the |
| | | | Entity_User_Access_Gen_Key has been |
| | | | created from delegation. |
| EUA_Delegation_Assoc | DT_Created | datetime | The date and time in GMT that this EUA |
| | | (8) | Delegation Association was added to the |
| | | | data base. |
| EUA_Delegation_Assoc | DT_Updated | datetime | The date and time in GMT that |
| | | (8) | information about this EUA Delegation |
| | | | Association was last updated. |
| EUA_Delegation_Assoc | Entity_User_Access_Gen_Key | int | This is a key to the Entity_User_Access |
| | | (4) | table, pointing to an Entity_User_Access |
| | | | row that is valid due to the reasons |
| | | | identified in the Delegation defined by |
| | | | the Delegation_Gen_Key. |
| EUA_Delegation_Assoc | EUA_Delegation_End_Date | datetime | The date and time in GMT when this |
| | | (8) | EUA Delegation Association is |
| | | | inactivated. It is initially NULL. |
| MENU_TEMPLATE | Bus_Func_Gen_Key | int | This is a key within the |
| | | (4) | Business_Function table, pointing to a |
| | | | Business Function that is associated with |
| | | | this Menu Template Item. |
| MENU_TEMPLATE | DT_Created | datetime | The date and time in GMT that this Menu |
| | | (8) | Template Item was added to the database. |
| MENU_TEMPLATE | DT_Updated | datetime | The date and time in GMT that |
| | | (8) | information about this Menu Template |
| | | | Item was last updated. |
| MENU_TEMPLATE | Menu_Gen_Key | int | This is a unique key that identifies this |
| | | (4) | Menu_Template row. It is generated |
| | | | when the Menu_Template row is added |
| | | | to the data base. |
| MENU_TEMPLATE | Menu_Level | tinyint | Identifies the level, or layer, within the |
| | | (1) | menu system at which this Menu |
| | | | Template Item is presented. The first |
| | | | layer is layer 1, the next layer is layer 2, |
| | | | etc. |
| MENU_TEMPLATE | Menu_Sequence | tinyint | This is a numeric sequence number that |
| | | (1) | determines the order Menu Template |
| | | | Items are displayed within a particular |
| | | | parent and menu level. |
| MENU_TEMPLATE | Menu_Short_Name | varchar | A short name for the menu item. This is |
| | | (40) | the value typically displayed to the user |
| | | | for the Menu Template Item. |
| MENU_TEMPLATE | Menu_Tool_Tip | varchar | The text displayed when a user places |
| | | (60) | his/her mouse over this Menu Template |
| | | | Item. |
| MENU_TEMPLATE | Origin_Gen_Key | int | This a key within the Port_Of_Origin |
| | | (4) | table, pointing to the Port of Origin in |
| | | | which this Menu Template Item is valid. |
| MENU_TEMPLATE | Parent_Menu_Gen_Key | int | Identifies the menu item to which this |
| | | (4) | menu item is a child. Top level menu |
| | | | items have a value of zero in this field. |
| | | | All the children of a particular menu item |
| | | | will have the value of the |
| | | | Menu_Gen_Key of the parent in this |
| | | | column. |
| MENU_TEMPLATE | Return_URL | varchar | This is the URL to return to when the |
| | | (255) | function controlled by the Menu |
| | | | Template Item completes. It is used in |
| | | | conjunction with the ReturnToSL.asp |
| | | | page. |
| MENU_TEMPLATE | Tag1 | varchar | This is a user-defined field. It stores |
| | | (2048) | additional information about this menu |
| | | | item. This can be used to provide |
| | | | instructions to a menu processor on how |
| | | | to handle the presentation of the menu |
| | | | item. It can also be used to store |
| | | | information that a business function |
| | | | developer may need. This field |
| | | | commonly contains XML tags. |
| MENU_TEMPLATE | Tag2 | varchar | This is a user-defined field. It stores |
| | | (2048) | additional information about this menu |
| | | | item. This can be used to provide |
| | | | instructions to a menu processor on how |
| | | | to handle the presentation of the menu |
| | | | item. It can also be used to store |
| | | | information that a business function |
| | | | developer may need. This field |
| | | | commonly contains XML tags. |
| PORT_OF_ORIGIN | Default_Passback_String | varchar | The default string to be passed back to |
| | | (255) | an external system when a call from that |
| | | | system ends. This string may contain |
| | | | information of any kind, but is anticipated |
| | | | to be information the external system will |
| | | | use to re-establish the environment that |
| | | | exists immediately prior to placing the |
| | | | call to Humana's system. |
| PORT_OF_ORIGIN | Default_Return_Location | varchar | The URL to which control will be |
| | | (255) | returned when a call from the Port of |
| | | | Origin to Secured Logons has |
| | | | completed. This often is the menu page |
| | | | for the Port of Origin or an intermediate |
| | | | page that determines which menu page |
| | | | to go to. |
| PORT_OF_ORIGIN | DT_Created | datetime | The date and time in GMT that this Port |
| | | (8) | of Origin was added to the database. |
| PORT_OF_ORIGIN | DT_Updated | datetime | The date and time in GMT that |
| | | (8) | information about this Port of Origin was |
| | | | last updated. |
| PORT_OF_ORIGIN | Logo_URL | varchar | The URL to the logo for this Port of |
| | | (255) | Origin. The logo will be displayed on all |
| | | | screens that Secured Logons populates |
| | | | in that Port of Origin. |
| PORT_OF_ORIGIN | Origin_Gen_Key | int | This is a unique key that identifies this |
| | | (4) | Port of Origin. It is generated when the |
| | | | Port of Origin is added to the database. |
| PORT_OF_ORIGIN | Origin_Name | varchar | A short, concise, name by which this |
| | | (255) | Port of Origin may be known. It must be |
| | | | unique and it must not contain any |
| | | | spaces. |
| PORT_OF_ORIGIN | Style_Sheet_URL | varchar | The URL to the style sheet for the Port of |
| | | (255) | Origin. The style sheet will be applied to |
| | | | all screens that Secured Logons |
| | | | populates in that Port of Origin. |
| PORT_OF_ORIGIN_{—} | Attr_Nbr | tinyint | A number that uniquely identifies this |
| ATTRIBUTES | | (1) | attribute for this Port of Origin. |
| PORT_OF_ORIGIN_{—} | Attribute_Identifier | varchar | A name that identifies the purpose of this |
| ATTRIBUTES | | (20) | Port of Origin Attribute. |
| PORT_OF_ORIGIN_{—} | Attribute_Sequence | (tinyint | Defines the sequence in which this Port |
| ATTRIBUTES | | (1) | of Origin Attribute is presented on |
| | | | reports and management screens. |
| PORT_OF_ORIGIN_{—} | Attribute_Value | varchar | The value of this Port of Origin Attribute. |
| ATTRIBUTES | | (255) | |
| PORT_OF_ORIGIN_{—} | DT_Created | datetime | The date and time in GMT that this Port |
| ATTRIBUTES | | (8) | of Origin Attribute was added to the |
| | | | database. |
| PORT_OF_ORIGIN_{—} | DT_Updated | datetime | The date and time in GMT that |
| ATTRIBUTES | | (8) | information about this Port of Origin |
| | | | Attribute was last updated. |
| PORT_OF_ORIGIN_{—} | Origin_Gen_Key | int | This a key within the Port_Of_Origin |
| ATTRIBUTES | | (4) | table, pointing to the Port of Origin to |
| | | | which this Attribute belongs. |
| STATUS_CONTROL | Actor_Role | int | This is a code indicating the role of the |
| | | (4) | user who created the Status Control |
| | | | item. 1 = internal security; 2 = external |
| | | | user; 3 = transaction acceptor. |
| STATUS_CONTROL | Added_By | varchar | This is the AKAName of the user who |
| | | (30) | created the Status Control item. |
| STATUS_CONTROL | Cancelled_By | varchar | This is the AKAName of the user who |
| | | (30) | initiated the cancel or replacement |
| | | | action. |
| STATUS_CONTROL | Disposition_Cd | varchar | Code that identifies the disposition of this |
| | | (5) | status item. Blank = Good - This record |
| | | | should be used along with other records |
| | | | having a blank disposition code in |
| | | | determining the current status. HIS = |
| | | | History - this record is no longer active |
| | | | and has been replaced by another one. |
| | | | IGN = Ignore - This records is no longer |
| | | | active and has not been replaced by |
| | | | another. OVR = Overridden - This |
| | | | record is no longer active, and was |
| | | | eliminated because someone put in a |
| | | | conflicting record/record set and |
| | | | requested this record to be overridden. |
| STATUS_CONTROL | dt_Added_On | datetime | The date and time in GMT that this |
| | | (8) | Status Control item was added to the |
| | | | data base. |
| STATUS_CONTROL | dt_Cancelled | datetime | The date and time in GMT that this |
| | | (8) | Status Control item was cancelled or |
| | | | replaced by another Status Control item. |
| STATUS_CONTROL | dt_To_Act | datetime | The date and time in GMT that this |
| | | (8) | Status Control item goes into effect. |
| STATUS_CONTROL | Impact_Type_Cd | varchar | Identifies the overall impact of the Status |
| | | (5) | Control item. A = Restart, P = Permanent, |
| | | | R = Registered, S = Started, T = Temporary |
| STATUS_CONTROL | Reason_Cd | varchar | Code that provides a reason why this |
| | | (5) | Status Control item exists. Reasons can |
| | | | be “Begin Leave,” “Begin Suspend,” |
| | | | “Begin Vacation,” “Revoked,” or |
| | | | “End Revoke.” |
| STATUS_CONTROL | Reason_Comment | varchar | A free-form field in which comments |
| | | (250) | regarding the Status Control item may be |
| | | | entered. |
| STATUS_CONTROL | Related_Reason_Cd | varchar | When this Status Control item is related |
| | | (5) | to another Status Control item, this code |
| | | | explains that relationship: B = this |
| | | | record ends and the other record begins |
| | | | a set of records that represents a range |
| | | | or period of time when status was |
| | | | interrupted. E = this record begins and |
| | | | the other record ends a set of records |
| | | | that represents a range or period of time |
| | | | when status was interrupted. R = the |
| | | | other record is a replacement for this |
| | | | one. |
| STATUS_CONTROL | Related_Status_Control_Gen_Key | int | This is a key within the Status_Control |
| | | (4) | table pointing to a Status Control item |
| | | | that is related to this Status Control item. |
| | | | The reason for the relationship is |
| | | | indicated in Related_Reason_Cd. |
| STATUS_CONTROL | Status_Cd | varchar | Code indicating what the status will be |
| | | (5) | as of the dt_To_Act. A = Active, |
| | | | I = InActive, R = Revoked |
| STATUS_CONTROL | Status_Control_Gen_Key | int | This is a unique key that identifies this |
| | | (4) | Status Control item. It is generated |
| | | | when the Status Control item is added to |
| | | | the data base. |
| STATUS_CONTROL | Status_Control_Type | varchar | Code indicating whether this Status |
| | | (2) | Control item is for a user (U), entity (E), |
| | | | or entity_user (EU). |
| STATUS_CONTROL | Type_Gen_Key | int | This is a key within the User, |
| | | (4) | External_Entity, or Entity_User table, |
| | | | pointing to the user, entity, or entity_user |
| | | | for which this Status Control item exists. |
| SYSTEM_APPLICATION | ActiveDate | datetime | The date and time in GMT that this |
| | | (8) | System Application became active. |
| SYSTEM_APPLICATION | DeActiveDate | datetime | The date and time in GMT that this |
| | | (8) | System Application became deactivated. |
| SYSTEM_APPLICATION | DT_Created | datetime | The date and time in GMT that this |
| | | (8) | System Application was added to the |
| | | | database. |
| SYSTEM_APPLICATION | DT_Updated | datetime | The date and time in GMT that |
| | | (8) | information about this System |
| | | | Application was last updated. |
| SYSTEM_APPLICATION | System_Application_Description | varchar | A detailed description or definition of this |
| | | (255) | System Application. |
| SYSTEM_APPLICATION | System_Application_ID | int | This is a unique key that identifies this |
| | | (4) | System Application. It is generated |
| | | | when the System Application is added to |
| | | | the database. |
| SYSTEM_APPLICATION | System_Application_Short_Name | varchar | The concise name of a System |
| | | (50) | Application |
| SYSTEM_APPLICATION_{—} | DT_Created | datetime | The date and time in GMT that this |
| ATTRIBUTES | | (8) | System Application Attribute was added |
| | | | to the database. |
| SYSTEM_APPLICATION_{—} | DT_Updated | datetime | The date and time in GMT that |
| ATTRIBUTES | | (8) | information about this System |
| | | | Application Attribute was last updated. |
| SYSTEM_APPLICATION_{—} | System_Application_Attr_Nbr | tinyint | A number that uniquely identifies this |
| ATTRIBUTES | | (1) | attribute for this System Application. |
| SYSTEM_APPLICATION_{—} | System_Application_ID | int | This a key within the System_Application |
| ATTRIBUTES | | (4) | table, pointing to the System Application |
| | | | to which this Attribute belongs. |
| SYSTEM_APPLICATION_{—} | System_Application_Identifier | varchar | A name that identifies the purpose of this |
| ATTRIBUTES | | (20) | System Application Attribute. |
| SYSTEM_APPLICATION_{—} | System_Application_Identifier_Sequence | tinyint | The sequence in which the menuing |
| ATTRIBUTES | | (1) | program passes this value to the |
| | | | external system application. |
| SYSTEM_APPLICATION_{—} | System_Application_Value | varchar | The value of this System Application |
| ATTRIBUTES | | (255) | Attribute. |
| SYSTEM_CONFIG | Attr_Name | varchar | A name that identifies the purpose of this |
| | | (30) | System Configuration Attribute. |
| SYSTEM_CONFIG | Attr_Value | varchar | The value of this System Configuration |
| | | (1024) | Attribute. |
| SYSTEM_CONFIG | Description | varchar | A description or definition or purpose of |
| | | (255) | this System Configuration Attribute. |
| SYSTEM_CONFIG | DT_Created | datetime | The date and time in GMT that this |
| | | (8) | System Configuration Attribute was |
| | | | added to the database. |
| SYSTEM_CONFIG | DT_Updated | datetime | The date and time in GMT that |
| | | (8) | information about this System |
| | | | Configuration Attribute was last updated. |
| SYSTEM_CONFIG | Eff_Date | datetime | The date and time in GMT that this |
| | | (8) | System Configuration Attribute becomes |
| | | | effective. |
| SYSTEM_CONFIG | End_Date | datetime | The date and time in GMT that this |
| | | (8) | System Configuration Attribute is no |
| | | | longer effective. |
| SYSTEM_CONFIG | Load_As_Application_Variable | bit | A code indicating whether this System |
| | | (1) | Configuration Attribute should be loaded |
| | | | as an application variable; Yes = 1 or No = |
| | | | 0. |

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

We claim:

1. A stand-alone security system controlling access to secured information and self-service functionality for a sponsor organization, comprising:
means for controlling access to secured information and self-service functionality for the sponsor organization;
means for enabling access to users who have indirect relationships to the sponsor organization as well as to users who have a direct relationship with the sponsor organization;
means for distributing security administration from a central information technology resource to various users of the security system;
means for supporting integration into different kinds of environments; and
means for supporting system integrators who need to interface with and use information in the security system in order to execute their business functions.

2. The security system of claim 1, wherein the means for controlling access includes means for supporting access to business functions that may not be in control of the sponsor organization, but may be at another organization.

3. The security system of claim 1, wherein the means for controlling access includes means for approving access for an entity and granting access to people within the entity.

4. The security system of claim 1, wherein the means for controlling access includes means for categorizing entities into entity types for purposes of controlling access to the security system and for determining which business functions are appropriate for an entity.

5. The security system of claim 1, wherein the means for controlling access includes means for supporting users who are people associated with an entity.

6. The security system of claim 1, wherein the means for controlling access includes means for supporting the use of a single user ID for a given user in multiple contexts.

7. The security system of claim 1, wherein the means for controlling access includes means for supporting an AKA Name for a user.

8. The security system of claim 1, wherein the means for controlling access includes means for creating different roles for different users.

9. The security system of claim 1, wherein the means for controlling access includes means for determining user roles in multiple ways.

10. The security system of claim 1, wherein the means for controlling access includes means for presenting to a user when the user logs on a menu of business functions that contains only those business functions that the user's role allows.

11. The security system of claim 1, wherein the means for controlling access includes means for delegating by entities to third parties with which they have a relationship.

12. The security system of claim 11, wherein the means for delegating by entities includes means for tracking a chain of delegation by a 3-tuple of data comprising a chain identifier of the delegation, the level of the delegation, and the parent party to the delegation.

13. The security system of claim 1, wherein for entities having data about them in a back-end system of a sponsor organization, the means for controlling access includes means for capturing access identifiers that provide the connection to that data.

14. The security system of claim 1, wherein the means for controlling access includes means for controlling access to information and functionality on a site based on the access identifiers of the entity that are assigned to the user and the business functions that are assigned to the user.

15. The security system of claim 1, wherein the means for controlling access includes means for enabling large organizations with multiple access identifiers to define subsets of themselves for purposes of controlling access to the subsets rather than the entire organization.

16. The security system of claim 1, wherein the means for controlling access includes means for controlling and keeping records of the fact that users of the site have agreed to or acknowledged the conditions for using the site prior to their use of the site.

17. The security system of claim 1, wherein the means for controlling access includes means for providing for session management at a Web site once a user has logged onto the Web site.

18. The security system of claim 1, wherein the means for controlling access includes means for enabling administrators to manage the status of users so that only users who are active can perform functions.

19. The security system of claim 1, wherein the means for enabling access to users includes means for allowing users to be people who are not previously known to any sponsor organization, but have an indirect relationship to the sponsor organization through their employers.

20. The security system of claim 1, wherein the means for enabling access to users includes means for requiring that the user's employer must identify a person who legally binds that employer and a person who handles day-to-day security administration for the employer.

21. The security system of claim 1, wherein the means for enabling access to users includes means for supporting multiple registration alternatives.

22. The security system of claim 1, wherein the means for distributing security administration includes means for distributing some of the security administration rights to System Application Owners and based on the business functions implemented by the System Application.

23. The security system of claim 1, wherein the means for distributing security administration includes means for distributing security administration to entities using the Web site in order to perform day-to-day account administration and to System Application Owners controlling business functions available on the Web site to grant those business functions and manage the access identifiers that the business functions need.

24. The security system of claim 1, wherein the means for supporting integration into different kinds of environments includes means for installing the security system at different sponsor organizations.

25. The security system of claim 1, wherein the means for supporting integration into different kinds of environments includes means allowing differences in configuration for different sponsor organizations.

26. The security system of claim 1, wherein the means for supporting integration into different kinds of environments includes means for integrating and blending into a port of origin between an unsecured section of the port of origin and a secured section of the port of origin.

27. The security system of claim 1, wherein the means for supporting integration into different kinds of environments includes means for integrating the security system with third party security software for providing an additional level of security for directory access protection.

28. The security system of claim 26, wherein the means for integrating and blending includes means for adapting to the look and feel of the port of origin, means for adjusting some content of the security system depending on the port of origin and means for defining the navigation paths of the security system to the functions that it offers.

29. The security system of claim 1, wherein the means for supporting system integrators includes means for receiving information from back-end systems for changing security profiles of entities and users.

30. The security system of claim 1, wherein the means for supporting system integrators includes means for notifying back-end systems of additions and changes to security profiles for entities and users.
